(19) United States
(12) Patent Application Publication
(10) Pub. No.: US 2025/0388131 A1
(43) Pub. Date: Dec. 25, 2025

(54) SEAT, SEAT CUSHION, SEAT SYSTEM AND CAR SYSTEM

(71) Applicant: TS TECH CO., LTD., Asaka-shi (JP)

(72) Inventors: Takayoshi ITO, Shioya-gun (JP); Minako OYA, Shioya-gun (JP); Akira MIYOSHI, Shioya-gun (JP); Hiroki ITO, Shioya-gun (JP)

(21) Appl. No.: 19/309,079

(22) Filed: Aug. 25, 2025

Related U.S. Application Data
(63) Continuation of application No. 18/463,532, filed on Sep. 8, 2023.
Application No. 18/463,532 is a continuation of application No. PCT/JP2021/043322, filed on Nov. 26, 2021.

(30) Foreign Application Priority Data
Mar. 11, 2021 (JP) 2021-039503
Mar. 23, 2021 (JP) 2021-048915
Mar. 23, 2021 (JP) 2021-049131
Mar. 23, 2021 (JP) 2021-049132
Mar. 23, 2021 (JP) 2021-049133
Mar. 23, 2021 (JP) 2021-049134
Mar. 31, 2021 (JP) 2021-060451
Mar. 31, 2021 (JP) 2021-060461
Mar. 31, 2021 (JP) 2021-060475

(51) Int. Cl. B60N 2/00; B60N 2/12; B60N 2/14; B60N 2/56; B60N 2/75; B60N 2/882; B60N 2/90

(52) U.S. Cl. CPC B60N 2/0034; B60N 2/12; B60N 2/14; B60N 2/56; B60N 2/787; B60N 2/882; B60N 2/90

(57) ABSTRACT

A seat includes a seat frame, a pad body, and a power generation device. The pad body covers the seat frame. The power generation device is arranged on an occupant-side of the pad body and generates electric power from vibrations. The seat may further include an outer covering that covers the pad body. The power generation device may be located between the pad body and the outer covering.

### REFERENCE TO RELATED APPLICATIONS

This application is a continuation application of International Application No. PCT/JP2021/043322 filed on Nov. 26, 2021 which claims priority from Japanese Patent Application No. 2021-039503 filed on Mar. 11, 2021, Japanese Patent Application Nos. 2021-048915, 2021-049131, 2021-049132, 2021-049133, 2021-049134 filed on Mar. 23, 2021, and Japanese Patent Application Nos. 2021-060451, 2021-060461, 2021-060475 filed on Mar. 31, 2021. The disclosures of these applications are incorporated herein by reference in their entirety.

### TECHNICAL FIELD

The present disclosure relates to a seat, a seat cushion, a seat system and a car system.

### BACKGROUND ART

A seat conventionally known in the art includes a power generation device that generates electric power from vibrations (JP 2018-197035 A). The power generation device is provided under a cushion pad of the seat. The seat is installed in a car and the power generation device generates electric power from vibrations caused while the car is being driven. The generated electric power is provided to sensors and other components.

### DESCRIPTION

The applicant is considering the use of a pressure sensor provided in the seat to detect motions of an occupant seated on the seat, and to use the detected results in various applications. In such seats provided with a pressure sensor, the motions of the occupant may generate electricity. However, with the power generation device installed under the cushion pad as is conventionally known in the art, vibrations are not efficiently transmitted to the power generation device, and thus electric power cannot be generated efficiently.

It would be desirable to provide a seat and a seat cushion capable of efficiently generating electric power by motions of an occupant.

In one aspect, a seat disclosed herein comprises a seat frame, a pad body, and a power generation device. The pad body covers the seat frame. The power generation device is arranged on an occupant-side of the pad body and configured to generate electric power from vibrations.

According to this configuration, since the power generation device, which generates electric power from vibrations, is arranged on the occupant-side of the pad body, vibrations are efficiently transmitted to the power generation device when the occupant moves. Thus, electric power can be efficiently generated by the motions of the occupant.

The above-described seat may further comprise an outer covering that covers the pad body. In this case, the power generation device may be located between the pad body and the outer covering.

The pad body preferably, but not necessarily, has a recess on the occupant-side of the pad body, and the power generation device is preferably, but not necessarily, located in the recess.

According to this configuration, the occupant is less likely to perceive the power generation device as a foreign object, and the seat can thereby be made more comfortable.

The seat preferably, but not necessarily, further comprises a cover pad that covers the power generation device.

According to this configuration, the occupant is less likely to perceive the power generation device as a foreign object, and the seat can thereby be made more comfortable.

The seat may further comprise a pressure sensor arranged on the occupant-side of the pad body. In this case, the power generation device may be connected to the pressure sensor to supply electric power to the pressure sensor.

If the seat comprises a pressure sensor, the pressure sensor may be arranged on an occupant-side of the power generation device in a position that overlaps the power generation device.

According to this configuration, the pressure sensor and the power generation device can be easily connected, and the sensitivity of the pressure sensor will not be impaired.

In another aspect, a seat cushion placed and used on a seating surface of a seat is disclosed herein. The seat cushion comprises a pad body, and a power generation device. The power generation device is arranged on an occupant-side of the pad body and configured to generate electric power from vibrations.

According to this configuration, since the power generation device, which generates electric power from vibrations, is arranged on the occupant-side of the pad body, vibrations are efficiently transmitted to the power generation device when the occupant moves. Thus, electric power can be efficiently generated by the motions of the occupant.

The seat cushion may further comprise an outer covering that covers the pad body. In this case, the power generation device may be located between the pad body and the outer covering.

The pad body preferably, but not necessarily, has a recess on the occupant-side of the pad body, and the power generation device is preferably, but not necessarily, located in the recess.

According to this configuration, the occupant is less likely to perceive the power generation device as a foreign object, and the seat can thereby be made more comfortable.

The seat cushion preferably, but not necessarily, further comprises a cover pad that covers the power generation device.

According to this configuration, the occupant is less likely to perceive the power generation device as a foreign object, and the seat can thereby be made more comfortable.

The seat cushion may further comprise a pressure sensor arranged on the occupant-side of the pad body. In this case, the power generation device may be connected to the pressure sensor to supply electric power to the pressure sensor.

If the seat cushion comprises a pressure sensor, the pressure sensor may be arranged on an occupant-side of the power generation device in a position that overlaps the power generation device.

According to this configuration, the pressure sensor and the power generation device can be easily connected, and the sensitivity of the pressure sensor will not be impaired.

According to the above-described seat and seat cushion, electric power can be efficiently generated by the motions of the occupant. Further, the seat and the seat cushion, including the power generation device that can efficiently generate electric power, can be made more comfortable. Additionally, by locating the pressure sensor in a position that overlaps the occupant-side of the power generation device, the pressure sensor and the power generation device can be easily connected, and the sensitivity of the pressure sensor will not be impaired.

Objects to which the power generation device G supplies power are not limited to the pressure sensor. The power generation device may, for example, be connected to various electrical devices such as other types of sensors, a blower, a motor, a heater, a lighting fixture, provided either inside or outside of the seat. The above-described power generation device can also supply electric power in the following embodiments.

One example of a seat disclosed herein comprises a seat body and a cartridge. The seat body comprises a seat bottom, a seat back and a headrest. The cartridge is installable into and removable from the seat body. The headrest comprises an air outlet, an air inlet, a cartridge installation section, and a fan. The air outlet blows out air, and the air inlet draws in air. The cartridge is removably installed in the cartridge installation section. The fan forms an airflow, in the headrest, which flows from the air inlet, through the cartridge installation section, to the air outlet. The cartridge installed in the cartridge installation section allows the airflow that flows through the cartridge installation section to flow therethrough. The cartridge installation section is located in a portion of the headrest behind the head of an occupant.

According to this configuration, since the cartridge installation section is located in a portion of the headrest behind the head of the occupant, the cartridge may be easily replaced. Further, by providing a power generation device in at least one of the seat bottom, the seat back, and the headrest and connecting the power generation device to the fan, electric power can be supplied to the fan.

In the above-described seat, the cartridge may be installed in the cartridge installation section from behind or from above.

According to this configuration, the cartridge can be easily installed and removed.

In the above-described seat, the headrest may comprise a plurality of cartridge installation sections.

According to this configuration, a plurality of cartridges of different types and/or having different functions can be installed in the headrest. This makes it possible to switch the cartridge to be used among the cartridges provided in the cartridge installation sections according to the situation, preferences, etc., without replacing the cartridge.

In the above-described seat, the cartridge installation section may comprise an opening for installing the cartridge, and the headrest may comprise a cover movable between an open position to open the opening and a closed position to close the opening.

According to this configuration, the opening of the cartridge installation section can be closed by the cover when the car seat is used without the cartridge being installed.

In the above-described seat, the headrest may comprise a biasing member that biases the cover toward the closed position.

According to this configuration, the opening of the cartridge installation section can be automatically closed by the cover when the cartridge is removed. This prevents the cover from being left open.

In the above-described seat, the cartridge installation section may comprise claws that hold the cartridge when the cartridge is installed in the cartridge installation section.

According to this configuration, it is possible to keep the installed cartridge from being detached from the cartridge installation section.

In the above-described seat, the cartridge may comprise a ventilation portion that connects the interior and the exterior of the cartridge and allows an airflow that passes through the cartridge installation section to pass through the cartridge installed in the cartridge installation section.

In the above-described seat, the cartridge installation section may comprise a shutter that opens and closes the ventilation portion.

According to this configuration, since the airflow passing through the cartridge installation section can be switched between a state in which the airflow passes through the ventilation portions of the cartridge and a state in which the airflow does not pass through the ventilation portions of the cartridge by opening and closing the shutters, a user can choose whether or not to use the function of the cartridge. In a configuration comprising a plurality of cartridge installation sections, the cartridge to be used can be switched by switching the open/close state of the shutters for each cartridge installation section.

In the above-described seat, the headrest may comprise a first duct connecting the air inlet and the cartridge installation section, and a second duct connecting the cartridge installation section and the air outlet.

In the above-described seat, the cartridge may comprise at least one of a scenting device, a temperature regulator, an ion generator, and an air purifier.

In another example, a seat system disclosed herein comprises a seat, an obstacle detection sensor, and a control unit. The seat is installed in a car comprising a recognition unit that recognizes a size of an occupant's baggage. The seat is switchable between a normal state in which an occupant can be seated on the seat and a retracted state in which a storage space in a car cabin is larger than the storage space in the car cabin with the seat in the normal state. The obstacle detection sensor detects an obstacle in the trajectory of the seat switching from the normal state to the retracted state. The control unit is capable of executing a seat retraction process to change the state of the seat from the normal state to the retracted state, and determining whether or not to execute the seat retraction process.

If it is determined to execute the seat retraction process based on information from the recognition unit, the control unit determines whether or not an obstacle is in the trajectory based on information from the obstacle detection sensor before starting the seat retraction process. If it is determined that there is no obstacle, the control unit starts the seat retraction process. If it is determined that there is an obstacle, the control unit does not start the seat retraction process.

According to this configuration, since it is determined whether or not an obstacle is in the trajectory based on information from the obstacle detection sensor before starting the seat retraction process, and the seat retraction process is not started if it is determined that there is an obstacle, the movement of the seat, caused by execution of the seat retraction process, can be restrained from being restricted by an obstacle. Further, by providing a power generation device in the seat and connecting the power generation device to the obstacle detection sensor, electric power can be supplied to the obstacle detection sensor.

The obstacle detection sensor may detect presence or absence of objects on a seat surface of the seat.

According to this configuration, since the obstacle detection sensor can also be used as a sensor for a seat belt reminder, costs can be reduced.

The seat may comprise a seat bottom and a seat back that can be rotated with respect to the seat bottom, and the seat back may be folded to face the seat bottom when the seat is in the retracted state.

According to this configuration, since the seat back is folded to face the seat bottom when the seat is in the retracted state, storage space in a car cabin can be made larger than that when the seat is in the normal state.

The seat may be positioned in front of a trunk located at the rear of the car, and the seat in the retracted state may be located frontward of a position of the seat in the normal state.

According to this configuration, the trunk space can be made larger than that in the normal state.

If it is determined that there is an obstacle and the seat retraction process is not to be started, the control unit may inform the occupant of non-execution information indicating that the seat retraction process will not be executed.

According to this configuration, since the occupant outside the car, for example, can be aware that the seat is not in the retracted state before opening the car door based on the informed non-execution information, the occupant can put down his/her baggage on the ground before opening the car door. Thus, straining motions of the occupant holding the baggage with one hand and opening the car door with the other hand, expecting the seat to be in the retracted state, can be avoided.

The control unit may inform the occupant of the non-execution information via a portable terminal that can be carried by the occupant.

According to this configuration, since the non-execution information is informed via the portable terminal carried by the occupant, it is easier for the occupant to check the non-execution information compared to when the non-execution information is informed, for example, via an internal speaker of the car.

If it is determined that there is no obstacle and the seat retraction process is to be started, the control unit may inform the occupant of execution information indicating that the seat retraction process will be executed.

According to this configuration, since the occupant outside the car, for example, can be aware that the seat is in the retracted state before opening the car door based on the informed non-execution information, the occupant carrying the baggage can open the car door rest assured.

The control unit may inform the execution information via a portable terminal that can be carried by the occupant.

According to this configuration, since the execution information is informed by the portable terminal carried by the occupant, the occupant can more easily check the execution information compared to when the execution information is informed, for example, via an internal speaker of the car.

In yet another example, a seat system disclosed herein comprises a seat, an obstacle detection sensor, and a control unit. The seat is installed in a car that is switchable between a non-autonomous drive mode and an autonomous drive mode. The seat comprises a seat bottom and a seat back that is rotatable relative to the seat bottom. The seat is switchable between a normal state in which an occupant can be seated on the seat and a relaxing state in which the seat back is reclined compared to the normal state. The sensor detects an obstacle in the trajectory of the seat switching from the normal state to the relaxing state. The control unit is capable of executing a reclining process to change a state of the seat from the normal state to the relaxing state and determines whether or not the reclining process is to be executed.

If it is determined to execute the reclining process in response to the car being switched from the non-autonomous drive mode to the autonomous drive mode or a request from an occupant, the control unit determines whether or not an obstacle is in the trajectory based on information from the obstacle detection sensor before the reclining process is started, and if not, starts the reclining process, and if so, does not start the reclining process.

According to this configuration, since it is determined whether or not an obstacle is in the trajectory based on information from the obstacle detection sensor before starting the reclining process, and the reclining process is not started if it is determined that there is an obstacle, the movement of the seat, caused by execution of the reclining process, can be restrained from being restricted by an obstacle. Further, by providing a power generation device in the seat and connecting the power generation device to the obstacle detection sensor, electric power can be supplied to the obstacle detection sensor.

The seat system may further comprise a rear seat located behind the seat, and the obstacle detection sensor may detect the presence or absence of an object on the seat surface of the rear seat.

According to this configuration, since the obstacle detection sensor can also be used, for example, as a sensor for a seat belt reminder that detects whether or not an occupant is seated on the rear seat, costs can be reduced.

The seat in the relaxing state may be located in a position rearward of a position of the seat in the normal state.

According to this configuration, the space in front of the seat can be made larger than that in the normal state, and the occupant can thereby feel more relaxed.

The control unit may inform the occupant of non-execution information indicating that the reclining process will not be executed if the control unit determines that there is an obstacle and the reclining process is not to be started.

According to this configuration, the occupant can be aware that the reclining process will not be executed.

The control unit may inform the occupant of the non-execution information via a portable terminal carriable by the occupant.

According to this configuration, since the non-execution information is informed via the portable terminal carried by the occupant, it is not necessary to execute control such as to temporarily stop music being played by an internal speaker of the car, as would be necessary if, for example, the non-execution information is informed via the internal speaker of the car.

The control unit may inform the occupant of execution information indicating that the reclining process will be executed if it determines that there is no obstacle and the reclining process is to be started.

According to this configuration, the occupant can be aware that the reclining process will be executed.

The control unit may inform the occupant of the execution information via a portable terminal carriable by the occupant.

According to this configuration, since the execution information is informed via the portable terminal carried by the occupant, it is not necessary to execute control such as to temporarily stop music being played by the internal speaker of the car, as would be necessary if, for example, the execution information is informed via the internal speaker of the car.

In a further example, a car system disclosed herein comprises a pedal for operating a car, an obstacle detection sensor, and a control unit. The pedal is movable between an operable position in which the pedal is operable by an occupant, and a retracted position in which the pedal is located in a position farther from the occupant than that in the operable position. The obstacle detection sensor detects an obstacle in the trajectory of the pedal switching from the operable position to the retracted position. The control unit is capable of executing a pedal retraction process that changes the position of the pedal from the operable position to the retracted position and determining whether or not to execute the pedal retraction process.

If it is determined to execute the pedal retraction process, the control unit determines whether or not an obstacle is in the trajectory based on information from the obstacle detection sensor before the pedal retraction process is started, and if not, starts the pedal retraction process, and if so, does not start the pedal retraction process.

According to this configuration, since it is determined whether or not an obstacle is in the trajectory based on information from the obstacle detection sensor before starting the pedal retraction process, and the pedal retraction process is not started if it is determined that there is an obstacle, the movement of the pedal, caused by execution of the pedal retraction process, can be restrained from being restricted by an obstacle. Further, by providing a power generation device in a seat installed in the car and connecting the power generation device to the obstacle detection sensor, electric power can be supplied to the obstacle detection sensor.

The car may be switchable between a non-autonomous drive mode and an autonomous drive mode. The control unit may determine to execute the pedal retraction process on the condition that the car is switched from the non-autonomous drive mode to the autonomous drive mode.

According to this configuration, since determination of execution of the pedal retraction process is made on the condition that the car is switched from the non-autonomous drive mode to the autonomous drive mode, the pedal retraction process can be restrained from being executed during the non-autonomous drive mode.

The car system may further comprise a seat located behind the pedal, and the control unit may execute the pedal retraction process on the condition that an application program using the seat as a controller has been launched.

According to this configuration, since space in front of the seat can be made larger when the occupant uses the application program, the occupant may more easily operate the seat as the controller.

If it is determined that there is an obstacle and the pedal retraction process is not to be started, the control unit may prohibit execution of the application program.

According to this configuration, since execution of the application program is prohibited when the pedal retraction process is not started, the application program can be restrained from being executed with the pedal located in the operable position, and the pedal can be restrained from interfering with motions of the occupant.

If it is determined that there is an obstacle and the pedal retraction process is not to be started, the control unit may inform the occupant of non-execution information indicating that the pedal retraction process will not be executed.

According to this configuration, the occupant can be aware that the pedal retraction process will not be executed.

The control unit may inform the occupant of the non-execution information via a portable terminal carriable by the occupant.

According to this configuration, since the non-execution information is informed via the portable terminal carried by the occupant, it is not necessary to execute control such as to temporarily stop music being played by an internal speaker of the car, as would be necessary if, for example, the non-execution information is informed via the internal speaker of the car.

The control unit may inform the occupant of execution information indicating that the pedal retraction process will be executed if it determines that there is no obstacle and the pedal retraction process is to be started.

According to this configuration, the occupant can be aware that the pedal retraction process will be executed.

The control unit may inform the occupant of the execution information via a portable terminal carriable by the occupant.

According to this configuration, since the execution information is informed via the portable terminal carried by the occupant, it is not necessary to execute control such as to temporarily stop music being played by the internal speaker of the car, as would be necessary if, for example, the execution information is informed via the internal speaker of the car.

In a yet a further example, a seat system disclosed herein comprises a seat, an obstacle detection sensor, and a control unit. The seat is rotatable about an axis extending in a vertical direction between a first orientation and a second orientation different from the first orientation. The obstacle detection sensor detects an obstacle in the trajectory of the seat switching from the first orientation to the second orientation. The control unit is capable of executing a seat orientation change process for changing an orientation of the seat from the first orientation to the second orientation and determines whether or not the seat orientation change process is to be executed.

If it is determined to execute the seat orientation change process, the control unit determines whether or not an obstacle is in the trajectory based on information from the obstacle detection sensor before the seat orientation change process is started, and if not, starts the seat orientation change process, and if so, does not start the seat orientation change process.

According to this configuration, since it is determined whether or not an obstacle is in the trajectory based on information from the obstacle detection sensor before starting the seat orientation change process, and the seat orientation change process is not started if it is determined that there is an obstacle, the movement of the seat, caused by execution of the seat orientation change process, can be restrained from being restricted by an obstacle. Further, by providing a power generation device in the seat and connecting the power generation device to the obstacle detection sensor, electric power can be supplied to the obstacle detection sensor.

The control unit may be capable of determining whether or not occupants should be placed in a state in which they can easily communicate with each other. If it is determined that the occupants should be placed in a state in which they can easily communicate with each other, the control unit may determine to execute the seat orientation change process.

The seat may be installed in a car that can be driven in an autonomous drive mode, and the control unit may determine to execute the seat orientation change process in response to a request from the occupant received during the autonomous drive mode.

According to this configuration, the orientation of the seat can be restrained from being changed during the non-autonomous drive mode or when there is no request from the occupant.

If it is determined that there is an obstacle and the seat orientation change process is not to be started, the control unit may inform the occupant of non-execution information indicating that the seat orientation change process will not be executed.

According to this configuration, the occupant can be aware that the seat orientation change process will not be executed.

The control unit may inform the occupant of the non-execution information via a portable terminal carriable by the occupant.

According to this configuration, since the non-execution information is informed via the portable terminal carried by the occupant, it is not necessary to execute control such as to temporarily stop music being played by an internal speaker of the car, as would be necessary if, for example, the non-execution information is informed via the internal speaker of the car.

The control unit may inform the occupant of execution information indicating that the seat orientation change process will be executed if it determines that there is no obstacle and the seat orientation change process is to be started.

According to this configuration, the occupant can be aware that the seat orientation change process will be executed.

The control unit may inform the occupant of the execution information via a portable terminal carriable by the occupant.

According to this configuration, since the execution information is informed via the portable terminal carried by the occupant, it is not necessary to execute control such as to temporarily stop music being played by the internal speaker of the car, as would be necessary if, for example, the execution information is informed via the internal speaker of the car.

In yet another example, a seat disclosed herein comprises a seat bottom cushion, a seat back cushion, a base section, a blower, and a user-operable control. The base section comprises a lower support portion that supports the seat bottom cushion from below, and a rear support portion that supports the seat back cushion from behind. The user-operable control allows the user to operate the blower. The seat bottom cushion is attachable to and detachable from the lower support portion. The seat back cushion is attachable to and detachable from the rear support portion. At least one of the seat bottom cushion and the seat back cushion has a cushion airflow passage through which an airflow formed by the blower flows. The cushion airflow passage has a vent opening that opens toward an occupant. The user-operable control is located on the left side surface or the right side surface of the base section, or a side portion protruding above the seat cushion and located on at least one of the right and left sides of the seat cushion.

According to this configuration, since it is possible to blow out or draw in air from the seat bottom cushion and/or the seat back cushion, the comfort of the occupant can be improved. Further, since the user-operable control is provided on the side surface of the base section or the side portion, the user-operable control may be operated more easily. Additionally, by providing a power generation device in the seat and connecting the power generation device to the fan and/or user-operable control, electric power can be supplied to the fan and/or user-operable control.

In yet a further example, a seat disclosed herein comprises a seat body, a side portion, and a sheet-shaped heater. The seat body comprises a seat bottom, on which a person is to be seated, and a seat back. The side portion is located on at least one of the left and right sides of the seat bottom and protrudes above the seat bottom. The heater comprises at least one of a seat bottom heater and a seat back heater, and a side heater. The seat bottom heater heats a surface of the seat bottom facing the occupant. The seat back heater heats a surface of the seat back facing the occupant. The side heater heats a surface of the side portion facing the occupant.

According to this configuration, the surface of the seat bottom facing the occupant can be heated by the seat bottom heater, the surface of the seat back facing the occupant can be heated by the seat back heater, and the surface of the side portion facing the occupant can be heated by the side heater. The comfort of the occupant can thereby be improved. Additionally, by providing a power generation device in the seat and connecting the power generation device to the heater, electric power can be supplied to the heater.

In yet another example, a seat disclosed herein comprises a seat body, a headrest, and a sheet-shaped heater. The seat body comprises a seat bottom, on which a person is to be seated, and a seat back. The heater comprises at least one of a seat bottom heater and a seat back heater, and a headrest heater. The seat bottom heater heats a surface of the seat bottom facing the occupant. The seat back heater heats a surface of the seat back facing the occupant. The headrest heater heats a surface of the headrest facing the occupant.

According to this configuration, the surface of the seat bottom facing the occupant can be heated by the seat bottom heater, the surface of the seat back facing the occupant can be heated by the seat back heater, and the surface of the headrest facing the occupant can be heated by the headrest heater. The comfort of the occupant can thereby be improved. Additionally, by providing a power generation device in at least one of the seat bottom, the seat back, and the headrest, and connecting the power generation device to the heater, electric power can be supplied to the heater.

The above aspects, other advantages and further features will become more apparent by describing in detail illustrative, non-limiting embodiments thereof with reference to the accompanying drawings, in which:

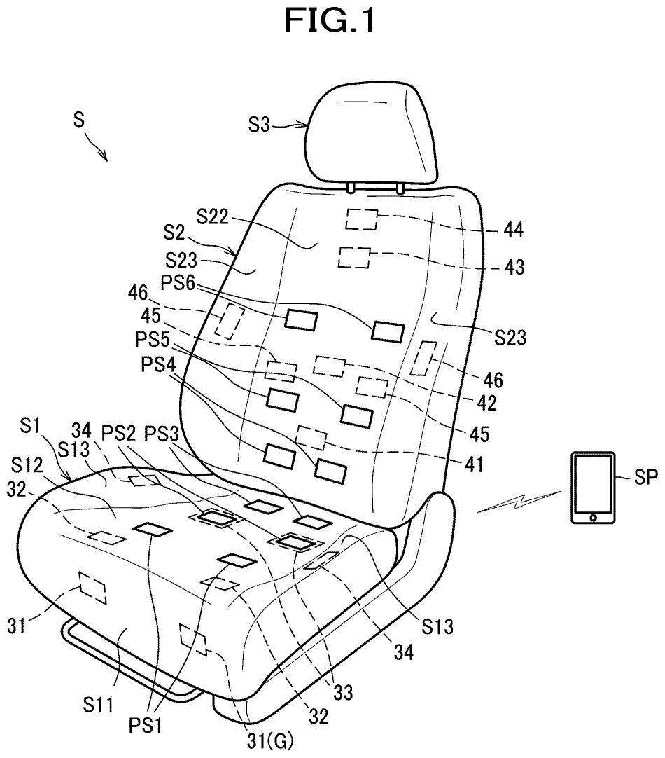

FIG. 1 is a perspective view of a seat according to a first example;

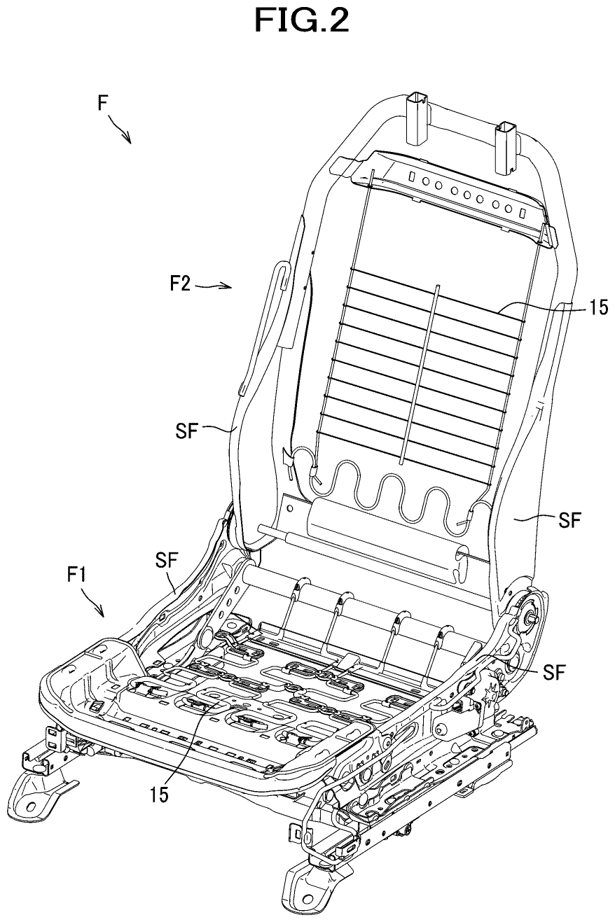

FIG. 2 is a perspective view a seat frame;

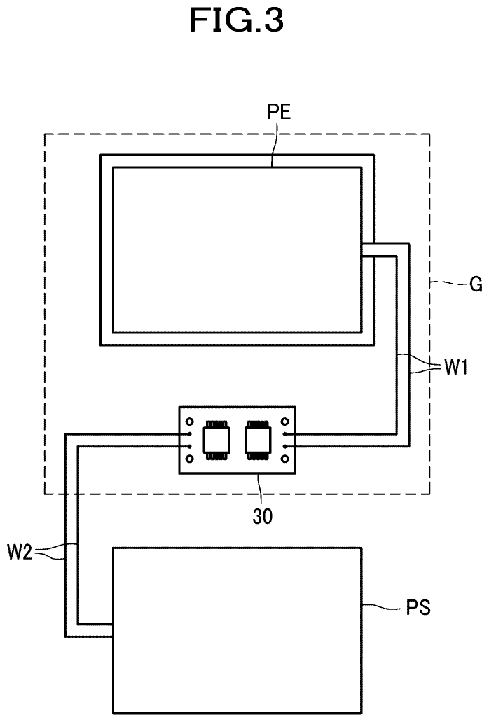

FIG. 3 is an illustration showing a power generation device, a pressure sensor and connections between the power generation device and the pressure sensor;

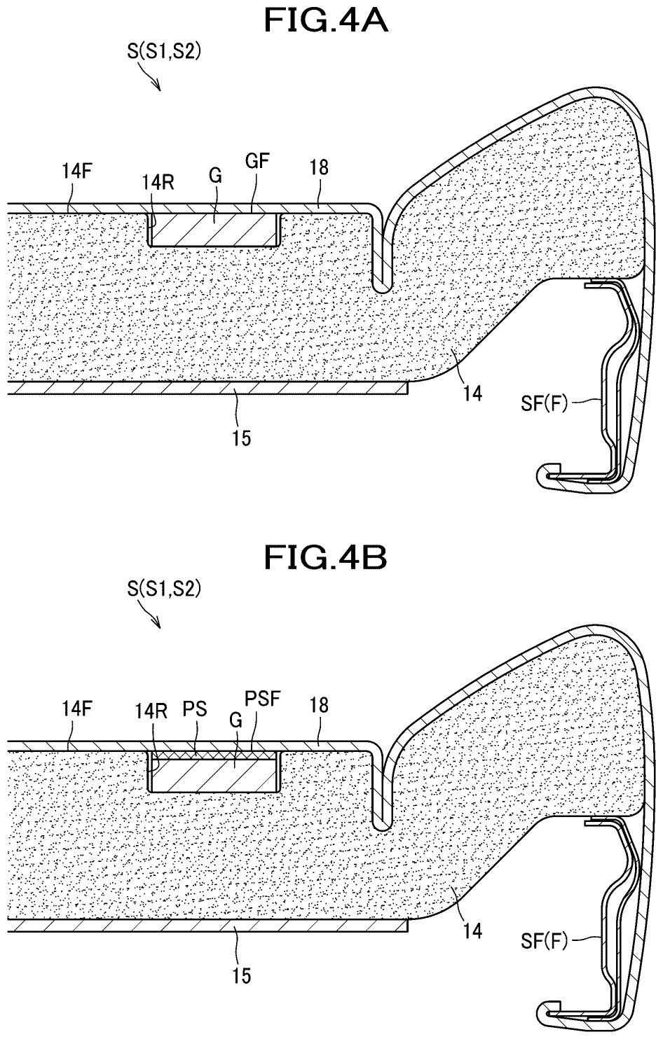

FIG. 4A is a cross-sectional view of a portion of the seat in which the power generation device is located;

FIG. 4B is a cross-sectional view of a portion of the seat in which the power generation device and the pressure sensor is located;

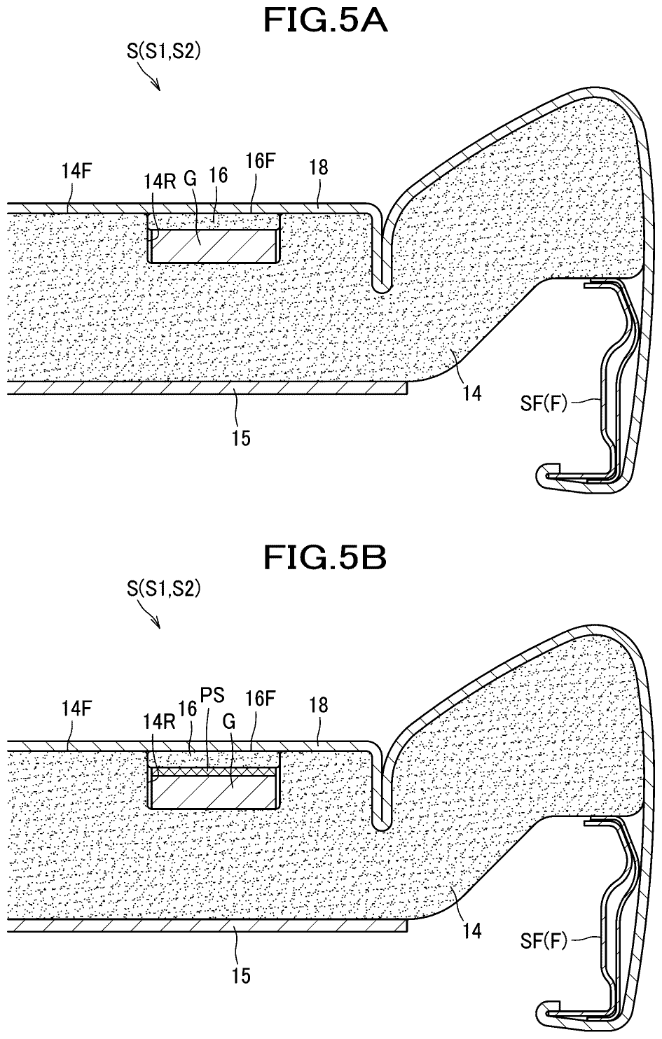

FIG. 5A is a cross-sectional view of a portion of the seat in which the power generation device is located with a cover pad provided;

FIG. 5B is a cross-sectional view of a portion of the seat in which the power generation device and the pressure sensor is located with the cover pad provided;

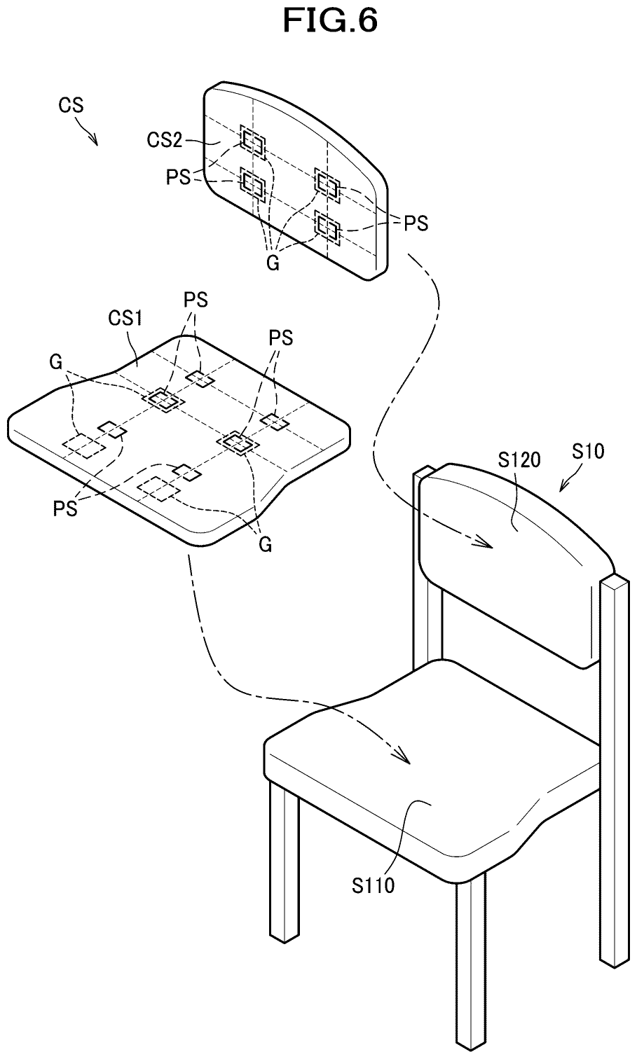

FIG. 6 is a perspective view of a seat cushion according to a second example;

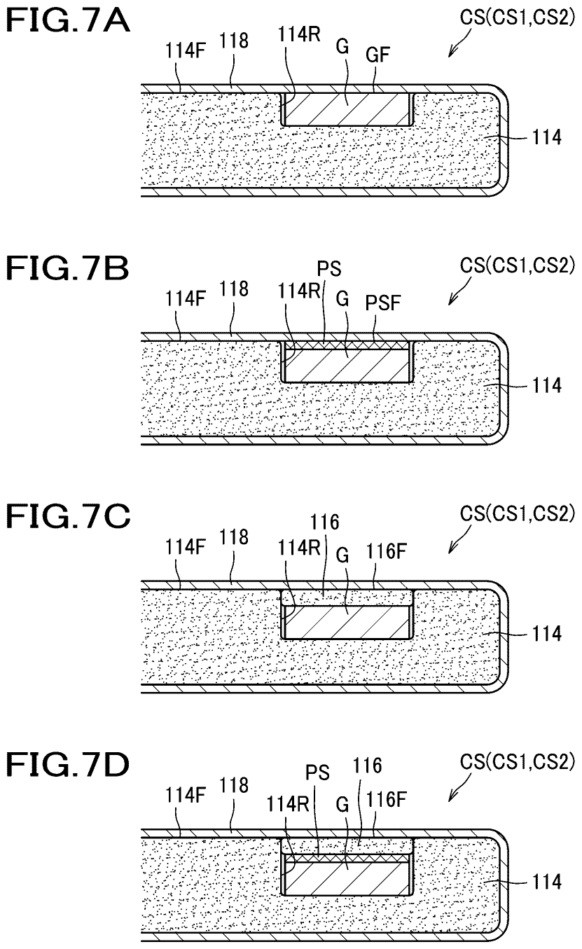

FIG. 7A is a cross-sectional view of a portion of the seat cushion in which a power generation device is located;

FIG. 7B is a cross-sectional view of a portion of the seat cushion in which the power generation device and a pressure sensor is located;

FIG. 7C is a cross-sectional view of a portion of the seat cushion in which the power generation device is located with a cover pad provided;

FIG. 7D is a cross-sectional view of a portion of the seat cushion in which the power generation device and the pressure sensor is located with the cover pad provided;

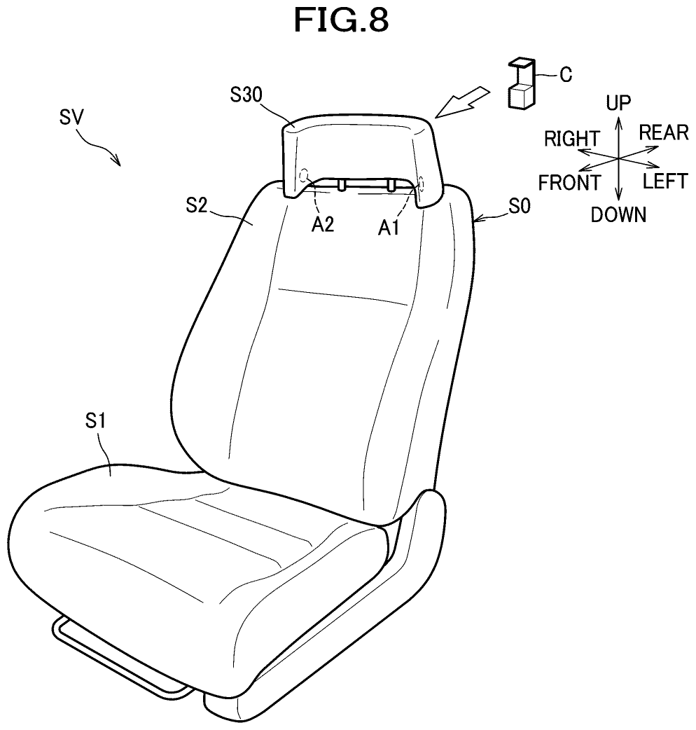

FIG. 8 is a perspective view of a seat according to a third example;

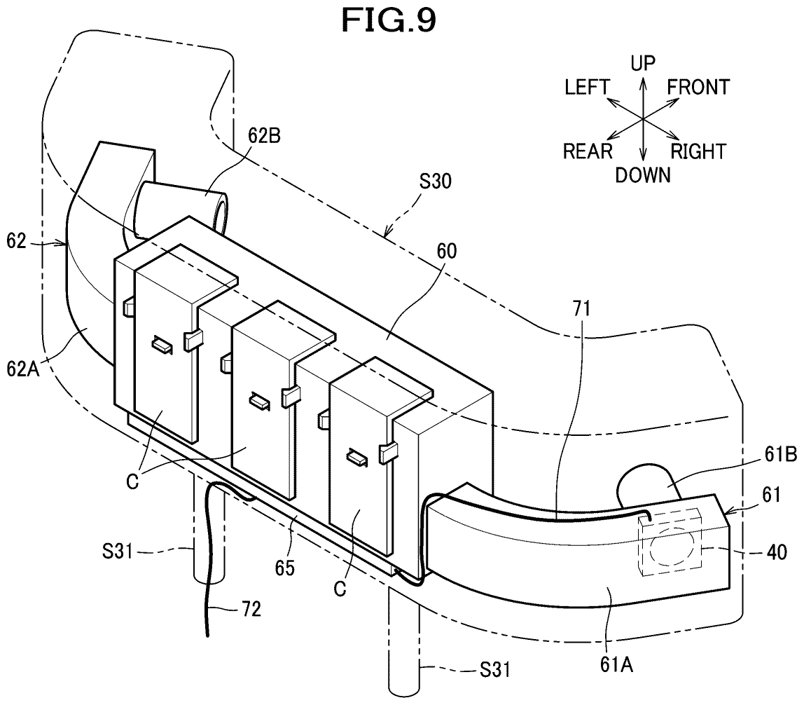

FIG. 9 is a perspective view showing a configuration of a headrest;

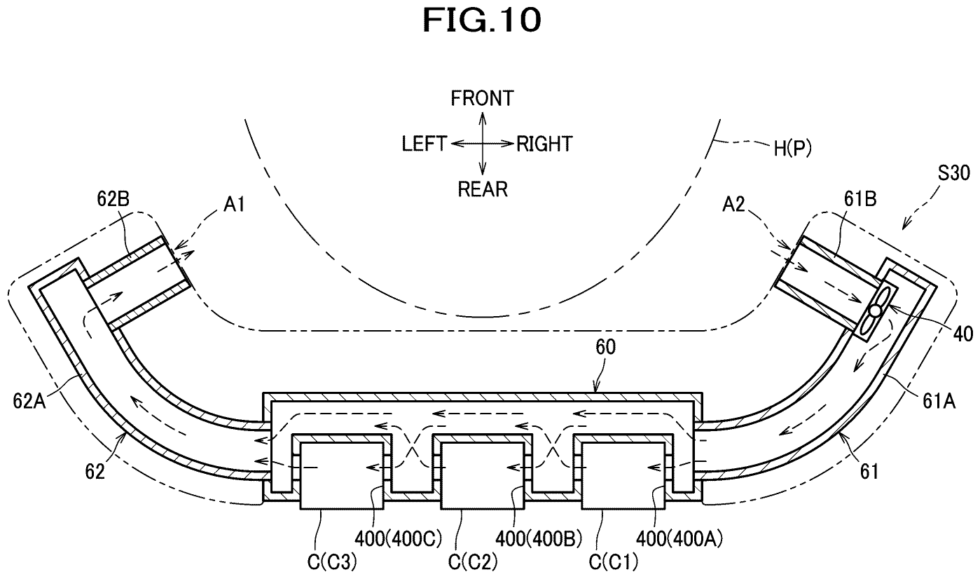

FIG. 10 is a cross-sectional view showing the configuration of the headrest;

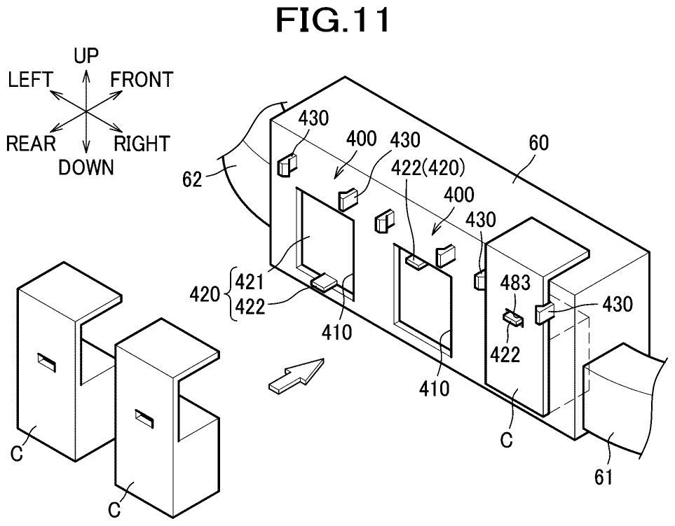

FIG. 11 is a perspective view showing cartridges and cartridge installation sections of the third example;

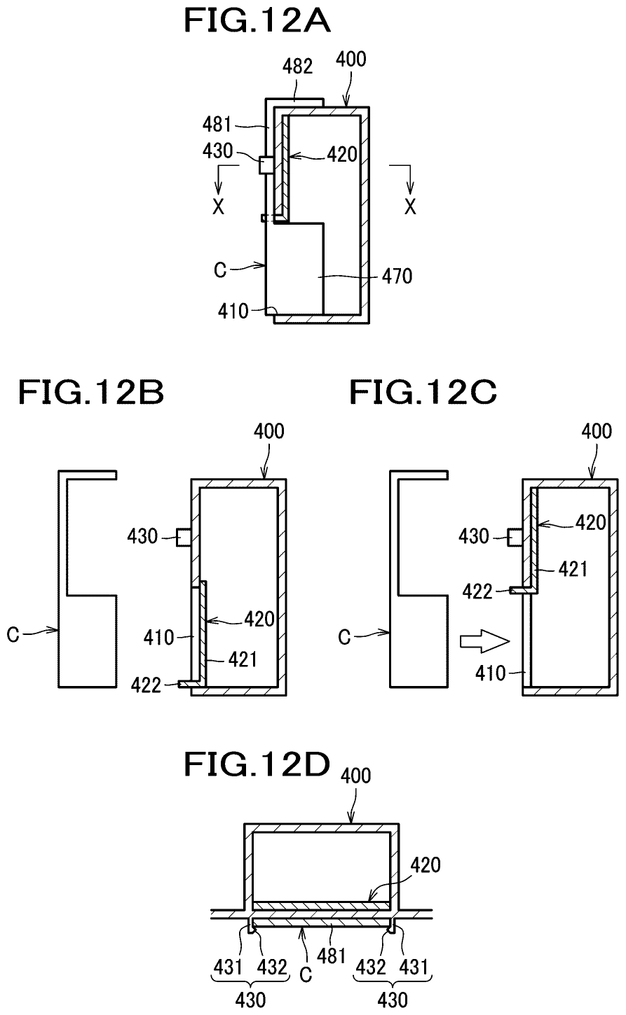

FIG. 12A is a cross-sectional view of a cartridge installation section with a cartridge installed therein;

FIG. 12B is a cross-sectional view of the cartridge and the cartridge installation section with a cover in a closed position;

FIG. 12C is a cross-sectional view of the cartridge and the cartridge installation section with the cover in an open position;

FIG. 12D is a cross-sectional view of the cartridge installation section with the cartridge installed therein taken along line X-X of FIG. 12A;

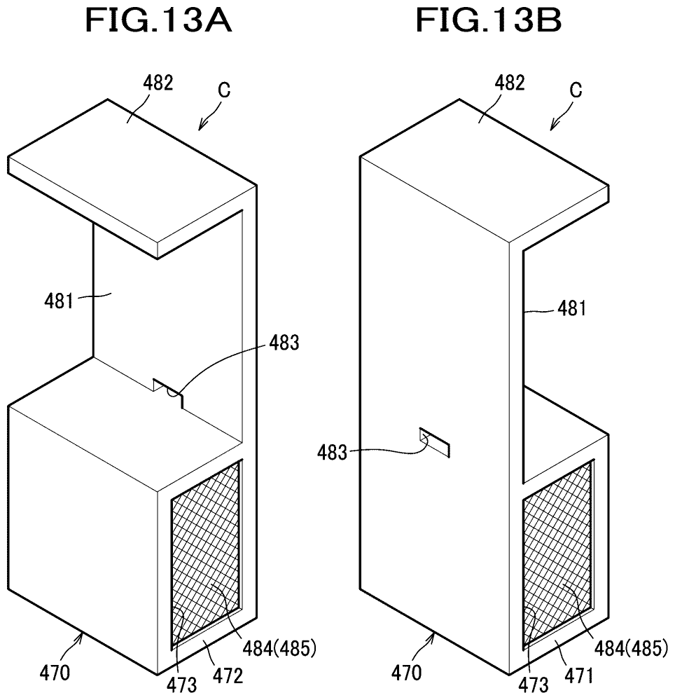

FIGS. 13A and 13B are perspective views of the cartridge;

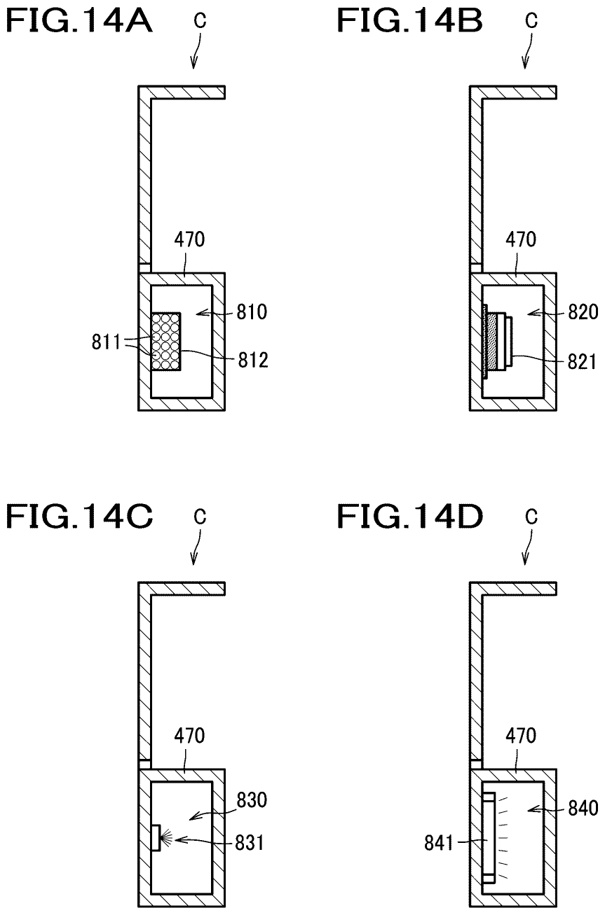

FIGS. 14A to 14D are cross-sectional views of concrete configurations of the cartridge;

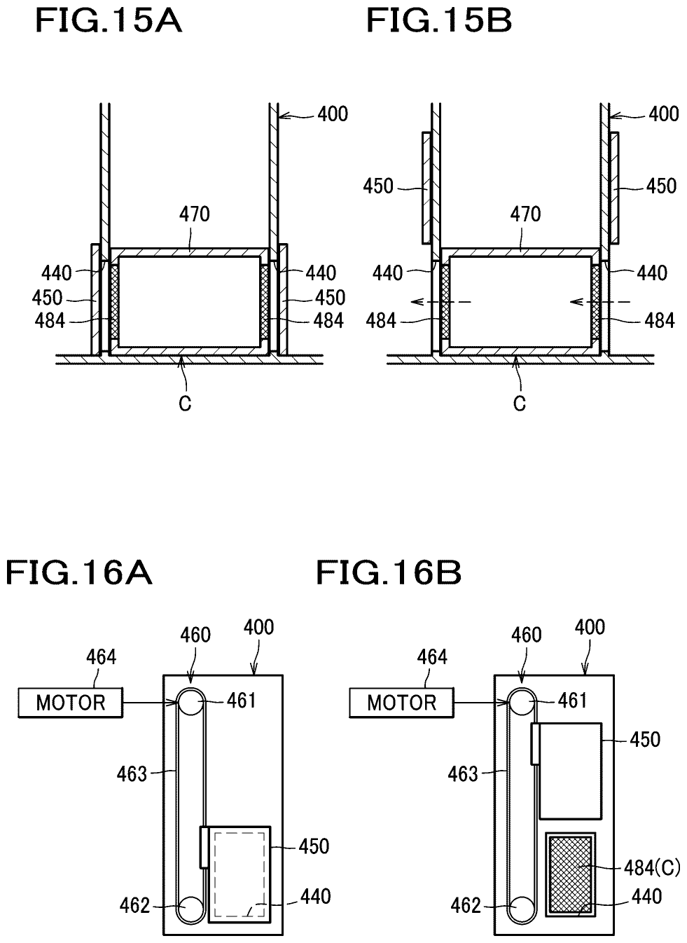

FIG. 15A is a cross-sectional view of the cartridge installation section with the cartridge installed therein showing shutters in a fully closed position;

FIG. 15B is a cross-sectional view of the cartridge installation section with the cartridge installed therein showing shutters in a fully open position;

FIGS. 16A and 16B are illustrations showing an example of a shutter drive mechanism;

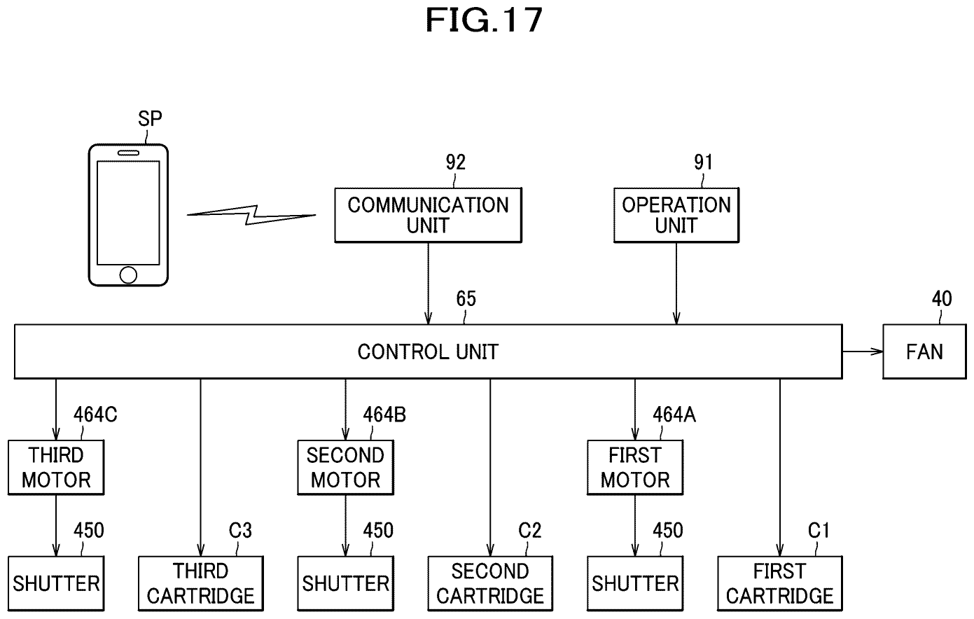

FIG. 17 is a control block diagram of the seat;

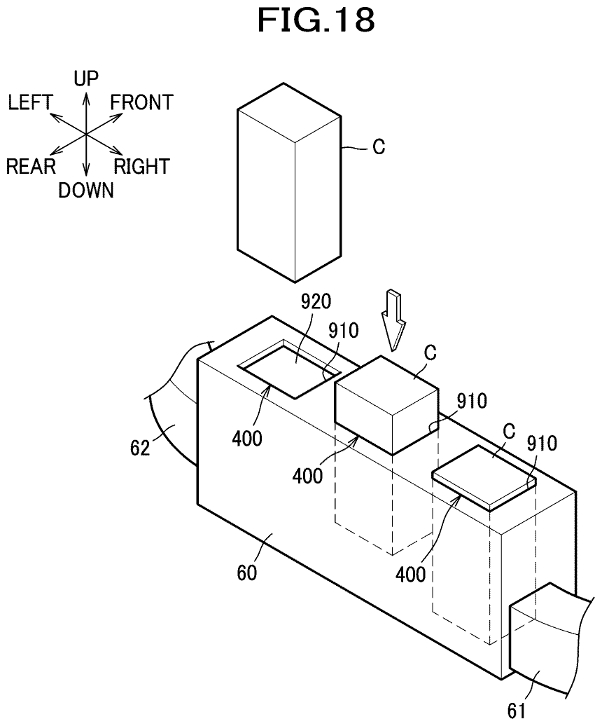

FIG. 18 is a perspective view showing cartridges and cartridge installation sections according to a fourth example;

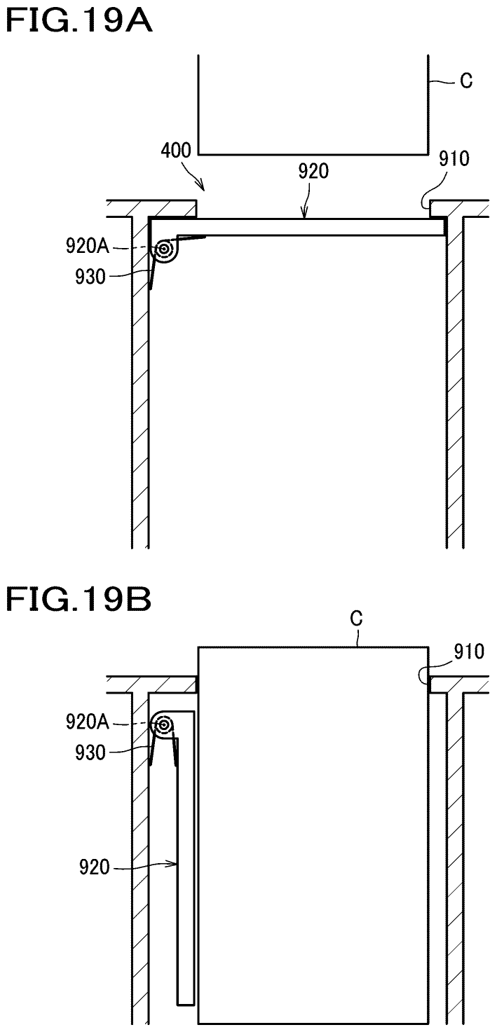

FIG. 19A is a cross-sectional view of a cartridge and a cartridge installation section of the fourth example with a cover in a closed position;

FIG. 19B is a cross-sectional view of the cartridge installation section of the fourth example with the cartridge installed therein and the cover in an open position;

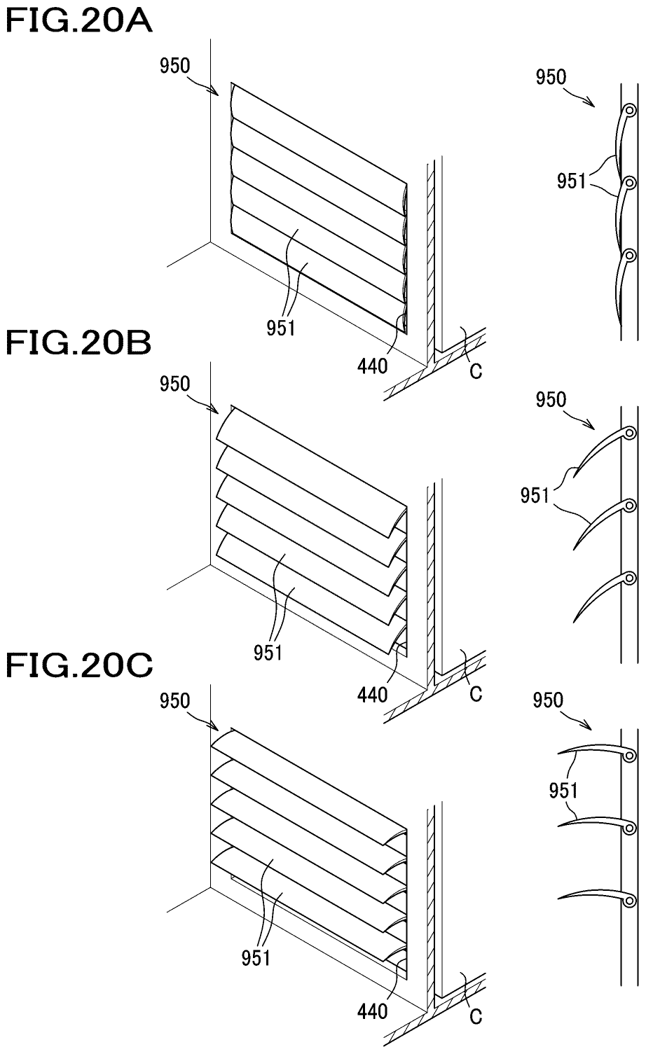

FIGS. 20A to 20C are illustrations showing modified examples of a shutter;

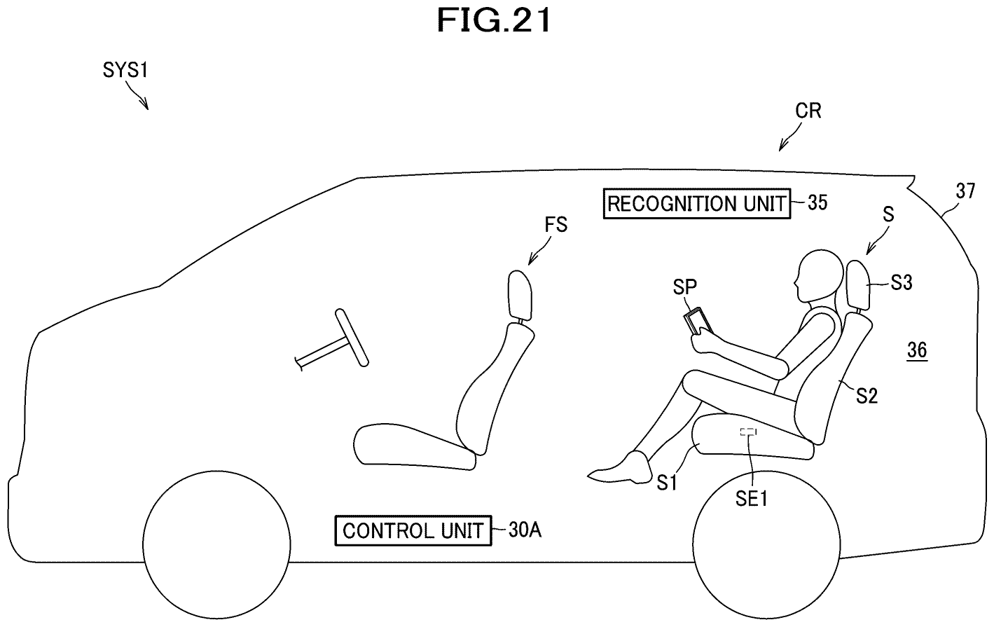

FIG. 21 is an illustration of a seat system according to a fifth example;

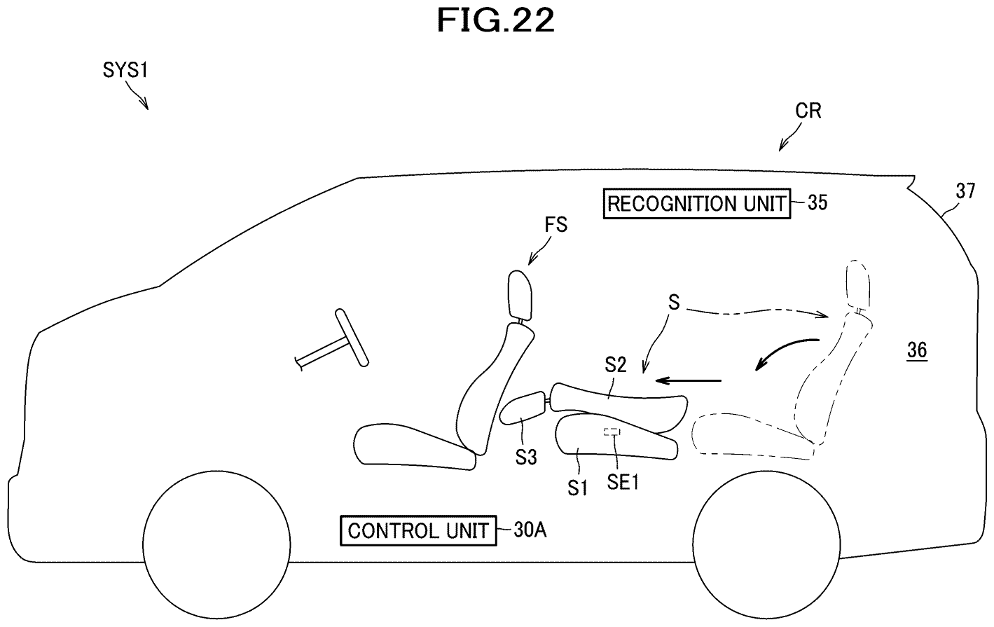

FIG. 22 is an illustration showing a seat moved from a normal state to a retracted state;

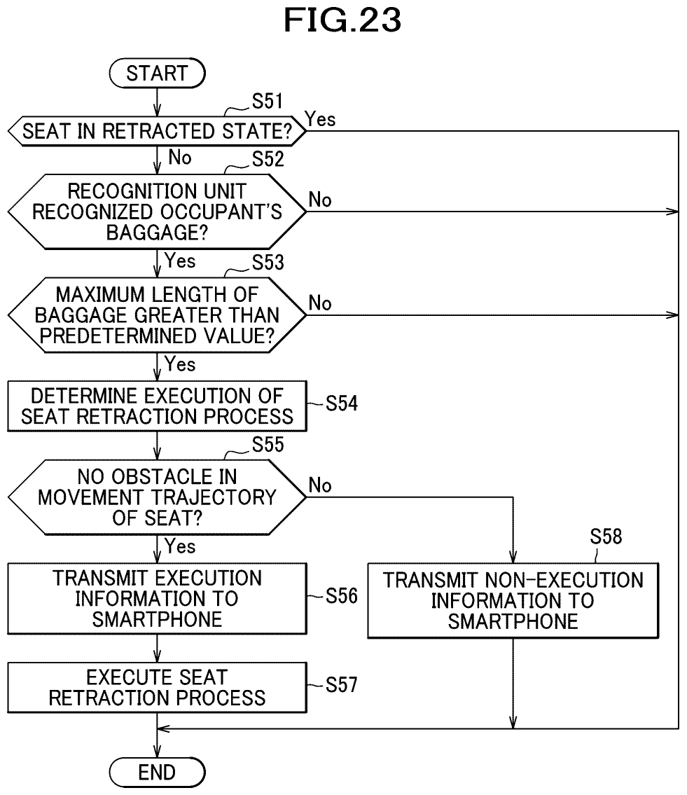

FIG. 23 is a flowchart showing the operation of a control unit;

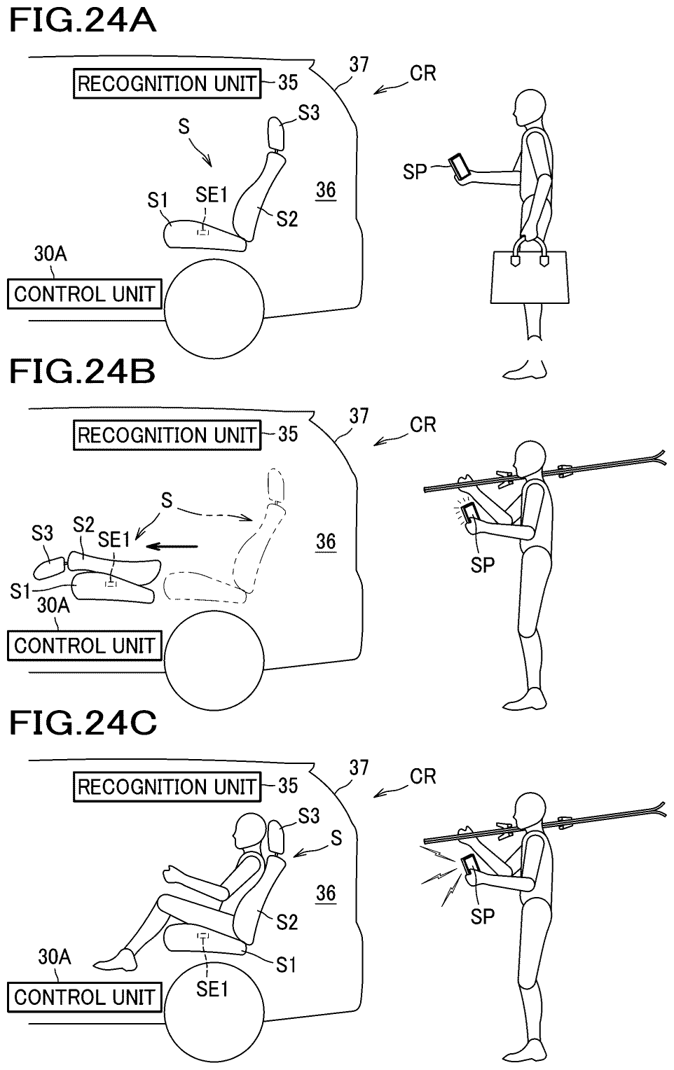

FIGS. 24A to 24C are illustrations showing specific examples of the operation of the control unit;

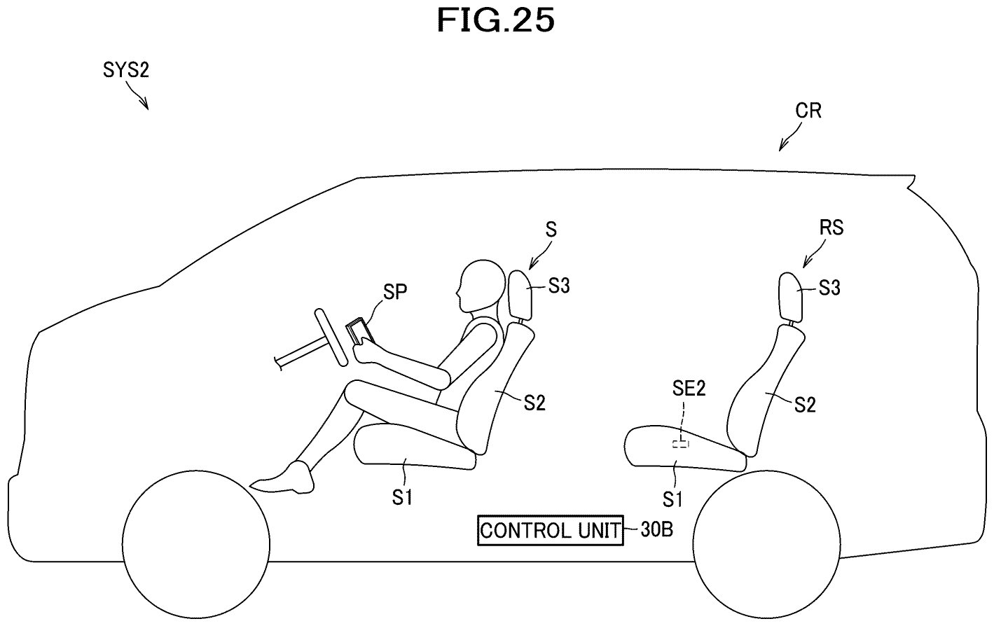

FIG. 25 is an illustration showing a seat system according to a sixth example;

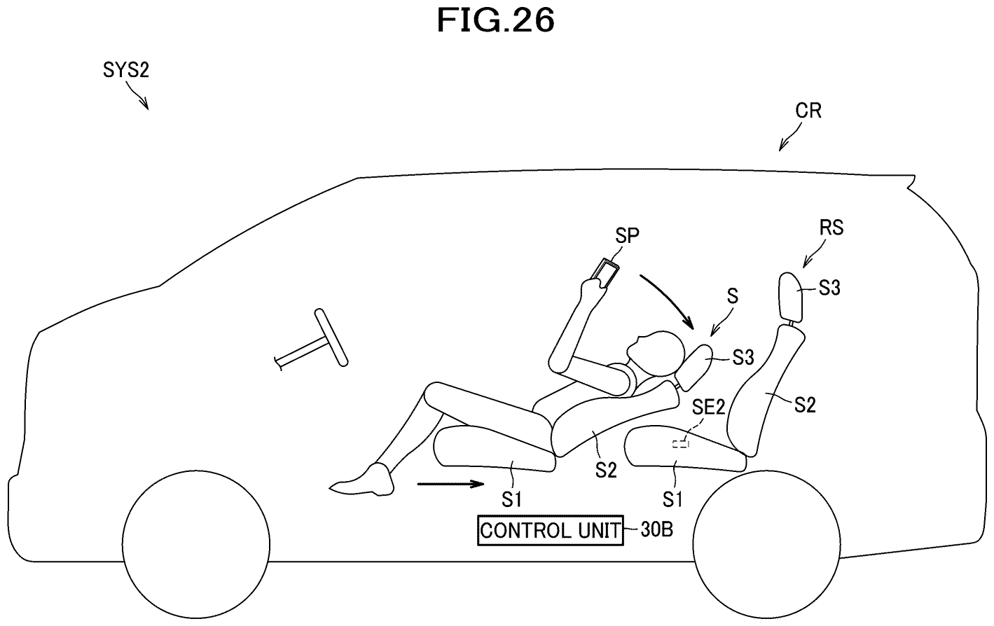

FIG. 26 is an illustration showing a seat switched from a normal state to a relaxing state;

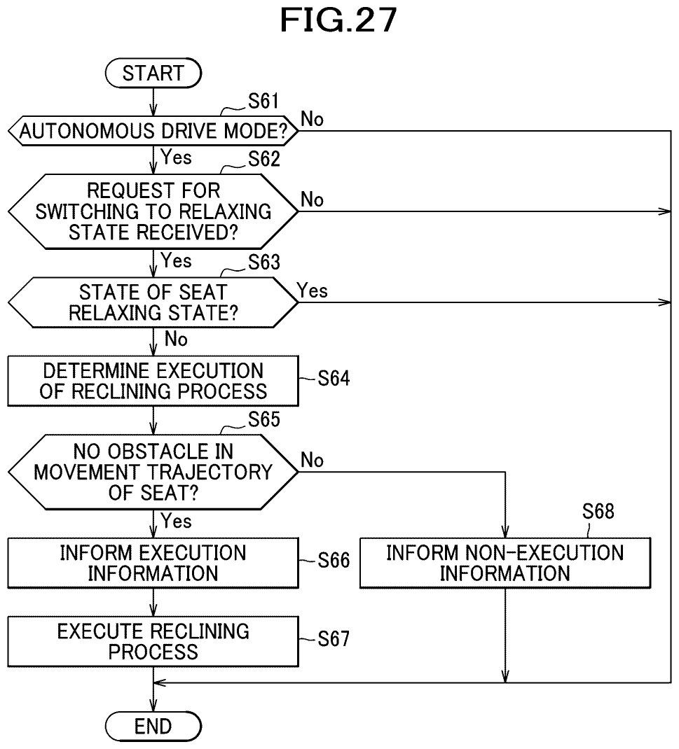

FIG. 27 is a flowchart showing the operation of a control unit;

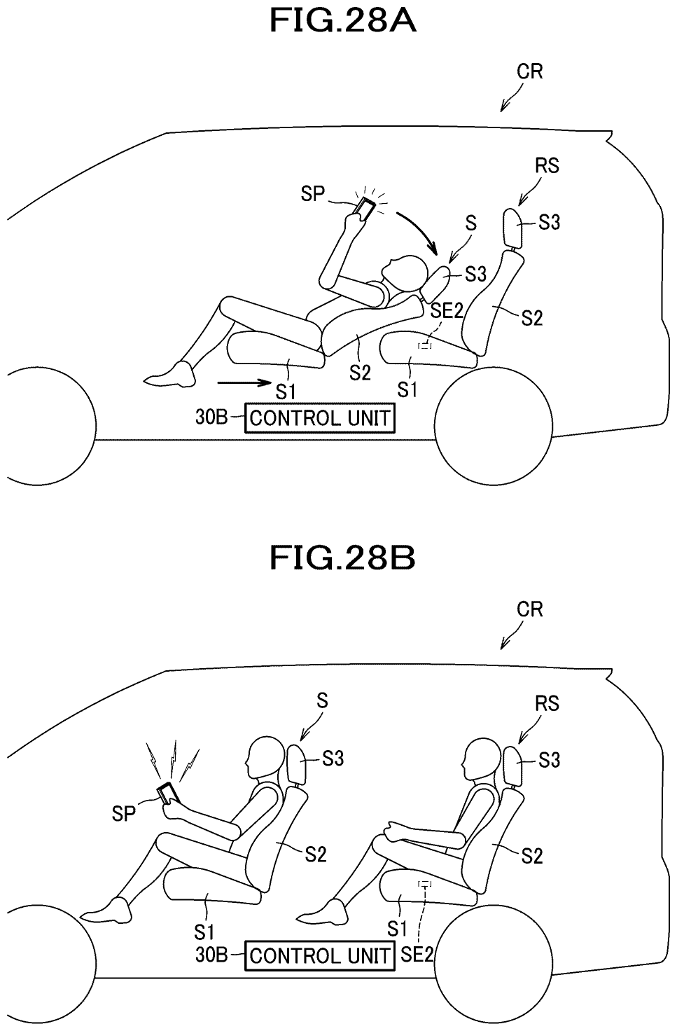

FIGS. 28A and 28B are illustrations showing specific examples of the operation of the control unit;

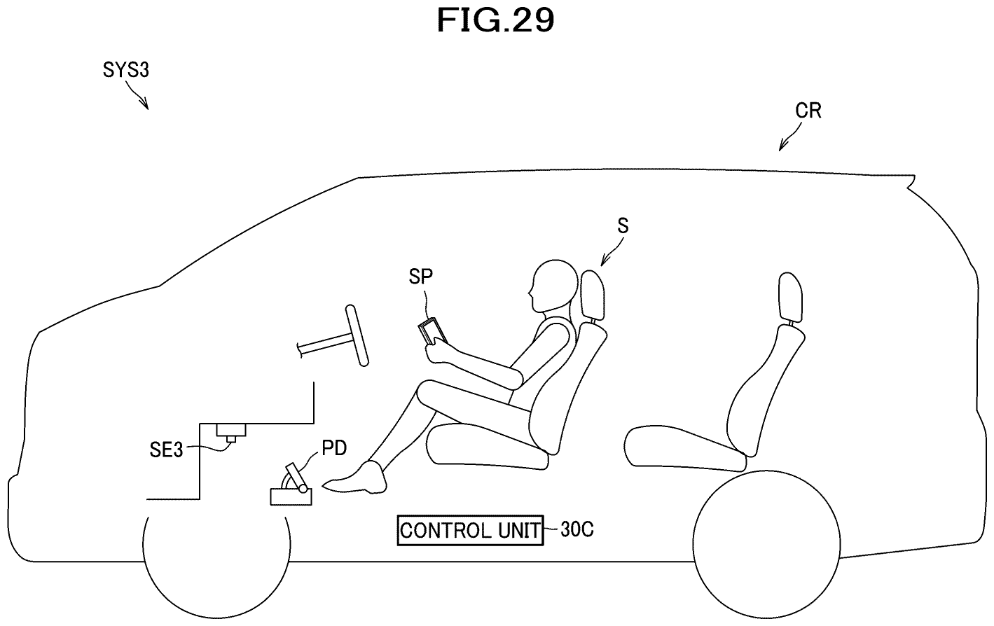

FIG. 29 is an illustration showing a car system according to a seventh example;

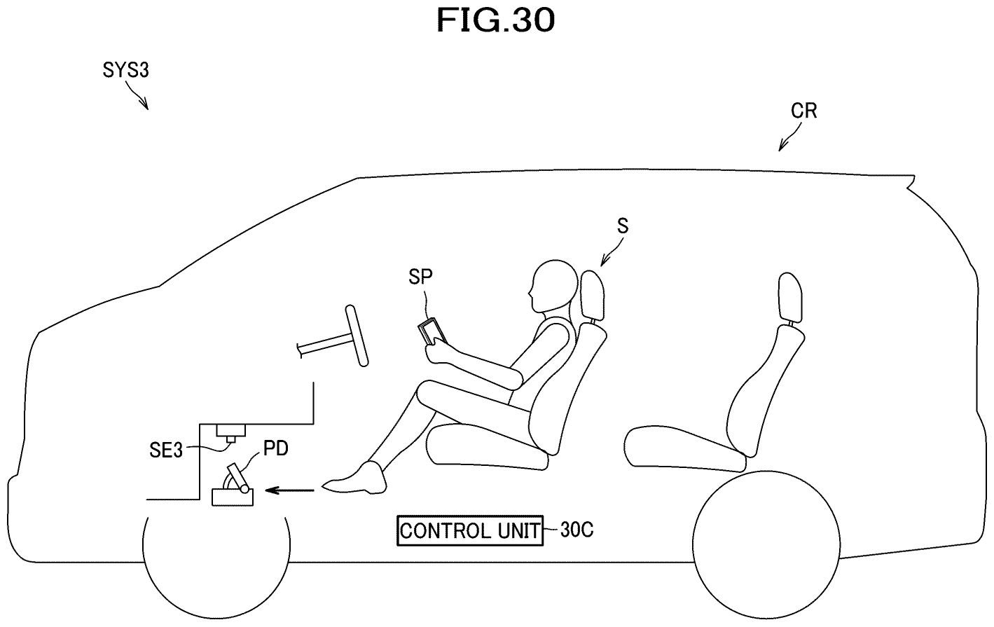

FIG. 30 is an illustration showing a pedal moved from an operable position to a retracted position;

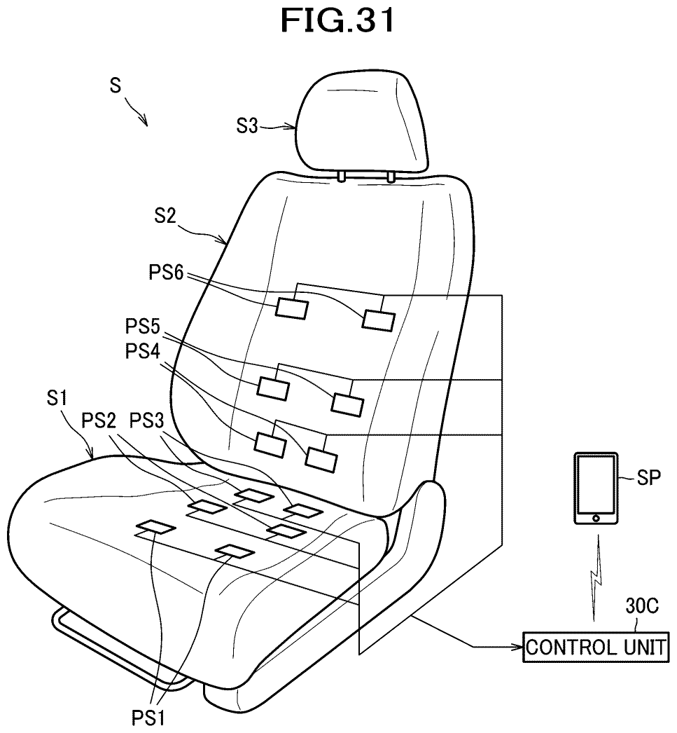

FIG. 31 is an illustration for explaining the configuration of a seat;

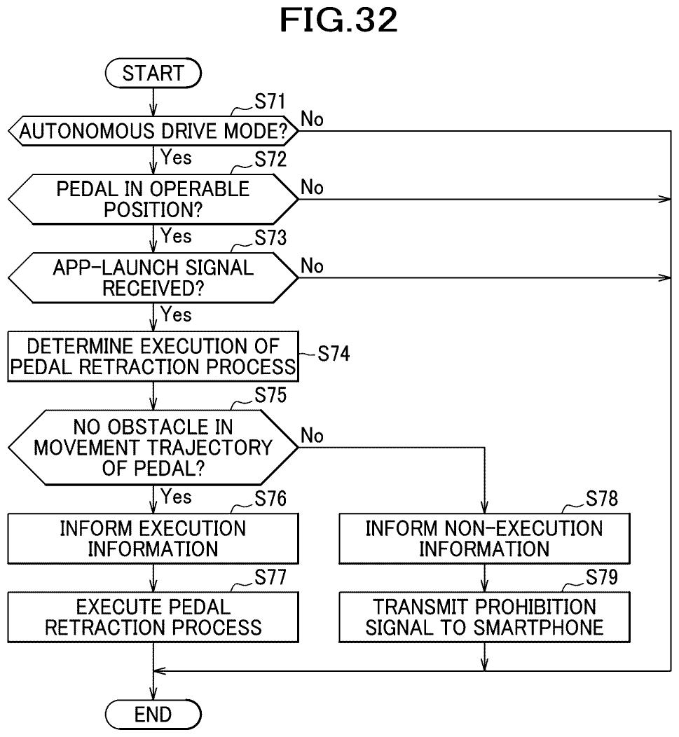

FIG. 32 is a flowchart showing the operation of a control unit;

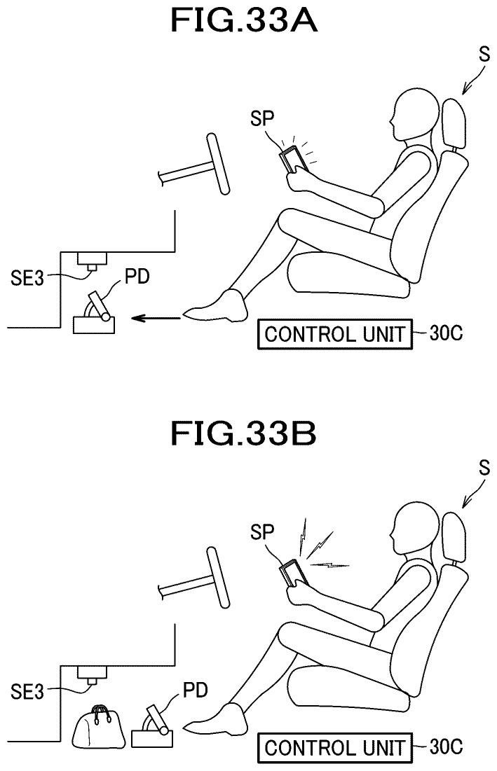

FIGS. 33A and 33B are illustrations showing specific examples of the operation of the control unit;

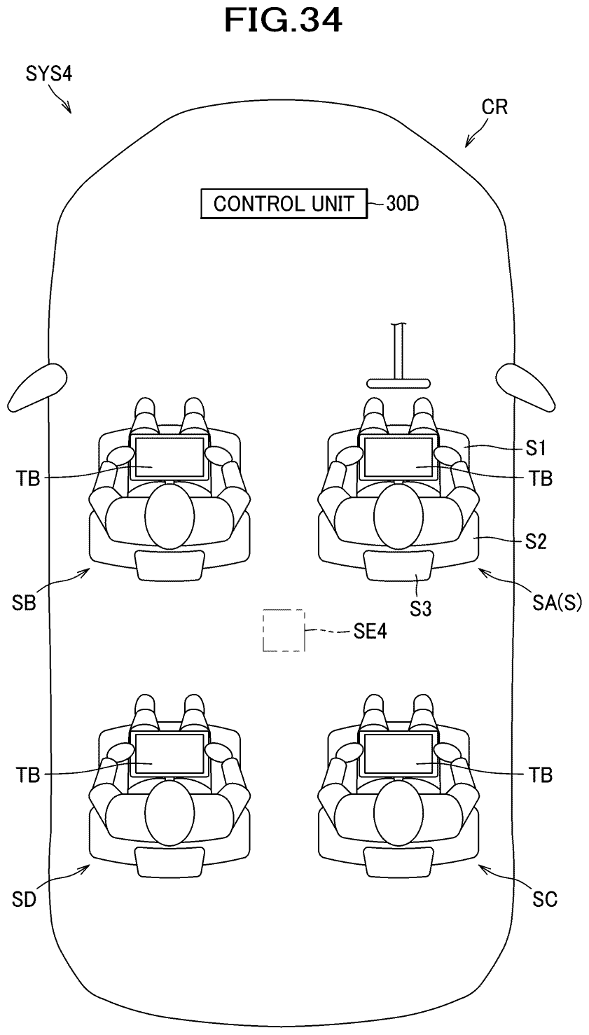

FIG. 34 is an illustration showing a seat system according to an eighth example;

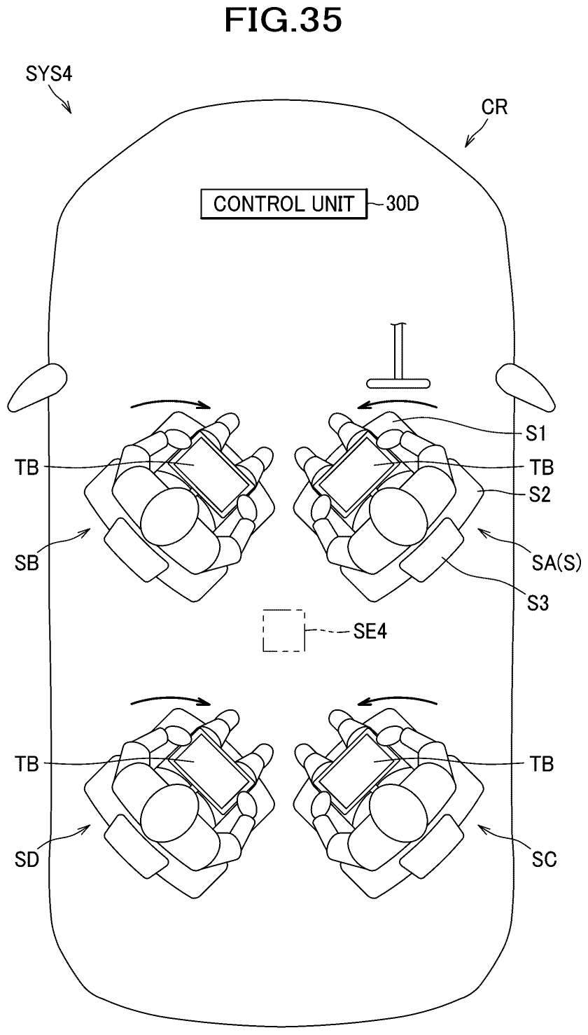

FIG. 35 is an illustration showing seats switched from a first orientation to a second orientation;

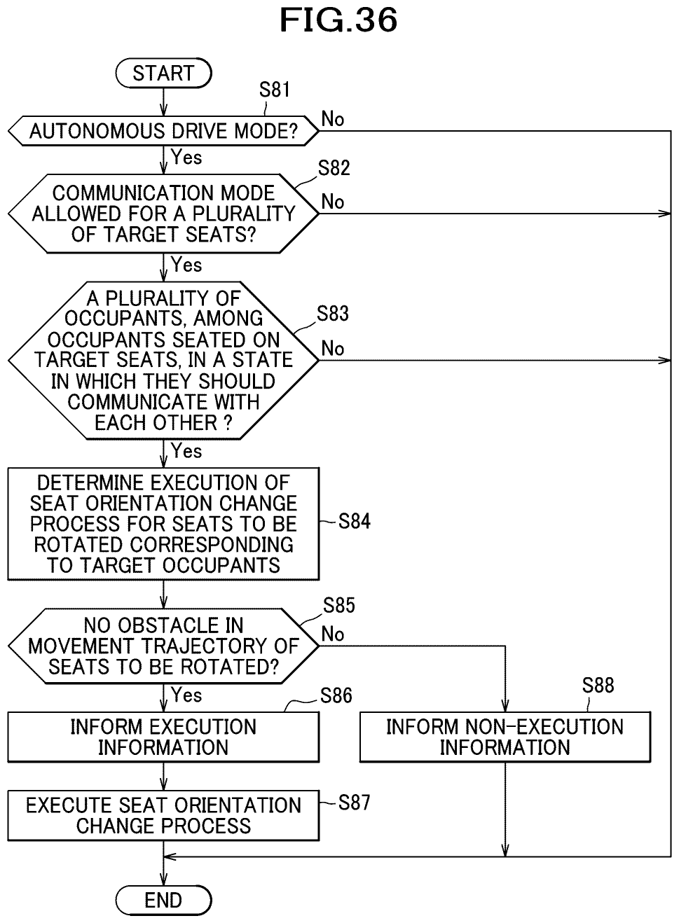

FIG. 36 is a flowchart showing the operation of a control unit;

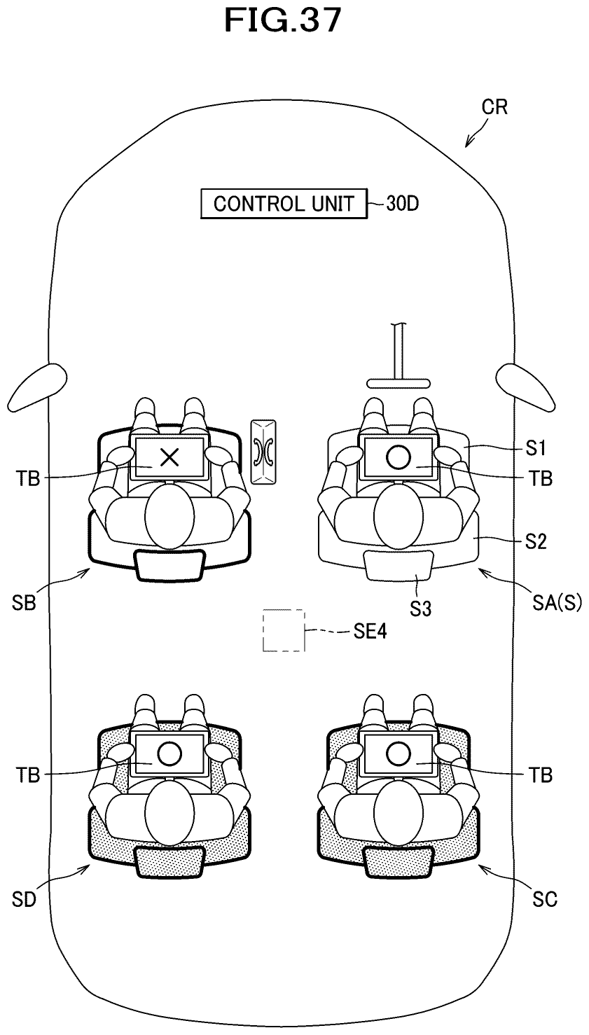

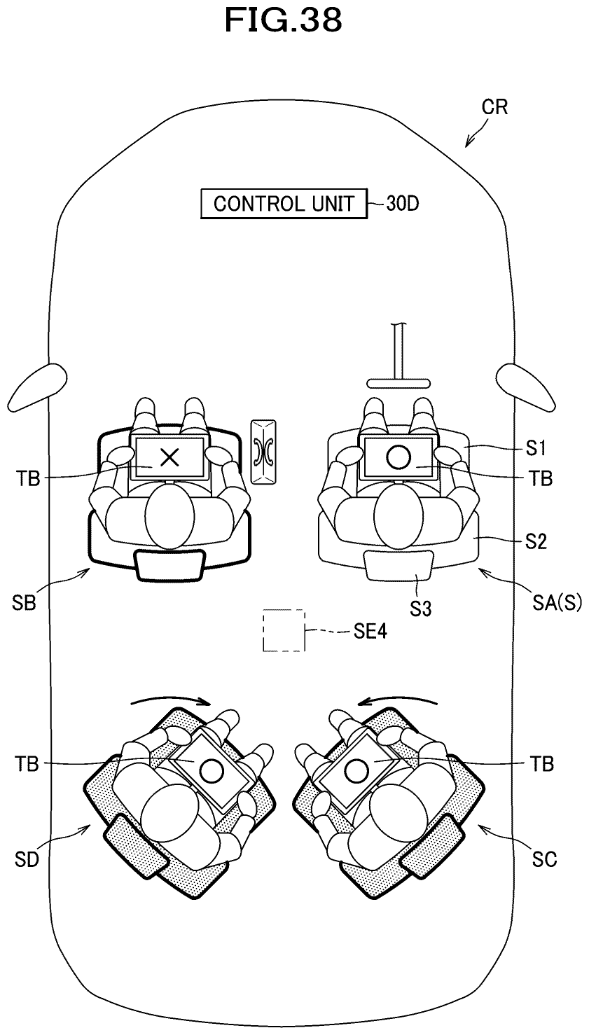

FIG. 37 is an illustration showing a specific example of the operation of the control unit in which the front passenger seat and the two seats in the second row are target seats, and the two seats in the second row are seats to be rotated;

FIG. 38 is an illustration showing the state after the seat orientation change process has been executed;

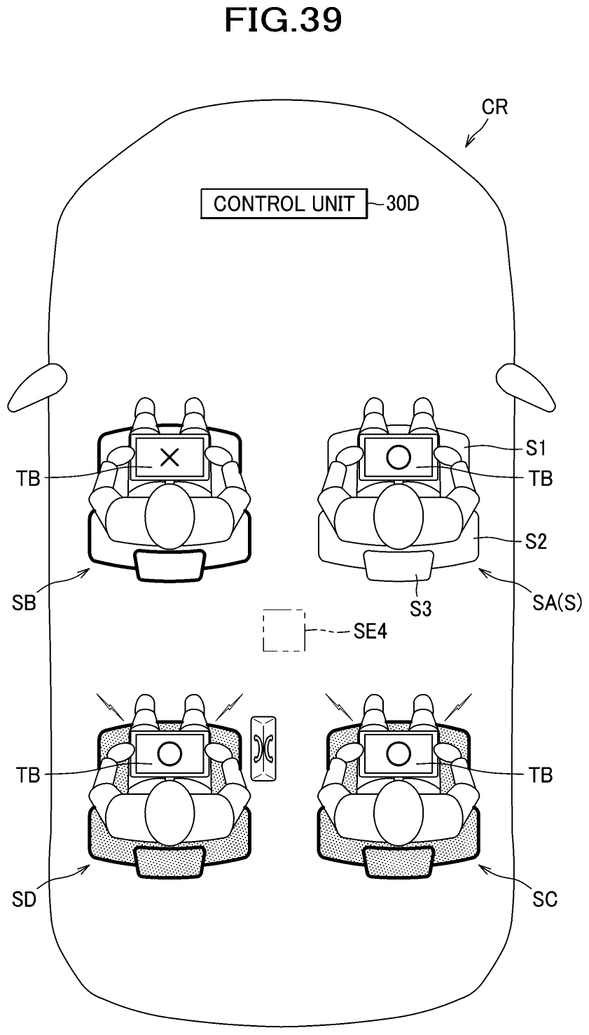

FIG. 39 is an illustration showing the state in which the seat orientation change process has not been executed due to presence of an obstacle;

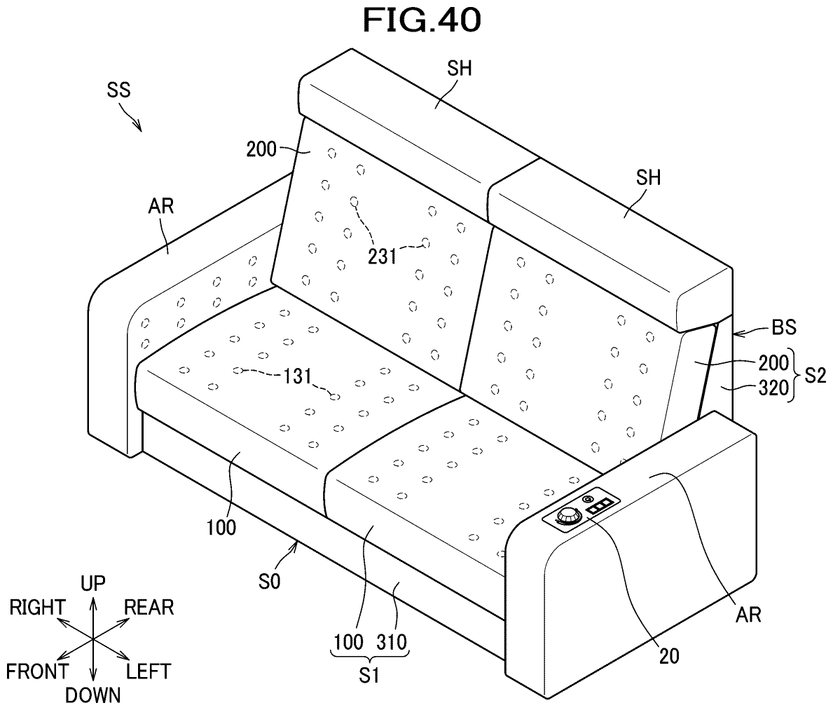

FIG. 40 is a perspective view of a sofa as an example of a seat according to a ninth example;

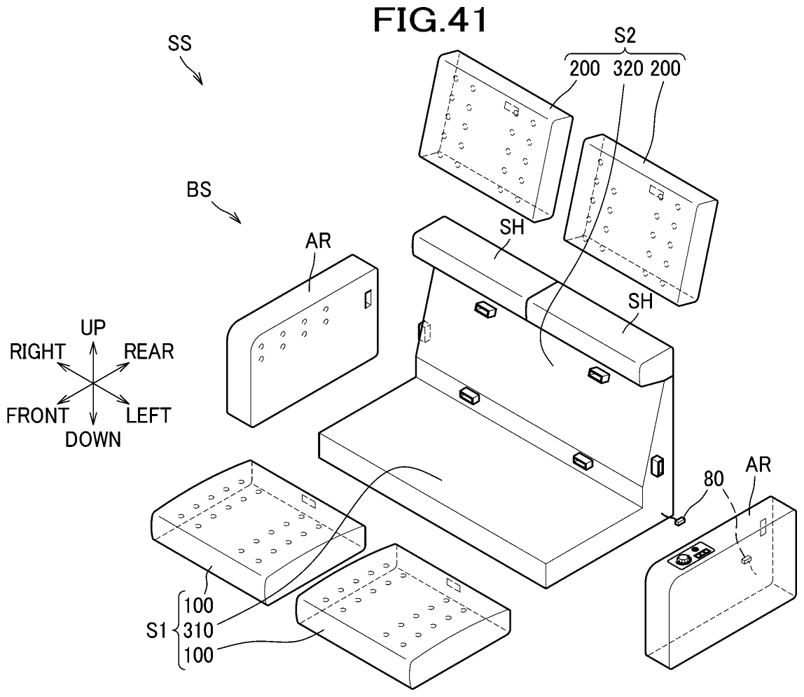

FIG. 41 is an exploded perspective view of the sofa;

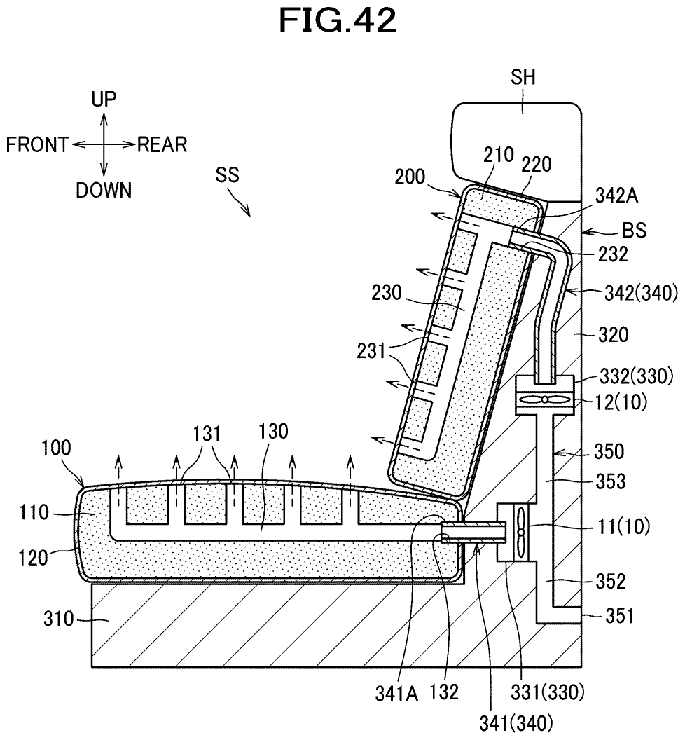

FIG. 42 is a cross-sectional view showing cushion airflow passages and structures related to the cushion airflow passages;

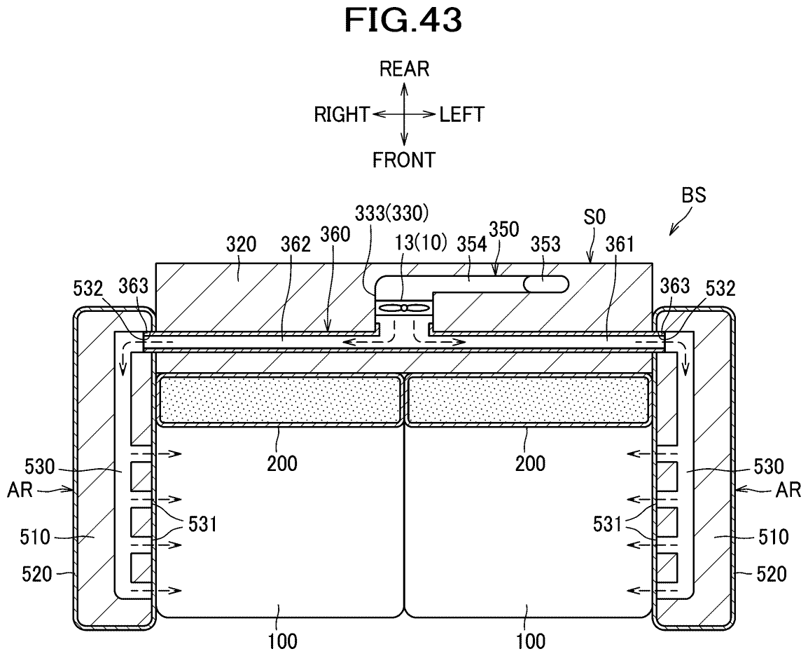

FIG. 43 is a cross-sectional view showing side airflow passages and structures related to the side airflow passages;

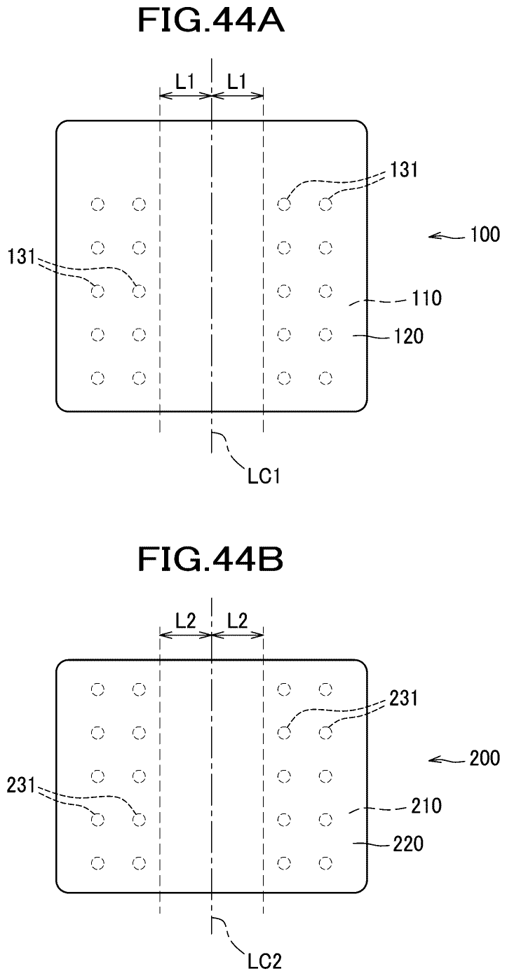

FIG. 44A is a front view of a seat bottom cushion;

FIG. 44B is a front view of a seat back cushion;

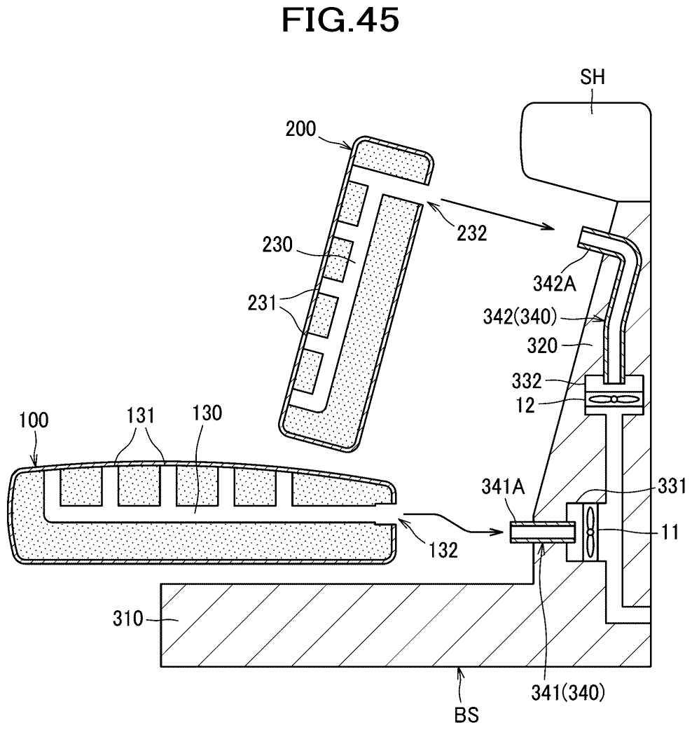

FIG. 45 is a cross-sectional view for describing the connection between the cushion airflow passages and the first-base-section airflow passages according to the ninth example;

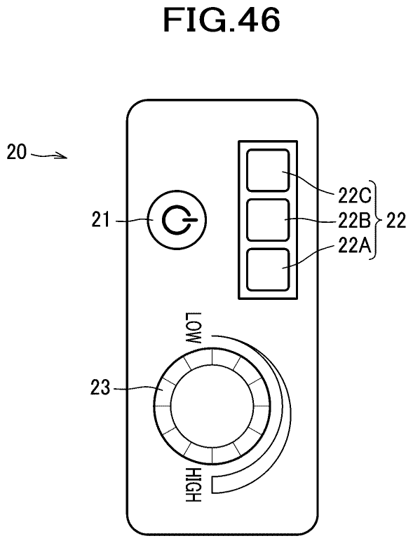

FIG. 46 is an illustration showing a user-operable control according to the ninth example;

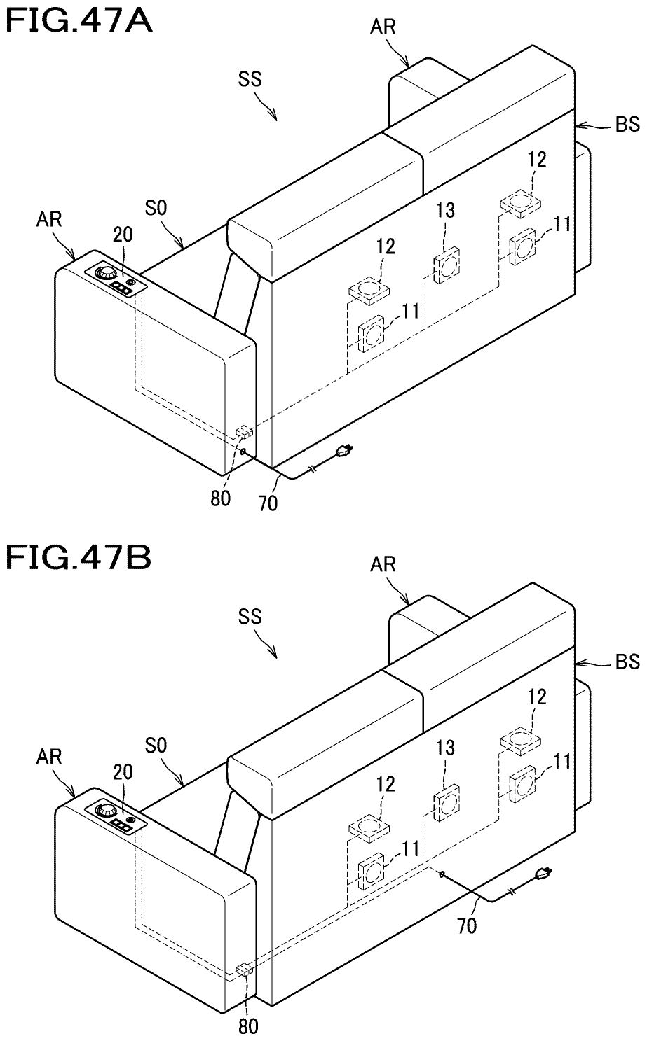

FIG. 47A is a perspective view showing a structure in which an electric wire is drawn out from an armrest;

FIG. 47B is a perspective view showing a structure in which the electric wire is drawn out from a laterally central portion of the base section;

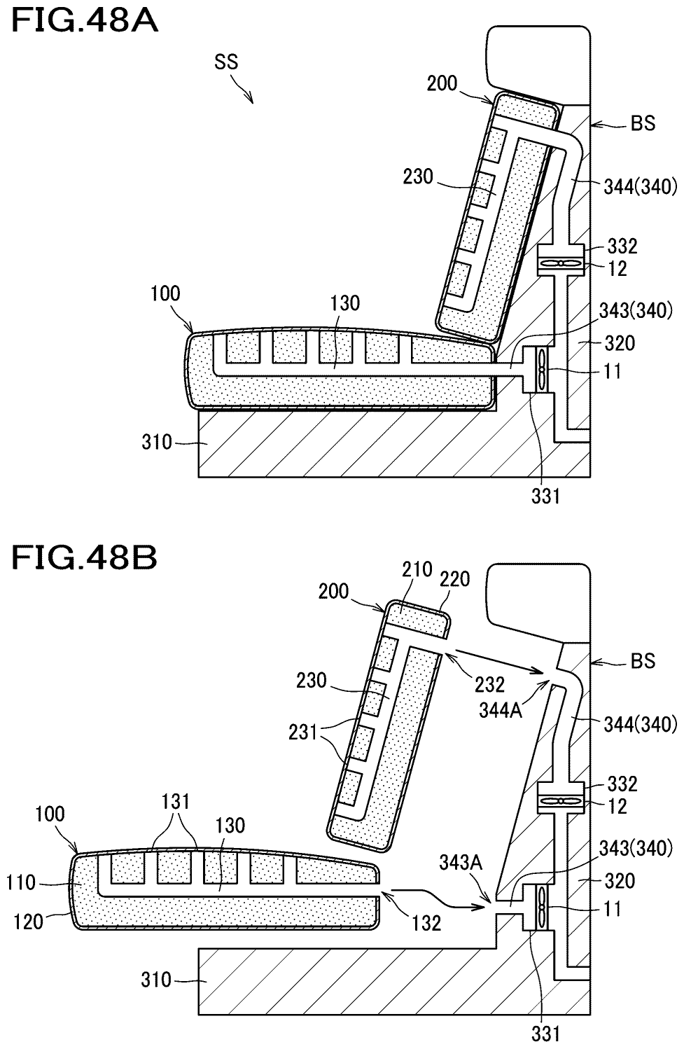

FIGS. 48A and 48B are cross-sectional views for describing the connection between the cushion airflow passages and the first-base-section airflow passages according to a tenth example;

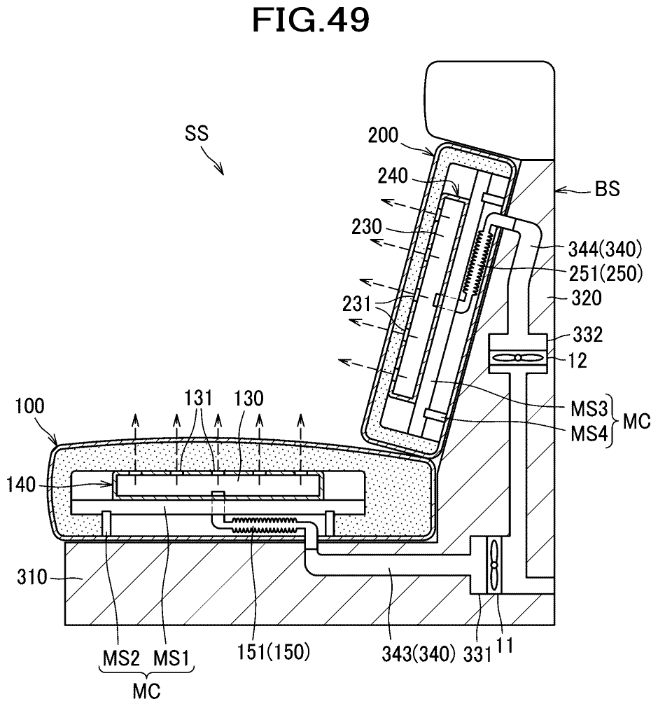

FIG. 49 is a cross-sectional view showing a sofa of an eleventh example;

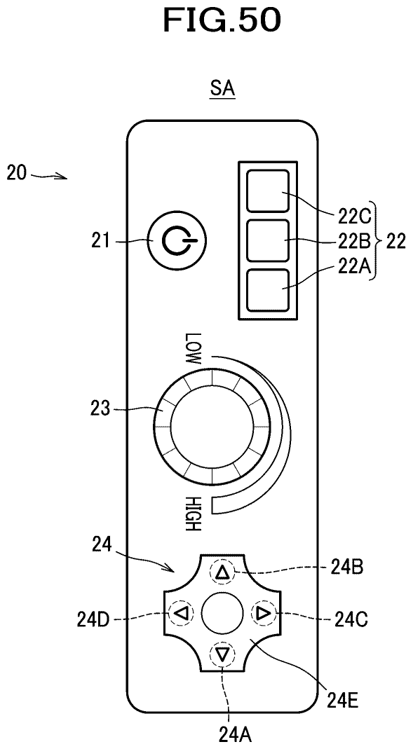

FIG. 50 is an illustration showing the user-operable control according to the eleventh example;

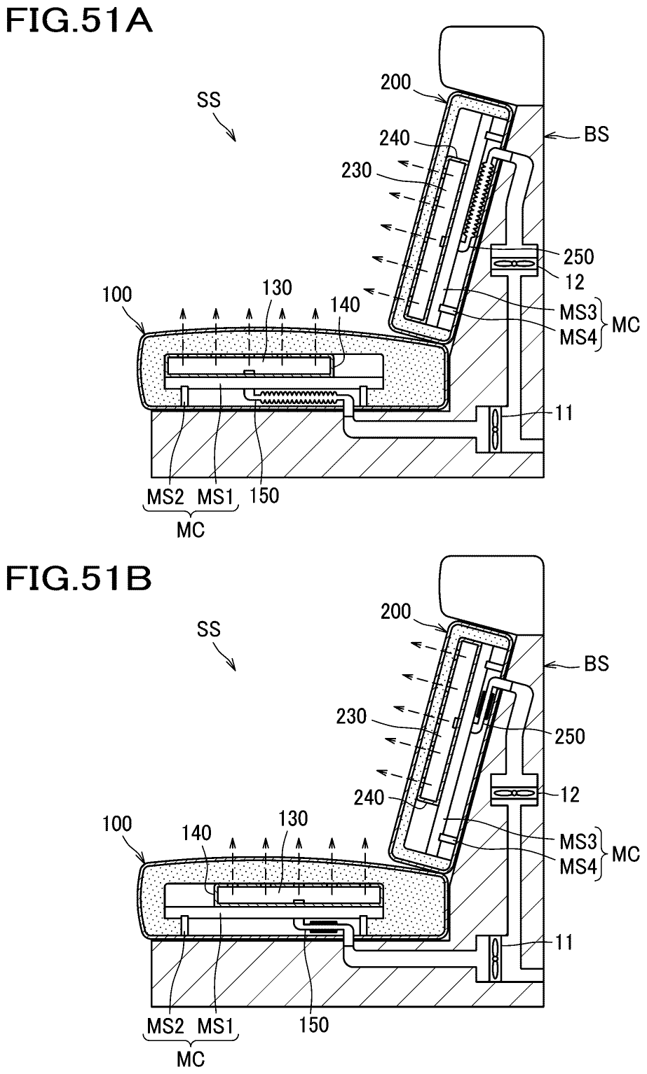

FIGS. 51A and 51B are cross-sectional views showing the actions of an adjustment mechanism according to the eleventh example;

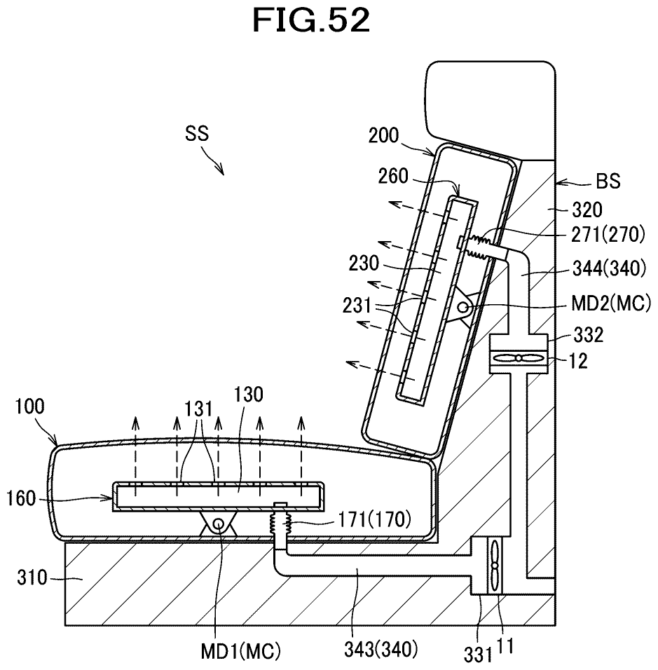

FIG. 52 is a cross-sectional view of a sofa according to a twelfth example;

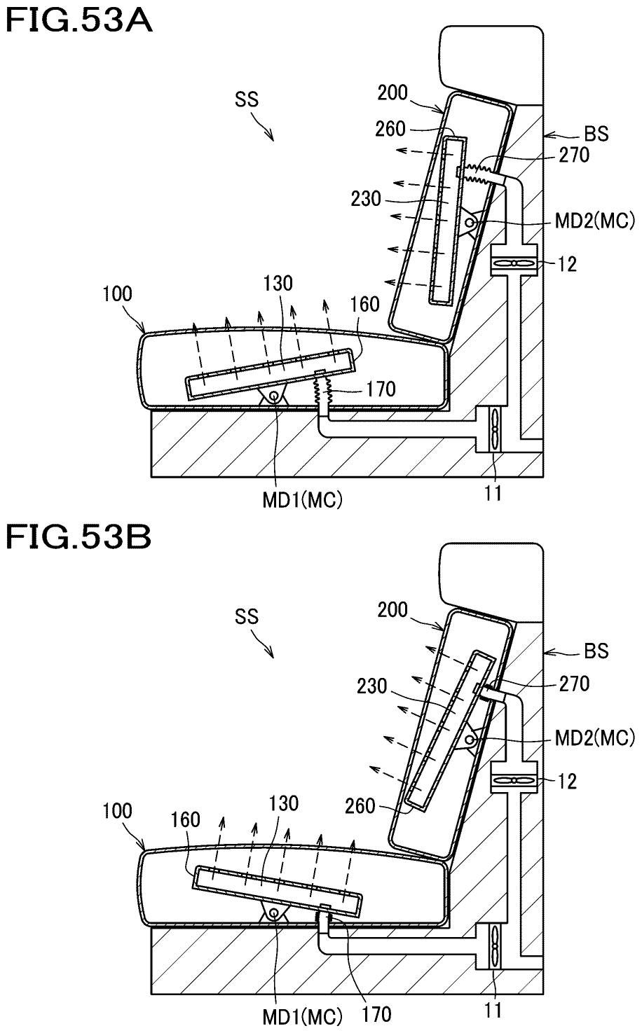

FIGS. 53A and 53B are cross-sectional views showing the actions of an adjustment mechanism according to the twelfth example;

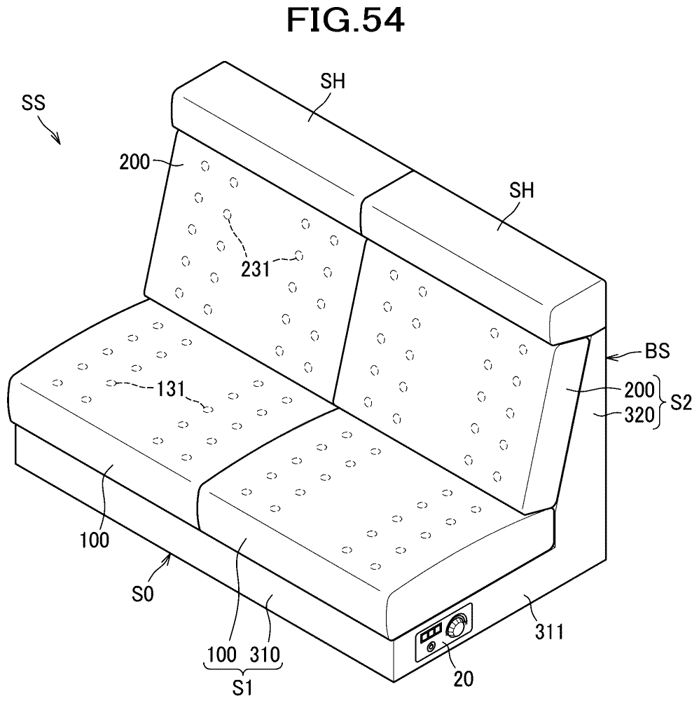

FIG. 54 is a perspective view of a sofa according to a first modified example;

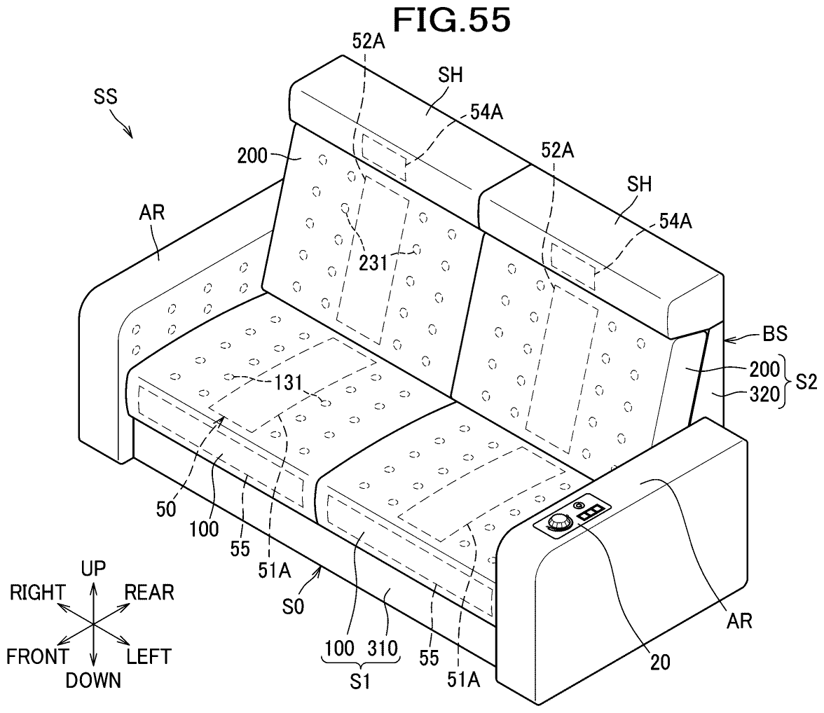

FIG. 55 is a perspective view of a sofa according to a second modified example;

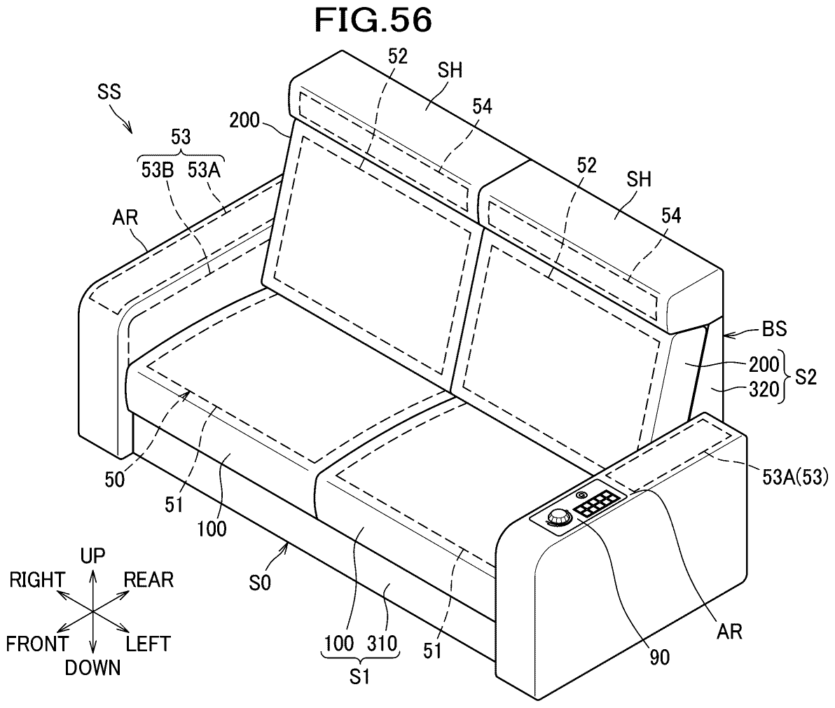

FIG. 56 is a perspective view of a sofa as an example of a seat according to a thirteenth example;

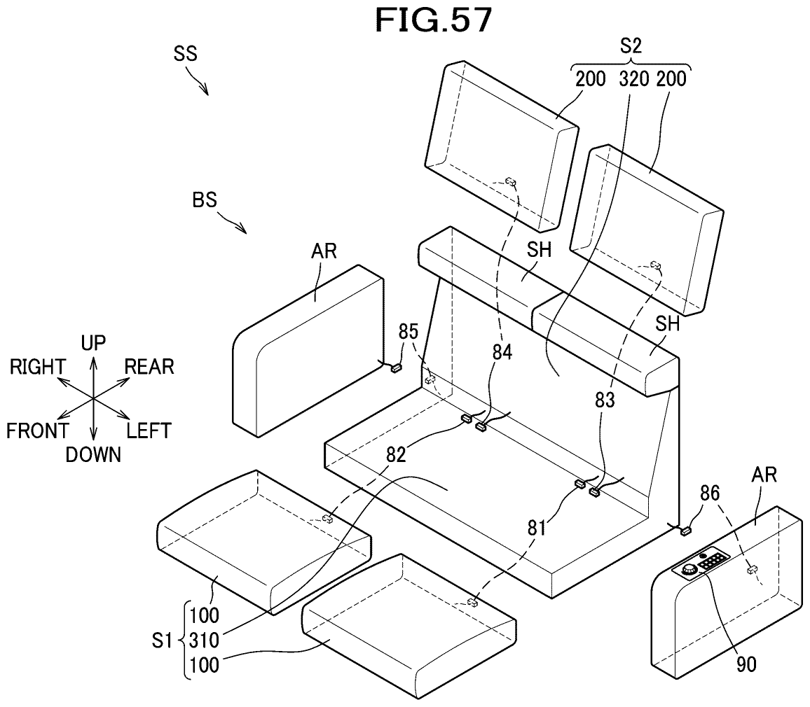

FIG. 57 is an exploded perspective view of the sofa;

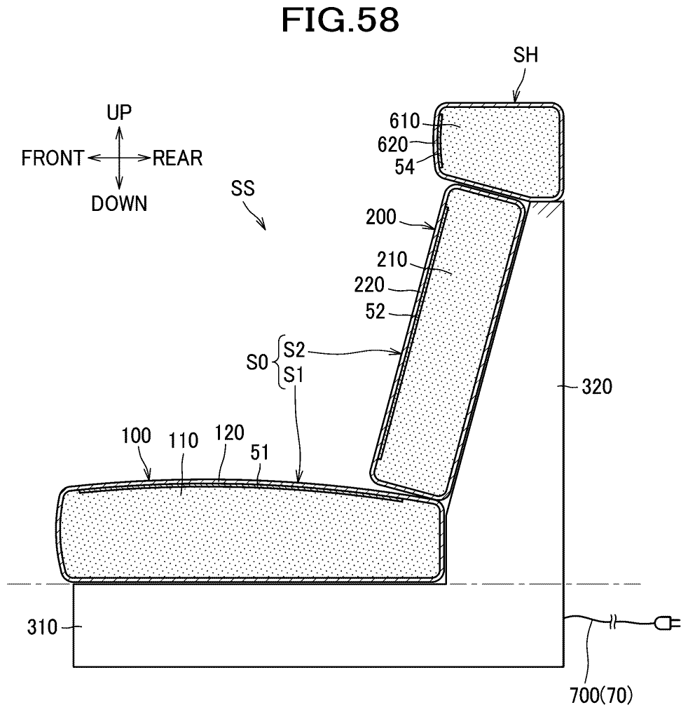

FIG. 58 is a cross-sectional view of the sofa;

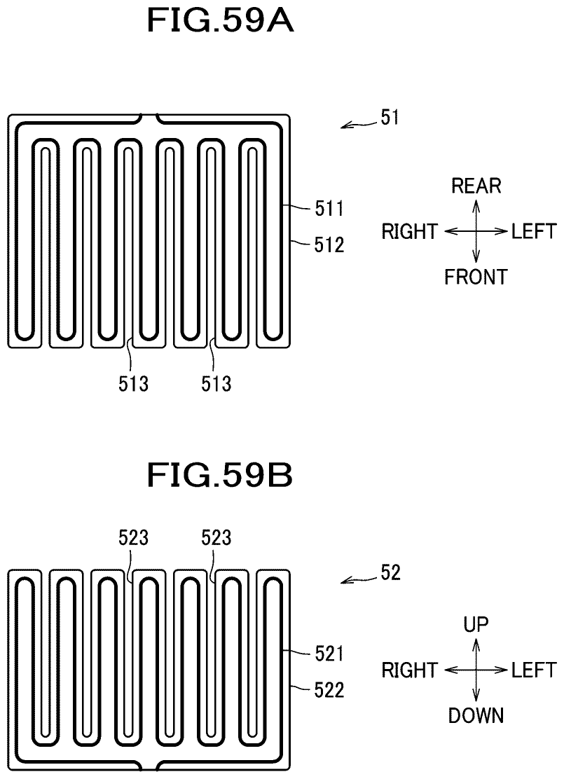

FIG. 59A is a front view of a seat bottom heater;

FIG. 59B is a front view of a seat back heater;

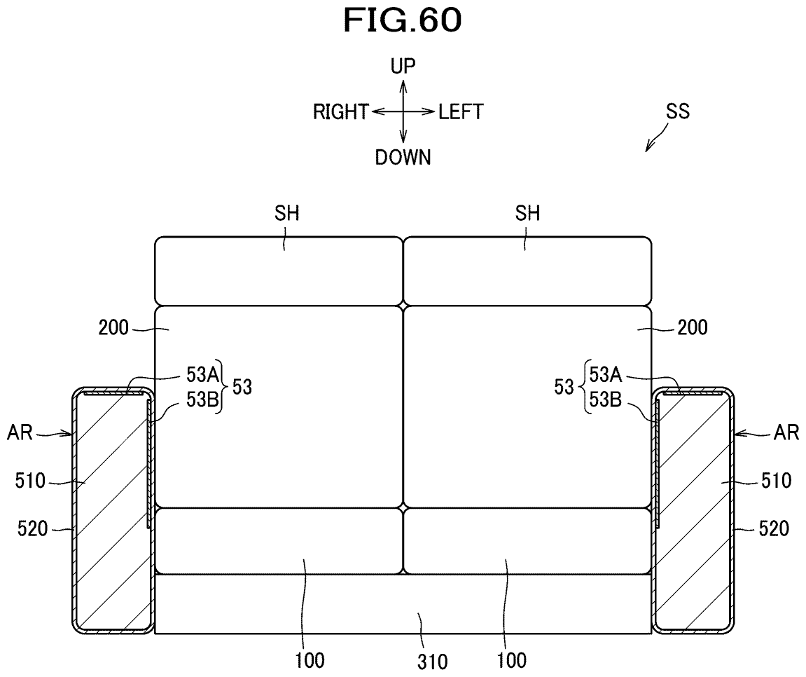

FIG. 60 is a view of the sofa from the front showing cross-sections of armrests;

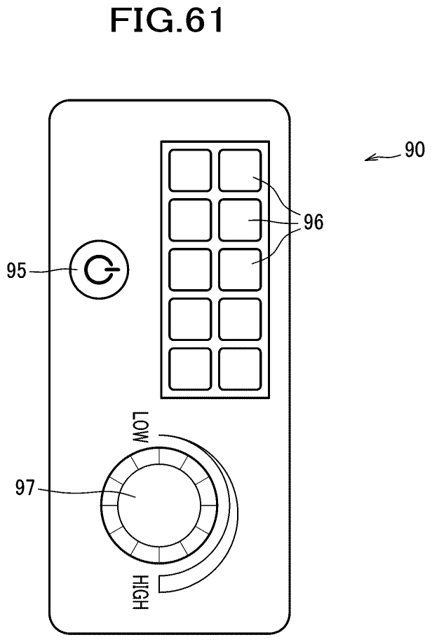

FIG. 61 is an illustration showing the user-operable control according to the thirteenth example;

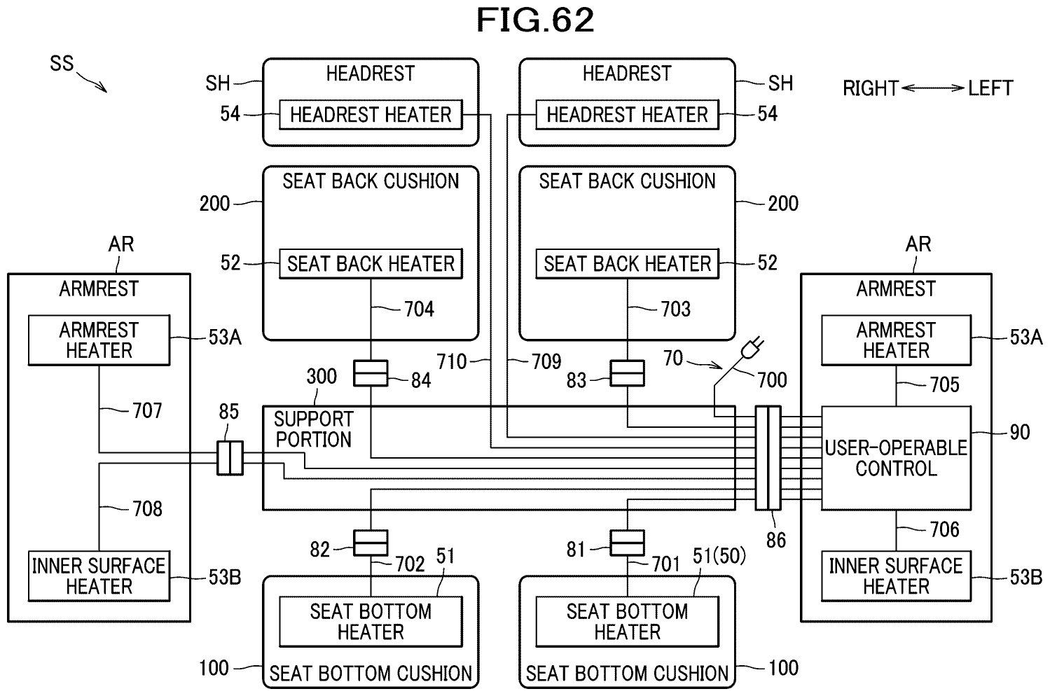

FIG. 62 is an illustration for describing the connections between the heaters and the user-operable control;

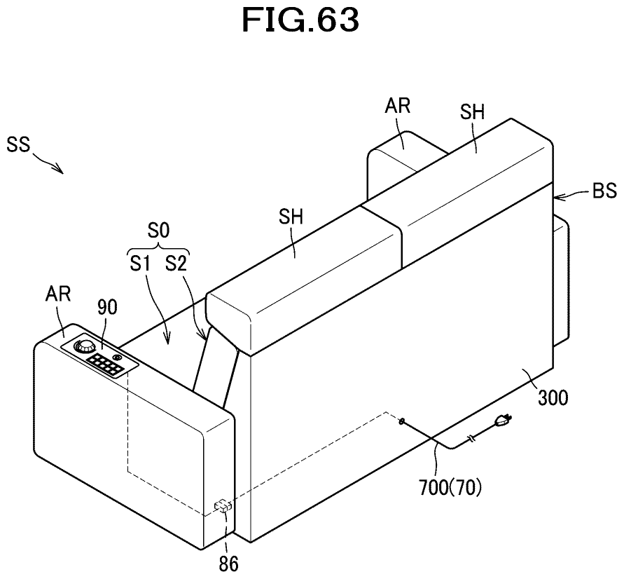

FIG. 63 is a perspective view of the sofa from behind; and

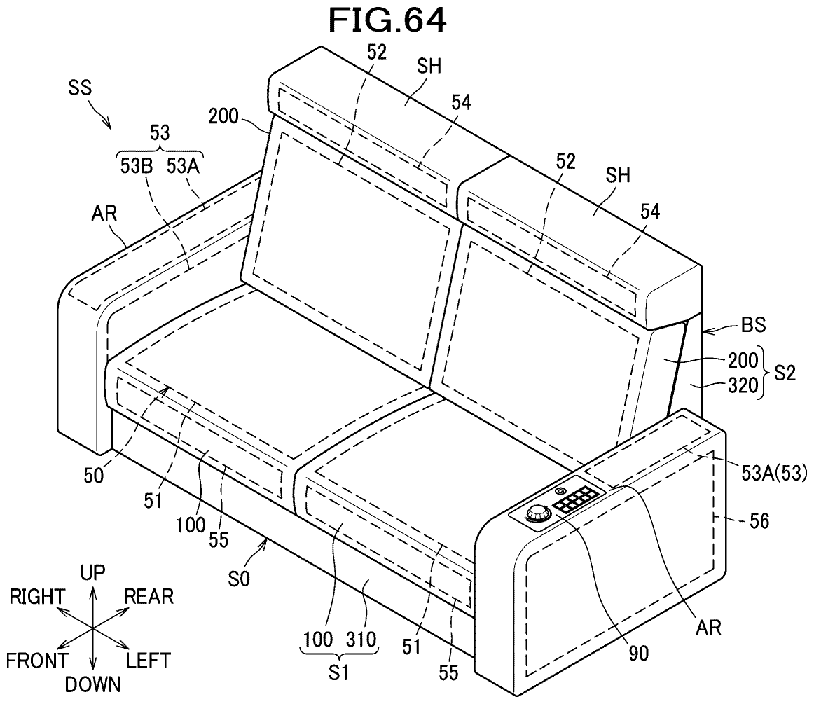

FIG. 64 is a perspective view of a sofa according to a modified example of the thirteenth example.

### FIRST EXAMPLE

A detailed description will be given of a first example of a seat with reference to FIGS. 1 to 5B where appropriate.

As shown in FIG. 1, the seat S of the first example is used as an in-seat experience device that is, for example, connected to a smartphone SP or other device and operates an application (app) of the smartphone SP in response to motions of an occupant on the seat S. The seat S may be installed in a car, or in facilities or places other than a car.

The seat S comprises a seat bottom S1, a seat back S2, and a headrest S3. More specifically, the seat S is comprised of a seat frame F such as shown in FIG. 2, and a pad body 14 and an outer covering 18 such as shown in FIGS. 4A and 4B. The seat frame F is upholstered with the pad body 14 and the outer covering 18 that covers the pad body 14.

As shown in FIG. 2, the seat frame F comprises a seat bottom frame F1 constituting a frame of the seat bottom S1, and a seat back frame F2 constituting a frame of the seat back S2. Although not shown in the drawings, a frame for the headrest S3 is detachably attached to the upper end of the seat back frame F2. The frame for the headrest S3 is also upholstered with a pad and an outer covering.

The seat bottom frame F1 and the seat back frame F2 each comprise left and right side frames SF and a supporting member 15. The side frames SF are spaced apart from each other in a lateral direction. The supporting member 15 is disposed between the left and right side frames SF and receives a load from an occupant seated on the seat S. The supporting member 15 supports, as shown in FIGS. 4A and 4B, a laterally central portion of the pad body 14.

As shown in FIG. 1, the seat bottom S1 has a front surface S11, a central surface S12, and protruding surfaces S13. The front surface S11 faces frontward. The central surface S12 is arranged in a laterally central position of an upper surface of the seat bottom S1 on which the occupant is to be seated. The protruding surfaces S13 are arranged on left and right sides of the central surface S12 and protrude upward with respect to the central surface S12. The seat back S2 has a central surface S22, and protruding surfaces S23. The central surface S22 is arranged in a laterally central position of the seat back S2 and supports the occupant from behind. The protruding surfaces S23 are arranged on left and right sides of the central surface S22 and protrude frontward with respect to the central surface S22. In this description, the descriptions front/rear (frontward/rearward), left/right (leftward/rightward; lateral), and up/down (upward/downward; vertical) are based on directions as viewed from an occupant seated on the seat S.

The seat S comprises a plurality of pressure sensors PS (PS1 to PS6) in the seat bottom S1 and the seat back S. The pressure sensors PS are arranged on an occupant-side of the pad body 14, specifically between the pad body 14 and the outer covering 18 (see FIG. 4B). The pressure sensors PS are elements that have electrical resistances which vary in response to external pressure. Each pressure sensor PS is arranged so as to detect a state of a seat surface that faces a user seated on the seat S, and acquires a value of pressure from the user seated on the seat S.

The respective pressure sensors PS1 to PS6 are provided in pairs, each arranged left and right, symmetric with respect to a laterally central position of the seat S. The pressure sensors PS1 to PS3 are arranged in the seat bottom S1.

The pressure sensors PS1 are arranged in a front portion of the seat bottom S1, frontward of a central position of the seat bottom S1 in the front-rear direction, and can measure values of pressure from the thighs of the occupant P.

The pressure sensors PS2 and PS3 are pressure sensors for measuring pressure from the buttocks of the user. Since the pressure sensors PS2 and PS3 are both intended for measuring pressure from the buttocks of the user, only one of the two may be provided. The pressure sensors PS2 and PS3 are arranged rearward of the central position of the seat bottom S1 in the front-rear direction

The pressure sensors PS2 and PS3 are arranged rearward of and distanced far from the pressure sensors PS1. Specifically, the pressure sensors PS3 are located in positions corresponding to the lowermost portions of ischial bones of the user. The load of the user is largest at these positions. The pressure sensors PS2 are arranged a little frontward of the pressure sensors PS3.

The pressure sensors PS4 to PS6 are arranged in the seat back S2. The pressure sensors PS4 are located in positions corresponding to the rear side of the lumbar region of the user. The pressure sensors PS5 are arranged a little above the pressure sensors PS4. Since the pressure sensors PS4 and PS5 are both intended for measuring pressure from the lumbar region of the user, only one of the two may be provided. The pressure sensors PS6 are arranged above and distanced far from the pressure sensors PS4 and PS5. The pressure sensors PS6 are located in positions corresponding to the shoulders of the user and can measure values of pressure from the shoulders of the user.

The seat S comprises a plurality of power generation devices G (31 to 34, 41 to 46) arranged in the seat bottom S1 and the seat back S2. Each power generation device G is disposed on the occupant-side of the pad body 14, specifically, between the pad body 14 and the outer covering 18 (see FIGS. 4A and 4B). The power generation devices G are devices that generate electric power from vibrations.

The power generation devices 31 are provided in a pair, laterally spaced apart and arranged on the front surface S11 of the seat bottom S1.

The power generation devices 32 are provided in a pair, laterally spaced apart and arranged on a front end of the central surface S12 of the seat bottom S1.

The power generation devices 33 are provided in a pair, laterally spaced apart and arranged on the central surface S12 of the seat bottom S1 in positions overlapping the pressure sensors PS2.

The power generation devices 34 are provided in a pair, laterally spaced apart and arranged on the left and right protruding surfaces S13 of the seat bottom S1. The power generation devices 34 are arranged in an approximately central position of the seat bottom S1 in the front-rear direction.

The power generation devices 41, 42, 43, 44 are arranged in a laterally central position of the central surface S22 of the seat back S2 in this order from the bottom of the seat back S2 upward. The power generation device 41 is arranged in a position corresponding to the height of the lumbar region of the occupant, below a vertically central position of the seat back S2. The power generation device 42 is arranged in a position corresponding to the center of the back of the occupant, in an approximately vertically central position of the seat back S2. The power generation devices 43, 44 are arranged in positions corresponding to the height of the shoulders of the occupant, above the vertically central position of the seat back S2.

The power generation devices 45 are provided in a pair, laterally spaced apart and arranged on the central surface S22 of the seat back S2. The power generation devices 45 are arranged in positions corresponding to the height of the center of the back of the occupant.

The power generation devices 46 are provided on the left and right protruding surfaces S23 of the seat back S2. The power generation devices 46 are arranged in an approximately vertically central position of the seat back S2.

As shown in FIG. 3, each power generation device G comprises a power generation element PE, a control unit 30, and a wiring W1 that connects the power generation element PE and the control unit 30. The control unit 30 is connected to the pressure sensor PS via a wiring W2 and thereby supplies electric power generated by the power generation device G to the pressure sensor PS, and detects pressure exerted on the pressure sensor PS. The power generation element PE is comprised of a piezoelectric element and other components. The power generation element PE is formed in a size and shape that allows the power generation element PE to efficiently generate electric power at frequencies of vibrations caused by motions of the occupant. The control unit 30 comprises a capacitor for storing electric power generated by the power generation element PE, a circuit for detecting resistance of the pressure sensor PS, and a communication device for transmitting detected pressures to an external device such as a smartphone SP by wireless communication. The power generation element PE also supplies electric power to the communication device.

As shown in FIG. 4A, the pad body 14 comprises a recess 14R on an occupant-side surface 14F thereof. The power generation device G is located in the recess 14R. An occupant-side surface GF of the power generation device G is flush with the occupant-side surface 14F of the pad body 14.

When the pressure sensor PS and the power generation device G are located in positions that overlap each other, such as the pressure sensor PS2 and the power generation device 33 shown in FIG. 1, the pressure sensor PS is disposed on the occupant-side of the power generation device G in a position that overlaps the power generation device G. In this case, the occupant-side surface PSF of the pressure sensor PS is flush with the occupant-side surface 14F of the pad body 14.

The smartphone SP receives the measured values of pressure from the control unit 30 of the power generation device G. The smartphone SP has an app installed therein that provides a game or the like using the values of pressure. Contents of such app is not limited and may be, for example, a competitive game that causes a character to run according to the number of times an occupant seated on the seat S moves his/her feet up and down.

According to the seat S configured as described above, since the power generation device G, which generates electric power from vibrations, is disposed on the occupant-side of the pad body 14, vibrations are efficiently transmitted to the power generation device G when the occupant moves. Thus, electric power can be efficiently generated by the motions of the occupant.

Further, since the power generation device G is located in the recess 14R formed in the pad body 14, the occupant is less likely to perceive the power generation device G as a foreign object, and the seat S can thereby be made more comfortable.

Since the pressure sensor PS is located in a position that overlaps the power generation device G, the pressure sensor PS and the power generation device G can be easily connected. Further, since the pressure sensor PS is disposed on the occupant-side of the power generation device G, the sensitivity of the pressure sensor PS is not impaired.

The seat S may, as shown in FIGS. 5A and 5B, further comprise a cover pad 16 to make the seat even more comfortable.

As shown in FIG. 5A, if the pressure sensor PS is not arranged to overlap the power generation device G, the cover pad 16 is arranged to overlap the occupant-side of the power generation device G. The recess 14R is formed with a depth equal to the combined thickness of the power generation device G and the cover pad 16. The occupant-side surface 16F of the cover pad 16 is flush with the occupant-side surface 14F of the pad body 14.

As shown in FIG. 5B, if the pressure sensor PS is arranged to overlap the power generation device G, the cover pad 16 is arranged to overlap the occupant-side of the pressure sensor PS. The recess 14R is formed with a depth equal to the combined thickness of the power generation device G, the pressure sensor PS, and the cover pad 16. The occupant-side surface 16F of the cover pad 16 is flush with the occupant-side surface 14F of the pad body 14.

According to the configurations shown in FIGS. 5A and 5B, since the cover pad 16 is located on the occupant-side of the power generation device G, the occupant is less likely to perceive the power generation device G as a foreign object, and the seat S can thereby be made even more comfortable.

### SECOND EXAMPLE

Next, a detailed description of an example of a seat cushion will be given. In this example, descriptions of the parts substantially the same as those of the first example will be omitted as appropriate.

As shown in FIG. 6, the seat cushion CS is placed and used on the seating surface of the seat S10. The seat S10 comprises a seat bottom S110 and a seat back S120. The seat cushion CS comprises a seat bottom cushion CS1 that is placed on a seating surface of the seat bottom S110, and a seat back cushion CS2 that is placed on a seating surface of the seat back S120. The seat bottom cushion CS1 and the seat back cushion CS2 are configured separately.

The seat bottom cushion CS1 and the seat back cushion CS2 comprise a plurality of pressure sensors PS and a plurality of power generation devices G, similar to the first example. Some of the power generation devices G are arranged in positions that overlap the pressure sensors PS, while other power generation devices G are arranged in positions that do not overlap the pressure sensors PS.

As shown in FIG. 7A, the seat cushion CS (CS1, CS2) comprises a pad body 114 and an outer covering 118 that covers the pad body 114. Each power generation device G is arranged on the occupant-side of the pad body 114, specifically, between the pad body 114 and the outer covering 118.

The pad body 114 has a recess 114R on an occupant-side 114F thereof. The power generation device G is located in the recess 114R. An occupant-side surface GF of the power generation device G is flush with the occupant-side surface 114F of the pad body 114.

When the pressure sensor PS and the power generation device G are located in positions that overlap each other, the pressure sensor PS is disposed on the occupant-side of the power generation device G and overlaps the power generation device G, as shown in FIG. 7B. In this case, the occupant-side surface PSF of the pressure sensor PS is flush with the occupant-side surface 114F of the pad body 114.

According to the seat cushion CS configured as described above, since the power generation device G, which generates electric power from vibrations, is arranged on the occupant-side of the pad body 114, vibrations are efficiently transmitted to the power generation device G when the occupant moves. Thus, electric power can be efficiently generated by the motions of the occupant.

Since the power generation device G is located in the recess 114R of the pad body 114, the occupant is less likely to perceive the power generation device G as a foreign object, and the seat S can thereby be made more comfortable.

Since the pressure sensor PS is located in a position that overlaps the power generation device G, the pressure sensor PS and the power generation device G can be easily connected. Since the pressure sensor PS is located on the occupant-side of the power generation device G, the sensitivity of the pressure sensor PS is not impaired.

Since the power generation device G supplies power to the communication device, the detected pressure can be transmitted from the seat cushion CS including the pressure sensors PS to the smartphone SP without the need for a power source, and the seat experience system using the seat cushion CS can thereby be used in places where no power supply is available.

The seat S may further comprise a cover pad 116, as shown in FIGS. 7C and 7D, to make the seat S even more comfortable.

As shown in FIG. 7C, when the pressure sensor PS is not arranged to overlap the power generation device G, the cover pad 116 is arranged to overlap the occupant-side of the power generation device G. The recess 114R is formed with a depth equal to the combined thickness of the power generation device G and the cover pad 116. The occupant-side surface 116F of the cover pad 116 is flush with the occupant-side surface 114F of the pad body 114.

As shown in FIG. 7D, when the pressure sensor PS is arranged to overlap the power generation device G, the cover pad 116 is arranged to overlap the occupant-side of the pressure sensor PS. The recess 114R is formed with a depth that is equal to the combined thickness of the power generation device G, the pressure sensor PS, and the cover pad 116. The occupant-side surface 116F of the cover pad 116 is flush with the occupant-side surface 114F of the pad body 114.

According to the configurations shown in FIGS. 7C and 7D, since the cover pad 116 is positioned on the occupant-side of the power generation device G, the occupant is less likely to perceive the power generation device G as a foreign object, and the seat S can thereby be made more comfortable.

Although the seat according to the first example and the seat cushion according to the second example have been described above, the above-described examples may be modified as appropriate.

For example, in the above-described first and second examples, the power generation device G was located in the recess 14R, 114R of the pad body 14, 114. However, the pad body 14, 114 may not be provided with the recess 14R, 114R, and the power generation device G may be arranged on the occupant-side surface 14F, 114F of the pad body 14, 114.

Although the power generation device G was provided in both of the seat bottom S1 and the seat back S2 in the seat S described above, the power generation device G may be provided only in the seat bottom S1 or only in the seat back S2. Although the headrest S3 was not provided with a power generation device G, a power generation device G may be provided in the headrest S3. The power generation device G may be provided in at least one of the seat bottom S1, the seat back S2, and the headrest S3.

Similarly, in the seat cushion CS described above, the seat bottom cushion CS1 and the seat back cushion CS2 are both provided with a power generation device G. However, the power generation device may be provided only in the seat bottom cushion CS1 or only in the seat back cushion CS2.

The seat S and seat cushion CS described above respectively comprise outer coverings 18, 118, but they may not comprise outer coverings.

Although the seat bottom cushion CS1 and the seat back cushion CS2 are configured separately in the seat cushion CS described above, the seat bottom cushion CS1 and the seat back cushion CS2 may be connected.

When the power generation device G and the pressure sensor PS are located in positions that overlap each other, another member may be placed between the power generation device G and the pressure sensor PS.

Although the power generation device G supplies power to the pressure sensor PS in the above-described example, the power generation device G may also supply power to objects other than the pressure sensor. The power generation device may, for example, supply power to a heater, a lighting fixture, a blower, a motor, etc.

The elements described in the first and second examples and modifications thereof may be implemented in combination as desired.

Third and fourth examples of a seat will be described, which seat comprises a seat bottom, a seat back, a headrest, and a removable cartridge.

A seat comprising a seat body and a scenting device is conventionally known (Patent Publication No. 2020-195429). The seat body comprises a seat bottom, a seat back, and a headrest. The scenting device is installable in and removable from the headrest of the seat body. In this art, the scenting device, which is provided as a removable cartridge, is attached to the headrest to blow out air containing a fragrance from an air outlet of the headrest.

It is desirable that a cartridge installable in and removable from the seat body, such as the cartridge of the conventional scenting device, can be easily replaced. Therefore, a seat is proposed in which a cartridge is easily replaceable, i.e. easily installable in or removable from the seat body. The seats according to the third and fourth examples, are also capable of switching the cartridge to be used, closing the opening of the cartridge installation section, preventing forgetting to close the cover, restraining detachment of the installed cartridge, and switching whether or not to use the function of the cartridge.

### THIRD EXAMPLE

Next, specific aspects of a third example will be described, referring mainly to FIGS. 8 to 17. In the following description, the descriptions front/rear (frontward/rearward), left/right (leftward/rightward; lateral), and up/down (upward/downward; vertical) are based on directions as viewed from a person (occupant) seated on a seat.

As shown in FIG. 8, a seat according to the third example is configured as a vehicle seat installed in a vehicle, specifically, a car seat SV installed in an automobile.

The car seat SV comprises a seat body S0 on which a person is to be seated and a cartridge C that is installable into and removable from the seat body S0. The seat body S0 comprises a seat bottom S1, a seat back S2, and a headrest S30. Similar to the first example, the seat bottom S1, the seat back S2, and the headrest S30 may each comprise a frame (seat frame) that constitutes a framework, a pad body that covers the frame, and an outer covering that covers the pad body. The cartridge C can be installed in and removed from the headrest S30 of the seat body S0.

The headrest S30 comprises an air outlet A1 and an air inlet A2. The air outlet A1 is an opening for blowing air out from the headrest S30, and the air inlet A2 is an opening for drawing air into the headrest S30.

The air outlet A1 and the air inlet A2 are positioned on lateral sides of the head of an occupant so as to sandwich the head of the occupant when viewed from the front side. Specifically, the air outlet A1 is located on one side, i.e., the left side or the right side of the occupant's head, and the air inlet A2 is located on the other side of the occupant's head. In more detail, the air outlet A1 is located on the left side of the occupant's head, and the air inlet A2 is located on the right side of the occupant's head.

When another car seat (not shown) is provided on the left or right side of the car seat SV, the air outlet A1 is preferably, but not necessarily, positioned on the side on which the other vehicle seat is positioned in the left-right direction, and the air inlet A2 is preferably, but not necessarily, positioned on the side of the car seat SV opposite to the side on which the other vehicle seat is positioned in the left-right direction. In more detail, if the other vehicle seat is located on the left side of the car seat SV, the air outlet A1 is preferably, but not necessarily, positioned on the left side and the air inlet A2 is preferably, but not necessarily, positioned on the right side. If the other car seat is located on the right side of the car seat SV, the air outlet A1 is preferably, but not necessarily, positioned on the right side and the air inlet A2 is preferably, but not necessarily, positioned on the left side.

As shown in FIG. 9, the headrest S30 comprises therein a cartridge housing 60, a first duct 61, a second duct 62, a fan 40, a control unit 65, a first cable 71 and a second cable 72.

As shown in FIG. 10, the cartridge housing 60 is a portion in which the cartridge C installed in the headrest S30 is housed. The cartridge housing 60 includes a cartridge installation section 400 in which the cartridge C is removably installed. The cartridge installation section 400 is provided on a rear side surface of the headrest S30 in an exposed condition. Details of the cartridge installation section 400 will be described later.

The first duct 61 is a duct that connects the air inlet A2 and the cartridge installation section 400. Air drawn in from the air inlet A2 (see the dashed arrows) passes through the first duct 61 and flows into the cartridge housing 60 and then into the cartridge installation section 400. The first duct 61 is connected to the cartridge housing 60. The first duct 61 includes a first tube portion 61A and a second tube portion 61B. The first tube portion 61A has one end connected to the cartridge housing 60. The second tube portion 61B extends from the other end of the first tube portion 61A to the air inlet A2 of the headrest S30.

The second duct 62 is a duct that connects the cartridge installation section 400 and the air outlet A1. Air in the cartridge installation section 400 passes through the cartridge housing 60 and the second duct 62, and is blown out from the air outlet A1. The second duct 62 is connected to the cartridge housing 60. The second duct 62 includes a third tube portion 62A and a fourth tube portion 62B. The third tube portion 62A has one end connected to the cartridge housing 60. The fourth tube portion 62B extends from the other end of the third tube portion 62A to the air outlet A1 of the headrest S30.

The fan 40 is a fan that forms an airflow in the headrest S30, which flows from the air inlet A2, through the cartridge installation section 400, to the air outlet A1. In other words, the fan 40 forms an airflow from the air outlet A1 to the air inlet A2 on the front side of the headrest S30. In this example, only one fan 40 is provided in the headrest S30. The fan 40 is located inside the first duct 61. Specifically, the fan 40 is located at a laterally outer end of the first duct 61A, near the connection between the first duct 61A and the second duct 61B. The fan 40 is opposed to the air inlet A2.

The control unit 65 is a unit for controlling the fan 40 and the cartridge C. As shown in FIG. 9, in this example, the control unit 65 is located under the cartridge housing 60.

The first cable 71 is a cable that connects the fan 40 and the control unit 65. The first cable has one end connected to the fan 40 and another end connected to the control unit 65. The first cable 71 is located along the first tube portion 61A of the first duct 61 and the cartridge housing 60.

The second cable 72 is a cable that connects the control unit 65 to a device located outside the headrest S30. The second cable 72 is, for example, a cable for supplying power to the control unit 65, and includes a cable connecting the control unit 65 to a battery installed in a car body (not shown). The second cable 72 extends through the inside of a headrest pillar S31 to the outside of the headrest S30.

As shown in FIG. 10, the headrest S30 comprises a plurality of cartridge installation sections 400. Specifically, the headrest S30 comprises three cartridge installation sections 400. One cartridge C is removably installed in one cartridge installation section 400.

The three cartridge installation sections 400 are arranged side-by-side. The three cartridge installation sections 400 include a first cartridge installation section 400A, a second cartridge installation section 400B, and a third cartridge installation section 400C. In this example, the first cartridge installation section 400A is the rightmost cartridge installation section 400, and the third cartridge installation section 400C is the leftmost cartridge installation section 400. The second cartridge installation section 400B is the cartridge installation section 400 located between the first and third cartridge installation sections 400A, 400C.

The cartridge installation section 400 (400A, 400B, 400C) is located in a portion of the headrest S30 behind the head of the occupant. Specifically, the cartridge installation section 400 is located in a portion of the headrest S30 that supports the head of the occupant from behind. In more detail, the cartridge installation section 400 is located in a laterally central position of the headrest S30. The cartridge installation section 400 is located at the rear of the laterally central position of the headrest S30.

As shown in FIG. 11, each cartridge installation section 400 comprises an installation opening 410, a cover 420, and a pair of left and right claws 430.

The installation opening 410 is an opening for installing the cartridge C in the cartridge installation section 400. The installation opening 410 opens toward the rear. This allows the cartridge C to be at least partially installed into the installation opening 410 of the cartridge installation section 400 from behind.

The cover 420 is a cover for opening and closing the installation opening 410. The cover 420 can move between an open position shown in FIG. 12C in which the installation opening 410 is opened, and a closed position shown in FIG. 12B in which the installation opening 410 is closed. In more detail, the cover 420 can be slid up and down between the open and closed positions. The cover 420 comprises a cover body 421 that opens and closes the installation opening 410 and a knob 422 that is held when the cover 420 is slid up and down. The knob 422 extends rearward from a laterally central position of a lower end of a rear side surface of the cover body 421 (see also FIG. 11).

FIG. 12D shows a cross section taken along line X-X of FIG. 12A. As shown in FIG. 12D, the claws 430 are parts that hold the cartridge C when the cartridge C is installed in the cartridge installation section 400. The left and right claws 430 are laterally spaced apart with a predetermined spacing therebetween. The left and right claws 430 are provided above the installation opening 410. The left and right claws 430 each have an arm portion 431 extending rearward and an engagement portion 432 protruding laterally inward from a rear end of the arm portion 431. The left and right claws 430 are configured to allow the arm portions 431 to elastically flex laterally outward when the cartridge C is installed or removed.

When the cartridge C is to be installed in the cartridge installation section 400, the knob 422 is held to slide the cover 420 in the closed position shown in FIG. 12B to the open position shown in FIG. 12C. Then, with the cover 420 held in the open position, the cartridge C is installed into the installation opening 410 from behind. As shown in FIGS. 12A and 12D, the cartridge C can be installed in the cartridge installation section 400 by installing the cartridge C in a position in which it is held by the claws 430.

As shown in FIGS. 13A and 13B, the cartridge C comprises a cartridge body 470, a first extending portion 481, and a second extending portion 482.

The cartridge body 470 is approximately box-shaped. The cartridge body 470 comprises ventilation portions 484 on the left and right sides 471, 472, respectively. The ventilation portions 484 are air permeable portions that connect the interior and the exterior of the cartridge C, more particularly, the interior and the exterior of the cartridge body 470. In one example, the ventilation portions 484 have a structure including an aperture 473 formed on each lateral side 471, 472 of the cartridge body 470 and covered with an air permeable mesh 485.

The specific configuration of the ventilation portions 484 is not limited to the above. For example, the ventilation portions 484 may be formed by the openings 473 not covered with mesh 485. The number of openings on each side 471, 472 is not limited to one, but may be more than one. For example, left and right walls of the cartridge body 470 may be formed in a mesh or grid pattern to form a plurality of openings (through holes) that connect the interior of the cartridge body 470 with the exterior of the cartridge body 470. The plurality of openings may be covered with a mesh. The ventilation portions 484 may be formed not only on the lateral sides 471, 472 of the cartridge body 470, but also, for example, on an upper side of the cartridge body 470.

Since the cartridge C comprises the ventilation portions 484, an airflow is allowed to pass through the cartridge installation section 400 with the cartridge C installed therein (see FIG. 10).

The first extending portion 481 is a portion extending upward from a rear end of an upper surface of the cartridge body 470. The first extending portion 481 has a hole 483 into which the knob 422 of the cover 420 enters when the cartridge C is installed in the cartridge installation section 400 (see FIG. 11). When the cartridge C is installed in the cartridge installation section 400, the claws 430 of the cartridge installation section 400 hold the first extending portion 481 (see FIG. 12D).

The second extending portion 482 is a portion extending frontward from an upper end of a front surface of the first extending portion 481. As shown in FIG. 12A, when the cartridge C is installed in the cartridge installation section 400, a rear wall of the cartridge installation section 400 is held between the second extending portion 482 and the cartridge body 470.

Next, some specific configurations (functions) of cartridge C will be described.

In a first configuration shown in FIG. 14A, the cartridge C comprises a fragrance emitter 810 in the cartridge body 470. The fragrance emitter 810 is a device for adding a fragrance to the air passing through the cartridge C. In one example, the fragrance emitter 810 includes scented beads 811 and a case 812 for housing the beads 811. The case 812 is air permeable. The specific structure of the fragrance emitter 810 is not limited to the above. For example, instead of the beads 811, the fragrance emitter 810 may include a sheet of paper or the like impregnated with a fragrance.

In a second configuration shown in FIG. 14B, the cartridge C comprises a temperature regulator 820 in the cartridge body 470. The temperature regulator 820 is a device that changes the temperature of the air passing through the cartridge C by cooling or heating the air. In one example, the temperature regulator 820 includes a Peltier element 821. The Peltier element 821 has a function of cooling or heating the air passing through the cartridge C.

The specific structure of the temperature regulator 820 is not limited to the above. The temperature regulator 820 may, for example, have a structure including elements that only have a function of cooling the air passing through the cartridge C, or a structure including elements that only have a function of heating the air passing through the cartridge C. Specifically, the temperature regulator 820 may, for example, comprise a heater instead of the Peltier element 821.

In a third configuration shown in FIG. 14C, the cartridge C comprises an ion generator 830 in the cartridge body 470. The ion generator 830 is a device for adding ions to the air passing through the cartridge C. In one example, the ion generator 830 includes a needle-shaped discharge electrode 831. The discharge electrode 831 generates ions in the air when a voltage is applied thereto.

In a fourth configuration shown in FIG. 14D, the cartridge C comprises an air purifier 840 in the cartridge body 470. The air purifier 840 is a device for purifying the air passing through the cartridge C. In one example, the air purifier 840 includes an ultraviolet (UV) lamp 841. The UV lamp 841 has a function of disinfecting the air passing through the cartridge C by ultraviolet light.

The specific structure of the air purifier 840 is not limited to the above. For example, the air purifier 840 may have a structure including a discharge electrode 831, as shown in FIG. 14C, to decompose odor components and bacteria in the air by ions generated by applying a voltage to the discharge electrode 831. The air purifier 840 may also have a structure including a filter or activated carbon that removes dust, odor components, bacteria, and other substances in the air passing through the cartridge C. The air purifier 840 may have a structure that includes two or more of the above-described ultraviolet lamp 841, discharge electrode 831, filter, activated carbon, etc.

As shown in FIG. 15A, each cartridge installation section 400 further comprises ventilation openings 440 respectively formed in the left and right side walls thereof, and a pair of left and right shutters 450 for opening and closing the ventilation openings 440.

The ventilation openings 440 are openings for exposing the ventilation portions 484 of the cartridge C installed in the cartridge installation section 400 to the outside of the cartridge installation section 400.

The shutters 450 open and close the ventilation openings 440 to open and close the ventilation portions 484 of the cartridge C installed in the cartridge installation section 400. The shutters 450 can be moved between fully-closed positions shown in FIG. 15A, which fully close the ventilation openings 440, and fully-open positions shown in FIG. 15B, which fully open the ventilation openings 440. Specifically, the shutters 450 can be slid up and down between the fully-closed and fully-open positions.

The headrest S30 comprises a shutter drive mechanism 460 for driving the shutters 450. As shown in FIG. 16A, the shutter drive mechanism 460 is provided for each of the cartridge installation sections 400 (400A, 400B, 400C (see FIG. 10)).

One example of the shutter drive mechanism 460 comprises a drive pulley 461, an idler pulley 462, an endless belt 463, a motor 464, and a reduction gear (not shown). The endless belt 463 is stretched between the drive pulley 461 and the idler pulley 462. The motor 464 drives the drive pulley 461 and can rotate in forward and reverse directions. The reduction gear reduces the driving force of the motor 464 and transmits the driving force to the drive pulley 461. The shutters 450 are attached to the belt 463.

As shown in FIG. 16A, when each shutter 450 is in the fully-closed position and the motor 464 is driven to rotate an output shaft (not shown) of the motor 464 in a first direction, the drive pulley 461 and the belt 463 rotate in a counterclockwise direction in the figure. This causes the shutter 450 to slide upward from the fully-closed position to open the ventilation opening 440. The shutter 450 can be stopped at any position between the fully-closed and fully-open positions by adjusting the amount of driving force of the motor 464. In other words, the degree of opening of the shutter 450 can be adjusted.

When each shutter 450 is open, including the fully-open position shown in FIG. 16B, and the motor 464 is driven to rotate the output shaft of the motor 464 in a second direction opposite to the first direction, the drive pulley 461 and belt 463 rotate in a clockwise direction in the figure. This causes the shutter 450 to slide down from the open position to close the ventilation opening 440. Again, the shutter 450 can be stopped at any position between the fully-open and fully-closed positions by controlling the amount of driving force of the motor 464.

As shown in FIG. 17, the control unit 65 has a function of controlling the fan 40, the cartridges C (C1, C2, C3) installed in the cartridge installation sections 400, and the motors 464 (464A, 464B, 464C) of the shutter drive mechanisms 460. In this example, the control unit 65 can also turn on and off, control the output of, or otherwise control the temperature regulator 820 (see FIG. 14B), the ion generator 830 (see FIG. 14C), and the air cleaner 840 (see FIG. 14D) for the cartridges C installed in the cartridge installation sections 400.

Herein, the first motor 464A is the motor 464 of the shutter drive mechanism 460 corresponding to the first cartridge installation section 400A, the second motor 464B is the motor 464 of the shutter drive mechanism 460 corresponding to the second cartridge installation section 400B, and the third motor 464C is the motor 464 of the shutter drive mechanism 460 corresponding to the third cartridge installation section 400C. The first cartridge C1 is the cartridge C installed in the first cartridge installation section 400A, the second cartridge C2 is the cartridge C installed in the second cartridge installation section 400B, and the third cartridge C3 is the cartridge C3 installed in the third cartridge installation section 400C.

An operation unit 91 and a communication unit 92 are connected to the control unit 65.

The operation unit 91 is a device that allows the occupant to turn the fan 40 on and off, adjust the quantity of air supplied by the fan 40, turn devices of the cartridges C on and off, adjust outputs of the devices of the cartridges C, open and close the shutters 450, and adjust the degree of opening of the shutters 450. The operation unit 91 comprises switches, buttons, touch panels, etc. for operating these devices. The operation unit 91 can be located, for example, on the left or right side of the headrest S30, on an instrument panel of the car, on a car door, etc.

The communication unit 92 is a device that enables near-field communication, such as Bluetooth (registered trademark) and Wi-Fi (registered trademark). Since the communication unit 92 is provided, the fan 40, the cartridges C, and the shutters 450 can be operated not only by the operation unit 91, but also by a smartphone SP or the like via application software installed therein.

The communication unit 92 can be disposed inside the headrest S30. For example, the communication unit 92 can be located under the cartridge housing 60, together with the control unit 65 (see FIG. 9). The communication unit 92 may also be disposed outside the headrest S30, for example in the car body, and connected to the control unit 65 by the second cable 72.

The control unit 65 may be configured not only to control the fan 40, the cartridges C and the shutters 450 in response to operation of the occupant, but also to automatically control the fan 40, the cartridges C and the shutters 450 in response to information, for example, input from devices located inside or outside the headrest S30.

For example, if the control unit 65 determines, based on road information input from a car navigation system installed in the car, that the road ahead has many curves likely to cause motion sickness, the control unit 65 controls the fan 40, the cartridge C, and the shutters 450 so that motion sickness is less likely to occur.

In one example, when a cartridge C including a mint fragrance emitter 810 that is said to be effective against motion sickness is installed, the control unit 65 opens the shutters 450 of the cartridge installation section 400 in which the cartridge C is installed and drives the fan 40. Thus, air containing the mint fragrance is blown out from the air outlet A1 of the headrest S30, thereby reducing the possibility of the occurrence of motion sickness.

In another example, when the cartridge C including the temperature regulator 820 is installed, the control unit 65 opens the shutters 450 of the cartridge installation section 400 in which the cartridge C is installed, drives the fan 40, and also drives the temperature regulator 820 to cool the air passing through the cartridge C. This allows cool air to be blown out from the air outlet A1 of the headrest S30, thereby reducing the possibility of the occurrence of motion sickness.

According to the third example described above, since the cartridge installation section 400 is disposed in the headrest S30 in a portion of the headrest S30 located behind the head of the occupant, the cartridge C can be easily replaced.

Since the cartridge C can be installed in the cartridge installation section 400 from behind, the cartridge C can be easily installed and removed. In particular, when a plurality of cartridge installation sections 400 is included as in this example, by arranging the cartridge installation sections 400 side-by-side, the cartridges C can be individually installed and removed without having to temporarily remove an adjacent cartridge C. This makes it easy to install and remove the cartridges C.

Since the headrest S30 comprises a plurality of cartridge installation sections 400, a plurality of cartridges C with different functions, types, etc. can be installed in the headrest S30. This makes it possible to switch the cartridge C to be used among the cartridges C provided in the cartridge installation sections 400 according to the situation, preferences, etc., without replacing the cartridge C.

Since the cartridge installation section 400 comprises a cover 420 that opens and closes the installation opening 410 of the cartridge installation section 400, the installation opening 410 can be closed by the cover 420 when the headrest S30 is used without installing the cartridge C. This can, for example, restrain dust and other particles from entering the cartridge installation section 400 through the installation opening 410.

Since the cartridge installation section 400 comprises claws 430, it is possible to keep the installed cartridge C from being detached from the cartridge installation section 400.

Since the airflow passing through the cartridge installation section 400 can be switched between a state in which the airflow passes through the ventilation portions 484 of the cartridge C and a state in which the airflow does not pass through the ventilation portions 484 of the cartridge C by opening and closing the shutters 450, the user can choose whether or not to use the function of the cartridge C. In a configuration comprising a plurality of cartridge installation sections 400 as in this example, the cartridge C to be used can be switched by switching the open/close state of the shutters 450 for each cartridge installation section 400.

Since the cartridge C includes the fragrance emitter 810, air containing the fragrance can be blown out from the air outlet A1 of the headrest S30 by installing the cartridge C in the cartridge installation section 400. Further, since the cartridge C comprising the fragrance emitter 810 is installable and removable, the type of fragrance can be changed according to circumstances and preferences.

Since the cartridge C includes the temperature regulator 820, the air with a regulated temperature such as warm or cold air can be blown out from the air outlet A1 of the headrest S30 by installing the cartridge C in the cartridge installation section 400.

Since the cartridge C includes the ion generator 830, air to which ions have been added can be blown out from the air outlet A1 of the headrest S30 by installing the cartridge C in the cartridge installation section 400.

Since the cartridge C includes the air purifier 840, purified air can be blown out from the air outlet A1 of the headrest S30 by installing the cartridge C in the cartridge installation section 400.

### FOURTH EXAMPLE

Next, a description of a fourth example will be given, referring mainly to FIGS. 18 and 19. Herein after, a detailed description will be given for points that differ from the third example described above, and descriptions will be omitted for points that are the same as those in the third example. The same reference characters will, for example, be affixed to components similar to those in the third example.

In this example, the cartridge housing 60 comprises, as shown in FIG. 18, three cartridge installation sections 400 arranged side-by-side. Each cartridge installation section 400 comprises an installation opening 910 and a cover 920.

The installation opening 910 is an opening for installing a cartridge C in the cartridge installation section 400. The installation opening 910 opens upward. As a result, in this example, the cartridge C can be installed into the installation opening 910 of the cartridge installation section 400 from above. In this example, an upper surface of the cartridge installation section 400 is exposed to the outside of the headrest S30.

As shown in FIG. 19, the cover 920 is a cover for opening and closing the installation opening 910. The cover 920 is movable between an open position shown in FIG. 19B, which opens the installation opening 910, and a closed position shown in FIG. 19A, which closes the installation opening 910. Specifically, the cover 920 is rotatable between the open and closed positions. In one example, the cover 920 has a front end and a rear end. The rear end of the cover 920 includes a shaft with a rotation axis 920A extending in a lateral direction. The front end of the cover 920 can be rotated up and down about the rotation axis 920A, between a closed position shown in FIG. 19A and an open position shown in FIG. 19B.

In this example, the headrest S30 comprises a torsion spring 930 as an example of a biasing member. The torsion spring 930 is a spring that biases the cover 920 toward the closed position shown in FIG. 19A. Specifically, the torsion spring 930 is arranged so that its coil portion is wrapped around the shaft of the cover 920, with one end contacting the cover 920 and the other end contacting the wall of the cartridge installation section 400.

As shown in FIG. 19A, the cartridge C is installed in the installation opening 910 from an upper side of the cartridge installation section 400. At this time, the cover 920 is pushed by the cartridge C and rotates from the closed position to the open position. When the cartridge C is installed in the cartridge installation section 400, as shown in FIG. 19B, the cover 920 is located in the open position.

When the cartridge C in the state shown in FIG. 19B is lifted up and removed from the cartridge installation section 400, the cover 920 is rotated from the open position to the closed position by the biasing force of the torsion spring 930. When the cartridge C is removed from the cartridge installation section 400, as shown in FIG. 19A, the cover 920 is positioned in the closed position.

The fourth example described above also provides the same advantageous effects as the third example.

Since the cartridge C can be installed into the cartridge installation section 400 from an upper side of the cartridge installation section 400, the cartridge C can be easily installed and removed. In particular, when a plurality of cartridge installation sections 400 is included, by arranging the cartridge installation sections 400 side-by-side, the cartridges C can be individually installed and removed without having to temporarily remove an adjacent cartridge C. This makes it easy to install and remove the cartridges C.

Since a torsion spring 930 that biases the cover 920, which opens and closes the installation opening 910 of the cartridge installation section 400, in the closed position is provided, the installation opening 910 can be automatically closed by the cover 920 when the cartridge C is removed. This configuration prevents the cover 920 from being left open. This configuration can more reliably restrain dust and other particles from entering the cartridge installation section 400 through the installation opening 910.

The third and fourth examples described above may be modified as appropriate as illustrated in the following examples.

For example, the specific functions of the cartridges described in the third and fourth examples are given as examples, and the cartridges may have functions other than those described in the third and fourth examples. For example, the cartridge C may include a deodorizer. The deodorizer is a device for removing odors from the air passing through the cartridge C and includes a deodorant filter or the like.

When the cartridge C including the deodorizer is installed, the control unit 65 measures the odor of the air in the vehicle by an odor sensor installed in the headrest S30 or in the car body. If the measured value of the odor sensor is above a predetermined value, the fan 40 is driven for a predetermined time to allow the air drawn in from the air inlet A2 to flow through the cartridge C and then blow out from air outlet A1, to thereby deodorize the interior of the car.

The deodorizer for deodorizing the interior of the car may, for example, be placed in the first duct 61 instead of the cartridge C. According to this configuration, since it is not necessary to install the cartridge C including the deodorizer in the cartridge installation section 400, the cartridge installation section 400 can be left open for a cartridge C with another function. For the same reason, the temperature regulator 820, the ion generator 830, the air purifier 840, etc. of the third and fourth examples may be placed in the first duct 61 or the second duct 62.

Although the third and fourth examples were configured such that a single cartridge has a single function, a single cartridge may have a plurality of functions. Specifically, the cartridge may be configured to include two or more devices having different functions, such devices including a fragrance emitter, a temperature regulator, an ion generator, an air purifier, and a deodorizer. For example, the cartridge may be configured to include an ion generator and an air purifier.

In the third and fourth examples, shutters 450 that slide up and down are given as an example of shutters that open and close the ventilation portions of the cartridge. However, as shown in FIGS. 20A to 20C, the shutters 950 may, for example, comprise a plurality of slats 951 and be configured to open and close the ventilation openings 440 (ventilation portions of cartridge C) by changing the direction of the slats 951, like a so-called louver. The cartridge installation section may also be configured without shutters.

Although the headrest S30 is configured with three cartridge installation sections 400 in the third and fourth examples, the headrest may, for example, be configured with two cartridge installation sections or with four or more cartridge installation sections. The headrest may also be configured with only one cartridge installation section 400.

Although a torsion spring 930 is given as an example of a biasing member that biases the cover 920 toward the closed position in the fourth example, the biasing member may, for example, be a compression coil spring, a tension coil spring, a leaf spring, or the like. The headrest may also be configured without a biasing member as in the third example.

Although a cover 420 that slides is illustrated in the third example, and a cover 920 that rotates is illustrated in the fourth example, the cover may be attachable to and removable from the cartridge installation section, such that the opening is closed when the cover is attached to the cartridge installation section and the opening is open when the cover is removed from the cartridge installation section. Further, the cover may be formed by a portion of the outer covering of the headrest that covers the headrest frame and cushioning material. The cartridge installation section may also be configured without a cover.

Although the cartridge C is configured to be installed in the cartridge installation section 400 from behind in the third example, and from above in the fourth example, the cartridge may, for example, be configured to be installed in the cartridge installation section from the left or right.

In the configuration in which the cartridge can be installed in the cartridge installation section from behind, the direction in which the cartridge is installed or removed may be parallel to the front-rear (horizontal) direction, or slightly inclined up, down, or to the left or right relative to the front-rear (horizontal) direction. In the configuration in which the cartridge is installed in the cartridge installation section from above, the direction in which the cartridge is installed or removed may be parallel to the up-down (vertical) direction, or slightly inclined to the front, rear, left or right relative to the up-down (vertical) direction. In a configuration in which the cartridge can be installed in the cartridge installation section from the left or right, the direction in which the cartridge is installed or removed may be parallel to the left-right (horizontal) direction, or slightly inclined up, down, or to the front or rear relative to the left-right (horizontal) direction.

The specific configuration of the claws holding the cartridge is not limited to the configuration of the above-described example. For example, although the claws 430 are located and exposed to the outside of the cartridge installation section 400, the claws may be located inside the cartridge installation section 400. Further, the cartridge installation section 400 may be configured without claws, as in the fourth example.

Although the fan 40 was located in the first duct 61 in the above-described example, the fan may, for example, be located in the second duct 62 or in the cartridge housing 60. Although the headrest S30 comprises only one fan 40 in the above-described example, the headrest may comprise a plurality of fans. The headrest may, for example, comprise two fans, with one fan located in the first duct and the other fan located in the second duct. Further, for example, a plurality of fans may be arranged in the first duct and/or a plurality of fans may be arranged in the second duct.

Although the cartridge installation section 400, the first duct 61, and the second duct 62 are provided separately in the above-described example, the cartridge installation section, the first duct and the second duct may, for example, be integrated into a single unit.

Although the cartridge installation section 400 is exposed to the outside in the above-described example, the cartridge installation section may, for example, be provided so that the cartridge installation section is normally covered with a portion of the outer covering of the headrest or the like and is exposed to the outside when a cartridge is to be installed.

In the third and fourth examples described above, the power generation device described in the first example may be provided in at least one of the seat bottom S1, the seat back S2 and the headrest S30. In this case, electric power can be supplied to the control unit 65, the fan 40, the motor 464, etc. via wires such as the first cable 71 and the second cable 72.

Although the seat bottom S1, the seat back S2 and the headrest S30 are provided separately in the above-described example, the seat may comprise a seat back and a headrest integrated into a single component. Alternatively, the seat may also comprise a seat bottom and a seat back integrated into a single component, or a seat bottom, a seat back, and a headrest integrated into a single component.

Although a car seat SV installed in an automobile is given as an example of a seat in the above-described example, the seat may be a vehicle seat installed in a vehicle other than an automobile, such as a railroad car, a ship, or an aircraft. The seat is not limited to a vehicle seat, but may also be a seat used, for example, in an amusement facility, a relaxation facility, or at home.

The elements described in the third and fourth examples and modifications thereof may be implemented selectively and in combination.

### FIFTH EXAMPLE

A detailed description will be given of a fifth example of a seat system comprising a control unit that causes a state of a seat to change.

A seat system conventionally known in the art is capable of recognizing the size of baggage carried by an occupant about to get in a car and executing a seat retraction process that folds a seat back to increase trunk space when the baggage is large (JP 2020-157943 A).

In this art, if an obstacle is on the seat to be folded when the seat retraction process is executed, rotation of the seat back may be restricted by the obstacle, which may exert an additional load on a motor that causes the seat back to rotate.

It would be desirable to provide a seat system that can restrain an obstacle from restricting movement of the seat caused by execution of the seat retraction process.

A detailed description will be given of the fifth example with reference to FIGS. 21 to 24. As shown in FIG. 21, a seat system SYS1 comprises a seat S, an obstacle detection sensor SE1, and a control unit 30A.

The seat S is installed in a car CR comprising a recognition unit 35 that recognizes the size of baggage carried by an occupant about to get in the car. The recognition unit 35 is a sensor that detects the baggage carried by the occupant outside the car CR and comprises a camera or the like. The recognition unit 35 determines whether an image obtained by shooting at least a predetermined area at the rear of the car CR is a baggage image of an occupant carrying baggage by analyzing the image. If the image is determined to be a baggage image, the recognition unit 35 identifies the maximum length of the baggage from the baggage image and outputs to the control unit 30A recognition information indicating that the baggage carried by the occupant is recognized, together with baggage information indicating the maximum length of the baggage.

The recognition unit 35 may perform detections at all times or when the occupant approaches the car CR. Determination of whether or not the occupant has approached the car CR may, for example, be based on radio waves of a key remote controller of the car CR, carried by the occupant.

The seat S is located in front of a trunk 36 located at the rear of the car CR. The seat S is located behind a front row seat FS, such as the driver's seat or the front passenger seat. The car CR is a five-door type car and has a total of four doors (not shown) located on the left and right sides of the car CR, and a back door 37 located behind the trunk 36.

The seat S comprises a seat bottom S1, a seat back S2, and a headrest S3. As in the first example, the seat bottom S1, the seat back S2, and the headrest S3 each have a frame (seat frame) constituting a framework, a pad (pad body) that covers the frame, and an outer covering (outer covering member) that covers the pad.

The seat back S2 is rotatably supported by the seat bottom S1. The seat S is movable in the front-rear direction by means of a slide rail (not shown). The seat S comprises a first drive source such as a motor (not shown) that causes the seat back S2 to rotate. The seat S or the car CR comprises a second drive source such as a motor (not shown) that causes the seat S to move in the front-rear direction. The first drive source and the second drive source are controlled by the control unit 30A.

The seat S is switchable between a normal state shown in FIG. 21 and a retracted state shown in FIG. 22. The normal state is a state in which the occupant can be seated, i.e., a state in which the seat back S2 stands upright relative to the seat bottom S1, and the seat S is located in a position other than the forwardmost position. The retracted state is a state in which storage space in a car cabin is larger than that in the normal state. In this example, the retracted state refers to the state in which the seat back S2 is folded so that it faces the seat bottom S1, and the seat S is located in the forwardmost position.

The obstacle detection sensor SE1 is a sensor that detects an obstacle in the trajectory of the seat S switching from the normal state to the retracted state. In this example, the obstacle detection sensor SE1 is placed between the outer covering and the pad of the seat bottom S1 and detects the presence or absence of objects on the seat surface of the seat bottom S1. In other words, the obstacle detection sensor SE1 can detect an obstacle in the rotational trajectory of the seat back S2 switching from the normal state to the retracted state.

The obstacle detection sensor SE1 is, for example, a pressure sensor. In this example, the obstacle detection sensor SE1 is also used as a sensor for a seat belt reminder that detects whether or not an occupant is seated on the seat.

The control unit 30A comprises a central processing unit (CPU), a read-only memory (ROM), a random-access memory (RAM), a rewritable nonvolatile memory, etc. (not shown) and executes processes based on programs stored in advance. The control unit 30A is capable of communicating with a smartphone SP as an example of a portable terminal that can be carried by an occupant.

The control unit 30A may be provided in the car CR or at the seat S. It is assumed that settings that enable communication between the control unit 30A and the smartphone SP are made in advance by the occupant.

The control unit 30A is capable of executing a seat retraction process to change the state of the seat S from the normal state to the retracted state. Specifically, the control unit 30A has a function of determining whether or not to execute the seat retraction process based on information from the recognition unit 35. In more detail, when the recognition information and the baggage information are received from the recognition unit 35, the control unit 30A determines whether or not the maximum length of the baggage is greater than a predetermined value. If it is determined that the maximum length of the baggage is greater than the predetermined value, the control unit 30A determines to execute the seat retraction process, and if it is determined that the maximum length of the baggage is equal to or less than the predetermined value, the control unit 30A does not execute the seat retraction process. Here, the predetermined value may be the length of the trunk when the seat S is in the normal state and the rearwardmost position, the width of the trunk, or the diagonal length of the cube-shaped trunk space.

If it is determined that the seat retraction process is to be executed, the control unit 30A has a function of determining whether or not an obstacle is in the trajectory of the seat S based on information from the obstacle detection sensor SE1 before the seat retraction process is started. If it is determined that there is no obstacle, the control unit 30A starts the seat retraction process, and if it is determined that there is an obstacle, the control unit 30A does not start the seat retraction process.

If it is determined that there is an obstacle and the seat retraction process is not to be started, the control unit 30A has a function of informing non-execution information, indicating that the seat retraction process will not be executed, to the occupant via the smartphone SP. The non-execution information may be, for example, audio information such as a voice message “seat retraction has not been performed” provided from a speaker of the smartphone SP, sound information such as a warning tone, or image information such as a message displayed on a screen of the smartphone SP or a warning indication, for example, a red screen.

If it is determined that there is no obstacle and the seat retraction process is to be started, the control unit 30A has a function of informing the occupant by the smartphone SP of execution information indicating that the seat retraction process will be executed. The execution information may be, for example, audio information provided from the speaker of the smartphone SP such as a voice message “seat retraction has been performed” or sound information such as a warning tone, or image information such as a message displayed on the screen of the smartphone SP or a success indication, for example, a blue screen.

The seat S may, for example, be returned from the retracted state to the normal state by the control unit 30A operating the seat S in response to a request from the occupant. The request from the occupant may, for example, be output to the control unit 30A in response to the occupant operating an operation unit located in the car or his/her smartphone SP. The operation of the smartphone SP may be activated by the voice of the occupant. Alternatively, the occupant may manually return the seat S from the retracted state to the normal state by operating a lever for actuating a reclining mechanism or a lever for unlocking the sliding movement.

Next, the operation of the control unit 30A will be described in detail.

As shown in FIG. 23, the control unit 30A determines whether or not the seat S is in the retracted state (S51). If it is determined in step S51 that the seat S is in the retracted state (Yes), the control unit 30A ends the present process.

If it is determined in step S51 that the seat S is not in the retracted state (No), the control unit 30A determines whether or not the recognition unit 35 has recognized the occupant's baggage (S52). In more detail, the control unit 30A determines in step S52 whether or not the recognition information and the baggage information have been acquired from the recognition unit 35.

If it is determined in step S52 that baggage has not been recognized (No), the control unit 30A ends the present process. If it is determined in step S52 that baggage has been recognized (Yes), the control unit 30A determines whether the maximum length of the baggage is greater than the predetermined value (S53).

If it is determined in step S53 that the maximum length of the baggage is not greater than the predetermined value (No), the control unit 30A determines not to execute the seat retraction process and ends the present process. If it is determined in step S53 that the maximum length of the baggage is greater than the predetermined value (Yes), the control unit 30A determines to execute the seat retraction process (S54).

After step S54, the control unit 30A determines whether or not an obstacle is in the movement trajectory of the seat S based on information from the obstacle detection sensor SE1 (S55). If it is determined in step S55 that there is no obstacle (Yes), the control unit 30A transmits the execution information to the smartphone SP (S56). After step S56, the control unit 30A executes the seat retraction process (S57) and ends the present process. If it is determined in step S55 that there is an obstacle (No), the control unit 30A transmits the non-execution information to the smartphone SP (S58) and ends the present process without executing the seat retraction process.

Next, specific examples of the operation of the control unit 30A will be described.

As shown in FIGS. 24A to 24C, when an occupant carrying baggage approaches the car CR, the recognition unit 35 recognizes the baggage carried by the occupant, identifies the size of the baggage, and transmits the recognition information and the baggage information to the control unit 30A. As shown in FIG. 24A, if the occupant's baggage is small such as a bag, the control unit 30A determines that the maximum length of the baggage is smaller than the predetermined value based on the baggage information, and does not execute the seat retraction process.

As shown in FIGS. 24B and 24C, when the occupant's baggage is large such as a ski board, the control unit 30A determines that the maximum length of the baggage is greater than the predetermined value based on the baggage information, and determines to execute the seat retraction process. Then, before starting the seat retraction process, the control unit 30A determines, based on information from the obstacle detection sensor SE1, whether or not an obstacle is in the rotational trajectory of the seat back S2.

As shown in FIG. 24B, if no obstacle is in the rotational trajectory of the seat back S2, the control unit 30A executes the seat retraction process to switch the seat S to the retracted state. Specifically, the control unit 30A causes the seat back S2 to fold frontward and then causes the seat S to move frontward. At this time, the control unit 30A transmits the execution information to the occupant's smartphone SP, and the smartphone SP informs the occupant of the execution information by voice, sound, image, vibration, etc.

Herein, the execution information transmitted from the control unit 30A to the smartphone SP may be, for example, a flag indicating that the seat retraction process will be executed. In this case, when the smartphone SP receives the information transmitted from the control unit 30A, the smartphone SP provides the execution information, for example, audio information such as a voice message “seat retraction has been performed” to the occupant.

As shown in FIG. 24C, if an obstacle such as a person is in the rotational trajectory of the seat back S2, the control unit 30A does not execute the seat retraction process even though it has determined to do so. At this time, the control unit 30A transmits the non-execution information to the occupant's smartphone SP, and the smartphone SP informs the occupant of the non-execution information by voice, sound, image, vibration, etc.

Herein, the non-execution information transmitted from the control unit 30A to the smartphone SP may be, for example, a flag indicating that the seat retraction process will not be executed. In this case, when the smartphone SP receives the information transmitted from the control unit 30A, the smartphone SP provides the non-execution information, for example, audio information such as a voice message “seat retraction has not been performed” to the occupant.

According to the above, the following advantageous effects can be obtained in this example.

Since it is determined whether or not an obstacle is in the movement trajectory of the seat S based on information from the obstacle detection sensor SE1 before starting the seat retraction process, and the seat retraction process is not started if it is determined that there is an obstacle, the movement of the seat S, caused by execution of the seat retraction process, can be restrained from being restricted by the obstacle. Thus, it is possible to reduce the load exerted on a drive source such as a motor for operating the seat S.

Since the obstacle detection sensor SE1 is also used as the sensor for the seat belt reminder, costs can be reduced.

Since the seat back S2 is folded to face the seat bottom S1 when the seat S is in the retracted state, the storage space in the car cabin can be made larger than that when the seat is in the normal state.

Since the seat S in the retracted state, positioned in front of the trunk 36 located at the rear of the car CR, is located frontward of a position of the seat S in the normal state, the trunk space can be made larger than that in the normal state.

Since the occupant is informed of the non-execution information when an obstacle is in the movement trajectory of the seat S, the occupant outside the car CR can be aware, based on the informed non-execution information, that the seat S is not in the retracted state before opening the back door 37 of the car CR. Thus, the occupant can put down the baggage he/she is carrying on the ground before opening the back door 37 of the car CR.

Since the occupant is informed of the execution information when there is no obstacle in the movement trajectory of the seat S, the occupant outside the car CR can be aware, based on the informed execution information, that the seat S is in the retracted state before opening the back door 37 of the car CR. Thus, the occupant carrying the baggage can open the back door 37 of the car CR rest assured.

Since the occupant is informed of the non-execution information or the execution information via the smartphone SP carried by the occupant, the occupant can more easily check the non-execution information or the execution information compared to when the non-execution information or the execution information is informed, for example, via an internal speaker or a room lamp in the car.

The fifth example described herein can be used in various forms as illustrated below.

Although the retracted state is defined as a state in which the seat back is folded and the seat is located in the forwardmost position in the above example, the seat with the seat back folded may be located in a recess formed in a floor in the retracted state. In more detail, the seat with the seat back folded may be configured to move frontward and downward, and the seat may be moved frontward and downward after the seat back is folded and located in the recess in the process of being switched from the normal state to the retracted state.

The seat is not limited to a rear seat, and may be a front seat, such as a driver's seat or a front passenger seat. In this case, the retracted state may be a state in which the seat back is folded and the seat is in located in a position in the front-rear direction which is the same as that in the normal state.

When the car has three rows of seats, the second row may be switched from the normal state to the retracted state by hip-up or by being slid frontward. Here, hip-up refers to a state in which the seat is rotated about a rotation axis located in front of and below the seat so that a rear portion of the seat bottom is positioned upward of the rear portion of the seat bottom in the normal state.

If the seat is in the first or second row, the detection target of the recognition unit may be predetermined areas on the left and right sides of the car. In this case, the occupant can put his/her baggage inside the car by opening a side door. If a seat in the second row is allowed to hip-up or slide frontward, the occupant may put his/her baggage in the trunk in the rear of the car after opening the side door.

The seat retraction process may also be performed for a plurality of seats. For example, when the seats of a car such as those in the above example are disposed in two rows, the seat back of the front passenger seat which is the front seat may be folded and placed in a retracted state, and the seat back of the rear seat may be folded and the rear seat may be moved frontward to a retracted state. In this case, even larger baggage such as surfboards can be placed in the car. When executing the seat retraction process for a plurality of seats, only the front seats or the rear seats may be placed in the retracted state, or both of the front seat(s) and the rear seat(s) may be placed in the retracted state, depending on the size of the baggage and the position of the occupant outside the vehicle.

Specifically, if an occupant carrying baggage is behind the car and the size of the baggage is larger than the first threshold value, the control unit only places the rear seats in the retracted state. If an occupant carrying baggage is next to the side door corresponding to a front seat of the car and the size of the baggage is larger than the first threshold value, the control unit only places the front seats in the retracted state. If the size of the baggage is larger than a second threshold value, which is greater than the first threshold value, the control unit places both of the front seat(s) and the rear seat(s) in the retracted state, regardless of the position of the occupant.

The obstacle detection sensor may be a camera, a radio wave sensor, a capacitance sensor, or the like. If a camera or a radio wave sensor is used, obstacles in the range of sliding movement of the seat can be detected. The obstacle detection sensor may also be configured by combining a plurality of sensors such as cameras. This allows more accurate detection of obstacles.

In the fifth example, the power generation device described in the first example may be provided in at least one of the seat bottom S1, the seat back S2, and the headrest S3 of the seat S. By connecting the power generation device to, for example, the obstacle detection sensor SE1, the power generation device can be configured to supply power to the obstacle detection sensor SE1.

The recognition unit may be provided inside the car as in the above-described example, or may be provided outside the car. If an error occurs in the recognition unit, such as, for example, being unable to recognize, the control unit may prohibit execution of the seat retraction process.

If an abnormality occurs in the drive source that operates the seat, the control unit, or the obstacle detection sensor, the control unit may prohibit execution of the seat retraction process.

The non-execution information and the execution information may be informed by the internal speaker, the room lamp in the car, or a light provided on the exterior of the car.

If the seat is caught on an obstacle during the movement of the seat caused by execution of the seat retraction process, the control unit may stop the movement of the seat and return the seat to its original state.

A mode in which the seat retraction process is executed and a mode in which the seat retraction process is not executed may be switchable by the occupant.

The control unit may be capable of executing an application program using the seat as a controller. In this case, the control unit may prohibit execution of the application program when the seat is in the retracted state.

The portable terminal may be a terminal other than the smartphone SP, such as a tablet terminal.

The elements described in the fifth example and modified examples thereof may be implemented selectively and in combination.

### SIXTH EXAMPLE

A detailed description will be given of a sixth example of a seat system comprising a control unit that causes a state of a seat to change.

A seat system conventionally known in the art is capable of executing a reclining process that causes a seat back to tilt rearward automatically or in response to a request from an occupant after switching from a non-autonomous drive mode to an autonomous drive mode (JP 2020-138721 A).

In this art, if an obstacle is in the rotational trajectory of the seat back, operated when the reclining process is executed, the obstacle may restrict rotation of the seat back and exert an additional load on a motor or the like that causes the seat back to rotate.

It would be desirable to provide a seat system that can restrain an obstacle from restricting movement of a seat caused by execution of a reclining process.

A detailed description will be given of the sixth example mainly referring to FIGS. 25 to 28. As shown in FIG. 25, a seat system SYS2 comprises a seat S, a rear seat RS, an obstacle detection sensor SE2, and a control unit 30B.

The seat S and the rear seat RS are installed in a car CR that can be switched between an autonomous drive mode and a non-autonomous drive mode. The car CR has two rows of seats, and the seat S is a seat in the first row such as a driver's seat or a front passenger seat. The rear seat RS is a seat in the second row located behind the seat S.

The seat S and the rear seat RS respectively comprise a seat bottom S1, a seat back S2, and a headrest S3. As in the first example, the seat bottom S1, the seat back S2, and the headrest S3 each have a frame (seat frame) constituting a framework, a pad (pad body) that covers the frame, and an outer covering (outer covering member) that covers the pad.

The seat back S2 is rotatably supported by the seat bottom S1. The seat S is movable in the front-rear direction by means of a slide rail (not shown). The seat S comprises a first drive source such as a motor (not shown) that causes the seat back S2 to rotate. The seat S or the car CR comprises a second drive source such as a motor (not shown) that causes the seat S to move in the front-rear direction. The first drive source and the second drive source are controlled by the control unit 30B.

The seat S is switchable between a normal state shown in FIG. 25 and a relaxing state shown in FIG. 26. The normal state is a state in which an occupant can be seated, i.e., a state in which the seat back S2 stands upright relative to the seat bottom S1, and the seat S is located in a position other than the rearwardmost position. The relaxing state is a state in which the seat back S2 is reclined compared to the normal state and the seat S is located in a position rearward of the position of the seat S in the normal state, specifically, in the rearwardmost position. In the relaxing state, the seat back S2 of the seat S is located over the seat bottom S1 of the rear seat RS.

The obstacle detection sensor SE2 is a sensor that detects an obstacle in the trajectory of the seat S switching from the normal state to the relaxing state. In this example, the obstacle detection sensor SE2 is located in the seat bottom S1 of the rear seat RS between the outer covering and the pad thereof and detects the presence or absence of objects on the seat surface of the seat bottom S1.

The obstacle detection sensor SE2 is, for example, a pressure sensor. In this example, the obstacle detection sensor SE2 is also used as a sensor for a seat belt reminder that detects whether or not an occupant is seated on the seat.

The control unit 30B comprises a central processing unit (CPU), a read-only memory (ROM), a random-access memory (RAM), a rewritable nonvolatile memory, etc. (not shown) and executes processes based on programs stored in advance. The control unit 30B is capable of communicating with a smartphone SP as an example of a portable terminal that can be carried by an occupant.

The control unit 30B may be provided in the car CR or at the seat S. It is assumed that settings of control unit 30B and the smartphone SP that enable communication therebetween are made in advance by the occupant.

The control unit 30B is capable of executing a reclining process to change the state of the seat S from the normal state to the relaxing state. Specifically, the control unit 30B has a function of determining whether or not to execute the reclining process. In more detail, the control unit 30B determines to execute the reclining process in response to the car being switched from the non-autonomous drive mode to the autonomous drive mode or a request from the occupant.

In this example, the control unit 30B determines to execute the reclining process when a first condition and a second condition is satisfied. The first condition is that information indicating the car CR has switched from the non-autonomous drive mode to the autonomous drive mode is received from an electronic control unit (ECU) (not shown) of the car CR. The second condition is that a request is received from the occupant. The request from the occupant may be output to the control unit 30B in response to the occupant operating an operation unit located in the car or his/her smartphone SP. The smartphone SP may be operated by the occupant's voice.

The control unit 30B has a function of determining whether or not an obstacle is in the trajectory of the seat S based on information from the obstacle detection sensor SE2 when it is determined to execute the reclining process, before the reclining process is started. If it is determined that there is no obstacle, the control unit 30B starts the reclining process. If it is determined that there is an obstacle, the control unit 30B does not start the reclining process.

The control unit 30B has a function of informing the occupant by the smartphone of non-execution information indicating that the reclining process will not be executed when it is determined that there is an obstacle and the reclining process is not to be started. The non-execution information may be, for example, audio information such as a voice message “the seat could not be changed to the relaxing mode” provided from a speaker of the smartphone SP, sound information such as a warning tone, or image information such as a message displayed on a screen of the smartphone SP or a warning indication, for example, a red screen.

The control unit 30B has a function of informing the occupant by the smartphone SP of execution information indicating that the reclining process will be executed when it is determined that there is no obstacle and the reclining process is to be started. The execution information may be, for example, audio information provided from the speaker of the smartphone SP, such as a voice message “the seat has been changed to the relaxing mode” or sound information such as a warning tone, or image information such as a message displayed on the screen of the smartphone SP or a success indication, for example, a blue screen.

The seat S may, for example, be returned from the relaxing state to the normal state by the control unit 30B operating the seat S in response to a request from the occupant. The request from the occupant may, for example, be output to the control unit 30B in response to the occupant operating the operation unit located in the car or his/her smartphone SP. Alternatively, the occupant may manually return the seat S from the relaxing state to the normal state by operating a lever for actuating a reclining mechanism, a lever for unlocking the sliding movement of the seat S, etc.

Next, the operation of the control unit 30B will be described in detail with reference to FIG. 27.

The control unit 30B determines whether or not the car CR is being driven in the autonomous drive mode (S61) based on information from the ECU (not shown). If it is determined in step S61 that the car CR is not being driven in the autonomous drive mode (No), the control unit 30B ends the present process.

If it is determined in step S61 that the car CR is being driven in the autonomous drive mode (Yes), the control unit 30B determines whether or not a request (information) for switching the state of the seat S to the relaxing state has been received from the occupant (S62). If it is determined in step S62 that a request has not been received (No), the control unit 30B ends the present process. If it is determined in step S62 that a request has been received (Yes), the control unit 30B determines whether or not the state of the seat S is the relaxing state (S63).

If it is determined in step S63 that the seat S is in the relaxing state (Yes), the control unit 30B determines not to execute the reclining process and ends the present process. If it is determined in step S63 that the seat S is not in the relaxing state (No), the control unit 30B determines to execute the reclining process (S64).

After step S64, the control unit 30B determines whether or not an obstacle is in the movement trajectory of the seat S based on information from the obstacle detection sensor SE2 (S65). If it is determined in step S65 that there is no obstacle (Yes), the control unit 30B transmits the execution information to the smartphone SP (S66). After step S66, the control unit 30B executes the reclining process (S67) and ends the present process. If it is determined in step S65 that there is an obstacle (No), the control unit 30B transmits the non-execution information to the smartphone SP (S68) and ends the present process without executing the reclining process.

Next, specific examples of the operation of the control unit 30B will be described.

As shown in FIG. 25, when the control unit 30B determines to execute the reclining process, the control unit 30B determines, before starting the reclining process, whether or not an obstacle is in the rotational trajectory of the seat back S2 based on information from the obstacle detection sensor SE2.

As shown in FIG. 25, if no obstacle is in the movement trajectory of the seat S, the control unit 30B executes the reclining process, as shown in FIG. 28A, to switch the seat S to the relaxing state. Specifically, the control unit 30B causes the seat back S2 to recline and then causes the seat S to move rearward. At this time, the control unit 30B transmits the execution information to the occupant's smartphone SP, and the smartphone SP informs the occupant of the execution information by voice, sound, image, vibration, etc.

Herein, the execution information transmitted from the control unit 30B to the smartphone SP may be, for example, a flag indicating that the reclining process will be executed. In this case, when the smartphone SP receives the information transmitted from the control unit 30B, the smartphone SP provides the execution information, for example, audio information such as a voice message “the seat has been changed to the relaxing mode” to the occupant.

As shown in FIG. 28B, if an obstacle such as a person is in the rotational trajectory of the seat S, more specifically, on the seat surface of the seat bottom S1 of the rear seat RS, the control unit 30B does not execute the reclining process even though it has determined to do so. At this time, the control unit 30B transmits the non-execution information to the occupant's smartphone SP, and the smartphone SP informs the occupant of the non-execution information by voice, sound, image, vibration, etc.

Herein, the non-execution information transmitted from the control unit 30B to the smartphone SP may be, for example, a flag indicating that the reclining process will not be executed. In this case, when the smartphone SP receives the information transmitted from the control unit 30B, the smartphone SP provides the non-execution information, for example, audio information such as a voice message “the seat could not be changed to the relaxing mode” to the occupant.

According to the above, the following advantageous effects can be obtained in this example.

Since it is determined whether or not an obstacle is in the movement trajectory of the seat S based on information from the obstacle detection sensor SE2 before starting the reclining process, and the reclining process is not started if it is determined that there is an obstacle, the movement of the seat S, caused by execution of the reclining process, can be restrained from being restricted by the obstacle. Thus, it is possible to reduce the load exerted on a drive source such as a motor for operating the seat S.

Since the obstacle detection sensor SE2 is also used as the sensor for the seat belt reminder, costs can be reduced.

Since the seat S in the relaxing state is located in a position rearward of that of the seat S in the normal state, the space in front of the seat S can be made larger than that in the normal state. Thus, the occupant can feel more relaxed.

Since the occupant is informed of the non-execution information when there is an obstacle in the movement trajectory of the seat S, the occupant can be aware that the reclining process will not be executed.

Since the occupant is informed of the execution information when there is no obstacle in the movement trajectory of the seat S, the occupant can be aware that the reclining process will be executed.

Since the non-execution information or the execution information is informed via the smartphone SP carried by the occupant, it is not necessary to execute control such as to temporarily stop music being played by an internal speaker of the car CR, as would be necessary if, for example, the non-execution information or the execution information is informed via the internal speaker of the car CR.

The sixth example described herein can be used in various forms as illustrated below.

Although the relaxing state is defined as a state in which the seat back is reclined and the seat is located in the rearwardmost position in the above embodiment, the relaxing state may be a state in which the seat back is reclined compared to the normal state and the seat is located in a position in the front-rear direction which is the same as that in the normal state.

The seat is not limited to a front seat, but may also be a rear seat. If the vehicle has three rows of seats, the seat may be a seat in the third row. If a seat in front of a trunk in the rear of the car such as a seat in the third row is subjected to the reclining process, the obstacle detection sensor may detect objects in the trunk.

The obstacle detection sensor may be a camera, a radio wave sensor, a capacitance sensor, or the like. If a camera or a radio wave sensor is used, obstacles in the range of sliding movement of the seat can be detected. The obstacle detection sensor may also be configured by combining a plurality of sensors such as cameras. This allows more accurate detection of obstacles.

In the sixth example, the power generation device described in the first example may be provided in at least one of the seat bottom S1, the seat back S2, and the headrest S3 of the seat S. By connecting the power generation device to, for example, the obstacle detection sensor SE2, the power generation device can be configured to supply power to the obstacle detection sensor SE2.

The non-execution information and the execution information may be informed by an internal speaker, a room lamp, etc. of the car.

If the seat is caught on an obstacle during the movement of the seat caused by execution of the seat reclining process, the control unit may stop the movement of the seat and return the seat to its original state.

The portable terminal may be a terminal other than the smartphone SP, such as a tablet terminal.

If an abnormality occurs in the drive source that operates the seat, the control unit, or the obstacle detection sensor, the control unit may prohibit execution of the reclining process.

Although the reclining process is determined to be executed when the first and second conditions are satisfied in the above example, the control unit may, for example, determine to execute the reclining process when it receives information that the car has been switched from the non-autonomous drive mode to the autonomous drive mode from the ECU of the car even if it does not receive a request from the occupant. Further, the control unit may determine to execute the reclining process when it receives a request from the occupant, regardless of whether the car is in the autonomous drive mode, in the non-autonomous drive mode, or parked.

The ECU of the car may be configured to determine whether or not a divider is provided on the road during the autonomous drive mode, and to output a request to the control unit for switching the state of the seat to the relaxing mode when it determines that a divider is provided. The control unit may be the ECU of the car. In this case, the control unit may determine to execute the reclining process if the condition that the car has been switched from the non-autonomous drive mode to the autonomous drive mode, and the condition that the divider is provided are satisfied.

The seat may be switchable between a first state and a second state. The obstacle detection sensor may detect an obstacle in the trajectory of the seat being switched from the first state to the second state. The control unit may be configured to execute a posture change process that changes the state of the seat from the first state to the second state. The control unit may be configured to determine whether or not an obstacle is in the trajectory of the seat based on information from the obstacle detection sensor when the control unit determines to execute the posture change process, before starting the posture change process, to start the posture change process if not, and not to start the posture change process if so.

The elements described in the sixth example and modified examples thereof may be implemented selectively and in combination.

### SEVENTH EXAMPLE

A detailed description will be given of a seventh example of a car system comprising a control unit that causes a position of a pedal to change.

A car system conventionally known in the art is capable of executing a pedal retraction process that causes a pedal to move from an operable position to a retracted position in response to a car being switched from a non-autonomous drive mode to an autonomous drive mode (JP 2020-131923 A). The operable position is a position in which the pedal is operable by an occupant's foot. The retracted position is a position in which the pedal is located in a position farther from the occupant than that in the operable position.

In this art, if an obstacle is in the movement trajectory of the pedal when the pedal retraction process is executed, the obstacle may restrict movement of the pedal and exert an additional load on a motor or the like that causes the pedal to move.

It would be desirable to provide a car system that can restrain an obstacle from restricting movement of the pedal caused by execution of the pedal retraction process.

A detailed description will be given of the seventh example with reference to FIGS. 29 to 33. As shown in FIG. 29, a car system SYS3 comprises a pedal PD, a seat S, an obstacle detection sensor SE3, and a control unit 30C.

The pedal PD and the seat S is installed in a car CR that can be switched between an autonomous drive mode and a non-autonomous drive mode. The pedal PD is a pedal for operating the car CR. The pedal may be at least one of a gas pedal and a brake pedal. In this example, the pedal includes both of the gas pedal and the brake pedal.

The pedal PD is movable between an operable position (position shown in FIG. 29) in which the pedal is operable by an occupant's foot, and a retracted position (position shown in FIG. 30) in which the pedal is located in a position farther from the occupant than that in the operable position. The car CR comprises a pedal drive source such as a motor (not shown) that causes the pedal PD to move in the front-rear direction. The pedal drive source is controlled by the control unit 30C.

The seat S is a driver's seat located behind the pedal PD. The seat S comprises a seat bottom S1, a seat back S2, and a headrest S3. As in the first example, the seat bottom S1, the seat back S2, and the headrest S3 each have a frame (seat frame) constituting a framework, a pad (pad body) that covers the frame, and an outer covering (outer covering member) that covers the pad. The seat back S2 is rotatably supported by the seat bottom S1.

As shown in FIG. 31, the seat S comprises a plurality of pressure sensors PS1 to PS6 for detecting motions of an occupant seated on the seat. The pressure sensors PS1 to PS3 are arranged between the outer covering and the pad of the seat bottom S1, and the pressure sensors PS4 to PS6 are arranged between the outer covering and the pad of the seat back S1. The respective pressure sensors PS1 to PS6 are provided in pairs, each arranged left and right, symmetric with respect to a laterally central position of the seat S.

The pressure sensors PS2 and PS3 are located in positions of the seat bottom S1 corresponding to the buttocks of the occupant. Specifically, the pressure sensors PS3 are located in positions, corresponding to the lowermost portions of ischial bones of the occupant, at which the load of the occupant is largest. The pressure sensors PS2 are arranged a little frontward of the pressure sensors PS3. The pressure sensors PS2, PS3 both acquire measurement values of pressure (hereinafter also referred to as “pressure values”) from the buttocks of the occupant.

The pressure sensors PS1 are arranged frontward of and distanced far from the pressure sensors PS2, PS3, specifically at positions corresponding to the thighs of the occupant. The pressure sensors PS1 acquire measurement values of pressure from the thighs of the occupant P.

The pressure sensors PS4, PS5 are arranged in a lower portion of the seat back S2. Specifically, the pressure sensors PS4 are located in positions corresponding to the rear side of the lumbar region of the occupant. The pressure sensors PS5 are arranged a little above the pressure sensors PS4. The pressure sensors PS4, PS5 acquire measurement values of pressure from the lumbar region of the occupant.

The pressure sensors PS6 are arranged above and distanced far from the pressure sensors PS4, PS5, i.e., in positions corresponding to the upper portion of the back of the occupant. The pressure sensors PS6 acquire measurement values of pressure from positions corresponding to the upper portion of the back of the occupant.

The pressure sensors PS1 to PS6 are, for example, elements having electrical resistances which vary in response to external pressure. The larger the pressure values, the higher or the lower the detection signals. The pressure sensors PS1 to PS6 output pressure values to the control unit 30C.

As shown in FIG. 29, the obstacle detection sensor SE3 is a sensor that detects an obstacle in the trajectory of the pedal PD switching from the operable position to the retracted position. A camera, a radio wave sensor, etc. may be used as the obstacle detection sensor SE3.

The control unit 30C comprises a central processing unit (CPU), a read-only memory (ROM), a random-access memory (RAM), a rewritable nonvolatile memory, etc. (not shown) and executes processes based on programs stored in advance. The control unit 30C is capable of communicating with a smartphone SP as an example of a portable terminal that can be carried by an occupant.

The control unit 30C may be provided in the car CR or at the seat S. It is assumed that settings of the control unit 30C and the smartphone SP that enable communication therebetween are made in advance by the occupant.

The smartphone SP acquires pressure values acquired by the pressure sensors PS1 to PS6 (see FIG. 31) via the control unit 30C. The smartphone SP includes an application program (hereinafter referred to as “app”) installed therein that uses the seat S as a controller and is capable of executing the installed app. The app is, for example, a game app that provides a game. The game app, for example, provides a 100-meter dash game.

The 100-meter dash game is a game in which an occupant seated on the seat S moves his/her legs up and down alternately to make a character displayed on a screen of the smartphone SP to run. The smartphone SP, for example, determines the up and down motions of the occupant's legs and based on the pressure values acquired from the left and right pressure sensors PS1 and advances the game. When the occupant launches the app, the smartphone SP outputs an app-launch signal indicating that the app has been launched to the control unit 30C.

The control unit 30C is capable of executing a pedal retraction process to change the position of the pedal PD from the operable position to the retracted position. Specifically, the control unit 30C has a function of determining whether or not to execute the pedal retraction process. In more detail, the control unit 30C determines to execute the pedal retraction process on the condition that the car is switched from the non-autonomous drive mode to the autonomous drive mode.

In this example, the control unit 30C determines to execute the pedal retraction process if a first condition and a second condition is satisfied. The first condition is that information indicating the car CR has switched from the non-autonomous drive mode to the autonomous drive mode is received from an electronic control unit (ECU) (not shown) of the car CR. The second condition is that the app-launch signal is received from the smartphone SP.

The control unit 30C has a function of determining whether or not an obstacle is in the movement trajectory of the pedal PD based on information from the obstacle detection sensor SE3 when is determined to execute the pedal retraction process, before the pedal retraction process is started. If it is determined that there is no obstacle, the control unit 30C starts the pedal retraction process. If it is determined that there is an obstacle, the control unit 30C does not start the pedal retraction process.

The control unit 30C has a function of informing the occupant by the smartphone SP of non-execution information indicating that the pedal retraction process will not be executed when it is determined that there is an obstacle and the pedal retraction process is not to be started. The non-execution information may be, for example, audio information such as a voice message “the pedal could not be retracted” provided from a speaker of the smartphone SP, sound information such as a warning tone, or image information such as a message displayed on a screen of the smartphone SP or a warning indication, for example, a red screen.

The control unit 30C has a function of prohibiting execution of the app when it is determined that there is an obstacle and the pedal retraction process is not to be started. Specifically, when the control unit 30C determines not to start the pedal retraction process, the control unit 30C outputs a prohibition signal to the smartphone SP for prohibiting the smartphone SP to execute the app.

The control unit 30C has a function of informing the occupant by the smartphone SP of execution information indicating that the pedal retraction process will be executed when it is determined that there is no obstacle and the pedal retraction process is to be started. The execution information may be, for example, audio information provided from the speaker of the smartphone SP such as a voice message “the pedal has been retracted” or sound information such as a warning tone, or image information such as a message displayed on the screen of the smartphone SP or a success indication, for example, a blue screen.

The pedal PD may, for example, be returned from the retracted position to the operable position by the control unit 30C moving the pedal PD in response to a request from the occupant. The request from the occupant may, for example, be output to the control unit 30C in response to the occupant operating an operation unit provided in the car or his/her smartphone SP. The smartphone SP may be operated by the occupant's voice. The control unit 30C may, for example, move the pedal PD from the retracted position to the operable position on the condition that the car CR is switched from the autonomous drive mode to the non-autonomous drive mode.

Next, the operation of the control unit 30C will be described in detail.

As shown in FIG. 32, the control unit 30C determines whether or not the car CR is being driven in the autonomous drive mode (S71) based on information from the ECU (not shown). If it is determined in step S71 that the car CR is not being driven in the autonomous drive mode (No), the control unit 30C ends the present process.

If it is determined in step S71 that the car CR is being driven in the autonomous drive mode (Yes), the control unit 30C determines whether or not the pedal PD is in the operable position (S72). If it is determined in step S72 that the pedal PD is not in the operable position (No), the control unit 30C ends the present process. If it is determined in step S72 that the pedal PD is in the operable position (Yes), the control unit 30C determines whether or not an app-launch signal has been received from the smartphone SP (S73).

If it is determined in step S73 that the app-launch signal has not been received (No), the control unit 30C determines not to execute the pedal retraction process and ends the present process. If it is determined in step S73 that the app-launch signal has been received (Yes), the control unit 30C determines to execute the pedal retraction process (S74).

After step S74, the control unit 30C determines whether or not an obstacle is in the movement trajectory of the pedal PD based on information from the obstacle detection sensor SE3 (S75). If it is determined in step S75 that there is no obstacle (Yes), the control unit 30C transmits the execution information to the smartphone SP (S76). After step S76, the control unit 30C executes the pedal retraction process (S77) and ends the present process. If it is determined in step S75 that there is an obstacle (No), the control unit 30C transmits the non-execution information to the smartphone SP (S78), and transmits a prohibition signal for prohibiting execution of the app to the smartphone SP (S79). After step S79, the control unit 30C ends the present process without executing the pedal retraction process.

Next, specific examples of the operation of control unit 30C will be described.

As shown in FIG. 29, when the occupant seated on the seat S operates his/her smartphone SP during the autonomous drive mode, the control unit 30C determines to execute the pedal retraction process. When the control unit 30C determines to execute the pedal retraction process, the control unit 30C determines, before starting the pedal retraction process, whether or not an obstacle is in the movement trajectory of the pedal PD based on information from the obstacle detection sensor SE3.

As shown in FIG. 29, if no obstacle is in the movement trajectory of the pedal PD, the control unit 30C executes the pedal retraction process, as shown in FIG. 33A, to move the pedal PD from the operable position to the retracted position. At this time, the control unit 30C transmits the execution information to the occupant's smartphone SP, and the smartphone SP informs the occupant of the execution information by voice, sound, image, vibration, etc.

Herein, the execution information transmitted from the control unit 30C to the smartphone SP may be, for example, a flag indicating that the pedal retraction process will be executed. In this case, when the smartphone SP receives the information transmitted from the control unit 30C, the smartphone SP provides the execution information, for example, audio information such as a voice message “the pedal has been retracted” to the occupant.

As shown in FIG. 33B, if an obstacle such as a bag is in the movement trajectory of the pedal PD, the control unit 30C does not execute the pedal retraction process even though it has determined to do so. At this time, the control unit 30C transmits the non-execution information and the prohibition signal to the occupant's smartphone SP. The smartphone SP informs the occupant of the non-execution information by voice, sound, image, vibration, etc. and prohibits execution of the app.

Herein, the non-execution information transmitted from the control unit 30C to the smartphone SP may be, for example, a flag indicating that the pedal retraction process will not be executed. In this case, when the smartphone SP receives the information transmitted from the control unit 30C, the smartphone SP provides the non-execution information, for example, audio information such as a voice message “the pedal could not be retracted” to the occupant.

The prohibition of execution of the app includes temporarily suspending execution of the app as well as terminating the app. Specifically, the smartphone SP having received the prohibition signal may force shutdown of the app, or may display screen for allowing the occupant to select whether to continue execution of the app or to terminate the app.

According to the above, the following advantageous effects can be obtained in this example.

Since it is determined whether or not an obstacle is in the movement trajectory of the pedal PD based on information from the obstacle detection sensor SE3 before starting the pedal retraction process, and the pedal retraction process is not started if it is determined that there is an obstacle, the movement of the pedal PD, caused by execution of the pedal retraction process, can be restrained from being restricted by the obstacle. Thus, it is possible to reduce the load exerted on a drive source such as a motor for moving the pedal PD.

Since the pedal retraction process is determined to be executed on the condition that the car CR is switched from the non-autonomous drive mode to the autonomous drive mode, the pedal retraction process can be restrained from being executed during the non-autonomous drive mode.

Since the pedal retraction process is determined to be executed on the condition that the app using the seat S as the controller has been launched, space in front of the seat S can be made larger when the occupant uses the app. Thus, the occupant can more easily operate the seat S as the controller.

Since execution of the app is prohibited when the pedal retraction process is not started due to presence of an obstacle, the app can be restrained from being executed with the pedal PD located in the operable position and thereby interfering with motions of the occupant.

Since the occupant is informed of the non-execution information when there is an obstacle in the movement trajectory of the pedal PD, the occupant can be aware that the pedal retraction process will not be executed.

Since the occupant is informed of the execution information when there is no obstacle in the movement trajectory of the pedal PD, the occupant can be aware that the pedal retraction process will be executed.

Since the non-execution information or the execution information is informed via the smartphone carried by the occupant, it is not necessary to execute control such as to temporarily stop music being played by an internal speaker of the car CR, as would be necessary if, for example, the non-execution information or the execution information is informed via the internal speaker of the car CR.

The seventh example described herein can be used in various forms as illustrated below.

Although the pedal is configured to move in the front-rear direction in the above embodiment, the pedal may be moved, for example, in the up-down direction between the operable position and a retracted position below the operable position. In this case, a recess for accommodating the pedal may be provided on the floor and the pedal may be retracted into the recess.

The seat is not limited to the driver's seat as long as the seat is located behind the pedal. For example, the seat may be a front passenger seat and the pedal may be a brake pedal located in front of the front passenger seat in a car used in a driving school.

The obstacle detection sensor may be a pressure sensor, a capacitance sensor, etc. If a pressure sensor or a capacitance sensor is used, a plurality of sensors may be provided in the moving range of the pedal. The obstacle detection sensor may also be configured by combining a plurality of sensors such as a pressure sensor and a camera. This allows a more accurate detection of obstacles.

In the seventh example, the power generation device described in the first example may be provided in at least one of the seat bottom S1, the seat back S2, and the headrest S3 of the seat S. By connecting the power generation device to, for example, the obstacle detection sensor, the power generation device can be configured to supply power to the obstacle detection sensor.

The non-execution information and the execution information may be informed by an internal speaker, a room lamp, etc. of the car.

If the pedal is caught on an obstacle during the movement of the pedal caused by execution of the pedal retraction process, the control unit may stop the movement of the pedal and return the pedal to its original state.

The portable terminal may be a terminal other than the smartphone SP, such as a tablet terminal.

If an abnormality occurs in the drive source that operates the seat, the control unit, or the obstacle detection sensor, the control unit may prohibit execution of the pedal retraction process.

Although the pedal retraction process is determined to be executed when the first and second conditions are satisfied in the above example, the control unit may, for example, determine to execute the pedal retraction process when it receives information indicating that the car has been switched from the non-autonomous drive mode to the autonomous drive mode regardless of whether or not the app has been launched. Further, the control unit may determine to execute the pedal retraction process when the app is launched, regardless of whether the car is in the autonomous drive mode, in the non-autonomous drive mode, or parked. The control unit may also determine to execute the pedal retraction process when a request is received from the occupant.

Retraction of the pedal and adjustment of the position of the seat (for example, the position of the seat in the front-rear direction) may be automatically preformed. Specifically, the seat, for example, may be moved to a position rearward of the present position when the pedal is moved from the operable position to the retracted position. In this case, a sensor for detecting an obstacle in the movement trajectory of the seat may be provided, and the pedal retraction process may be prohibited from starting also when an obstacle is in the movement trajectory of the seat.

The seat may be moved to a position rearward of the present position when the pedal retraction process is not started due to presence of an obstacle. That is, the seat may be movable to a first position and to a second position rearward of the first position, and the seat may be moved from the first position to the second position when the control unit determines that there is an obstacle and not to start the pedal retraction process. According to this configuration, the seat is moved rearward to widen the space in front of the seat when the pedal cannot be retracted, and the occupant can thereby more easily operate the seat as the controller.

The pedal may be a pedal operable by an occupant's hand.

The elements described in the seventh example and modified examples thereof may be implemented selectively and in combination.

### EIGHTH EXAMPLE

A detailed description will be given of an eighth example of a car system comprising a control unit that causes a state of seats to change.

A car system conventionally known in the art is capable of determining whether or not occupants should be placed in a state in which they can easily communicate with each other during an autonomous drive mode, and if so, executing a seat orientation change process that causes seats to rotate such that the occupants face each other (JP 2020-111292 A).

In this art, if an obstacle is in the rotational trajectory of the seats which are to be operated when the seat orientation change process is executed, the obstacle may restrict rotation of the seats and exert an additional load on motors or the like that cause the seats to rotate.

It would be desirable to provide a seat system that can restrain an obstacle from restricting movement of the seats caused by execution of the seat orientation change process.

A detailed description will be given of the eighth example with reference to FIGS. 34 to 39. As shown in FIG. 34, a seat system SYS4 comprises seats S, an obstacle detection sensor SE4, and a control unit 30D.

The seats S are installed in a car CR that can be switched between an autonomous drive mode and a non-autonomous drive mode. The car CR has two rows of seats, with two of seats S provided in the first row and two of the seats S provided in the second row. The seats S in the first row and the second row are positioned side-by-side and spaced apart in a lateral direction. Hereinbelow, the driver's seat is also referred to as a first seat SA, the front passenger seat as a second seat SB, the seat behind the driver's seat as a third seat SC, and the seat behind the front passenger seat as a fourth seat SD.

Each of the seats S comprises a seat bottom S1, a seat back S2, and a headrest S3. As in the first example, the seat bottom S1, the seat back S2, and the headrest S3 each have a frame (seat frame) constituting a framework, a pad (pad body) that covers the frame, and an outer covering (outer covering member) that covers the pad.

Each seat S is rotatable about an axis extending in a vertical direction. Each seat is rotatable between a first orientation shown in FIG. 34 and a second orientation shown in FIG. 35 by a drive source such as a motor (not shown). The first orientation is an orientation in which a seat surface of the seat back S2 faces frontward. The second orientation is an orientation in which the seat surface of the seat back S2 faces laterally inward of the car CR than in the first orientation.

The obstacle detection sensor SE4 is a sensor that detects an obstacle in the trajectory of the seat S switching from the first orientation to the second orientation. In this example, the obstacle detection sensor SE4 is located on the ceiling of the car CR and is a camera capable of shooting the space laterally inward of the first seat SA, the second seat SB, the third seat SC, and the fourth seat SD, i.e., the ranges of the trajectories of the seats SA to SD.

The control unit 30D comprises a central processing unit (CPU), a read-only memory (ROM), a random-access memory (RAM), a rewritable nonvolatile memory, etc. (not shown) and executes processes based on programs stored in advance. The control unit 30D is capable of communicating with tablet terminals TB as examples of a portable terminal that can be carried by an occupant.

The control unit 30D may be provided in the car CR or at the seat S. It is assumed that settings of the control unit 30D and the tablet terminal TB that enable communication therebetween are made in advance by each occupant. The control unit 30D stores each tablet terminal TB and each seat S in association with each other. Settings of the control unit 30D regarding such association are also assumed to be made in advance by each occupant.

The control unit 30D is capable of executing a seat orientation change process for each seat SA to SD to change an orientation of the seat S from a first orientation to a second orientation. Specifically, the control unit 30D has a function of determining whether or not to execute the seat orientation change process for each seat SA to SD. In more detail, the control unit 30D determines to execute the seat orientation change process if a first condition and a second condition are satisfied.

The first condition is a condition in which occupants should be placed in a state in which they can easily communicate with each other. Specifically, the control unit 30D is capable of determining whether or not the occupants should be placed in a state in which they can easily communicate with each other, and determines that the first condition is satisfied if it is determined that the occupants should be placed in a state in which they can easily communicate with each other. Herein, one method of determining whether or not the occupants should be placed in a state in which they can easily communicate with each other is, for example, determining, when the approximately same contents are being displayed on a plurality of tablet terminals, that the occupants with the tablet terminals TB displaying the approximately same contents should be placed in a state in which they can easily communicate with each other.

Hereinafter, the mode in which the seats S are rotated based on the contents displayed on the tablet terminal TB carried by each occupant is also referred to as a communication mode. Execution of the communication mode is allowed or prohibited by the occupant selecting a mode of the control unit 30D or the tablet terminal TB in advance.

The second condition is a condition that a request is received from the occupant during the autonomous drive mode. In this example, the second condition includes the condition that the car CR is in the autonomous drive mode, and the condition that execution of the communication mode is allowed. Determination of whether the car CR is in the autonomous drive mode may be based on information indicating that car CR has been switched from the non-autonomous drive mode to the autonomous drive mode, acquired from an Electronic Control Unit (ECU) (not shown) of the car CR.

The control unit 30D has a function of determining whether or not an obstacle is in the trajectory of the seat S based on information from the obstacle detection sensor SE4 when it is determined to execute the seat orientation change process, before the seat orientation change process is started. If it is determined that there is no obstacle, the control unit 30D starts the seat orientation change process. If it is determined that there is an obstacle, the control unit 30D does not start the seat orientation change process.

The control unit 30D has a function of informing the occupant by the tablet terminal TP of non-execution information indicating that the seat orientation change process will not be executed, to when it is determined that there is an obstacle and the seat orientation change process is not to be started. The non-execution information may be, for example, audio information such as a voice message “the seat could not be changed to the communication mode” provided from a speaker of the tablet terminal TB, sound information such as a warning tone, or image information such as a message displayed on a screen of the tablet terminal TB or a warning indication, for example, a red screen.

The control unit 30D has a function of informing the occupant by the tablet terminal TB of execution information indicating that the seat orientation change process will be executed when it is determined that there is no obstacle and the seat orientation change process is to be started. The execution information may be, for example, audio information provided from the speaker of the tablet terminal TB, such as a voice message “the seat has been change to the communication mode” or sound information such as a warning tone, or image information such as a message displayed on the screen of the tablet terminal TB or a success indication, for example, a blue screen.

In order to return the orientation of each seat S from the second orientation to the first orientation, the control unit 30D may, for example, cause the seat S to move in response to a request from the occupant. The request from the occupant may, for example, be output to the control unit 30D in response to the occupant operating an operation unit provided in the car or his/her tablet terminal TB. The tablet terminal TB may be operated by the occupant's voice. Alternatively, the occupant may manually return the orientation of the seat S from the second orientation to the first orientation by operating a lever for actuating a mechanism for rotating the seat S.

Next, the operation of the control unit 30D will be described in detail.

As shown in FIG. 36, the control unit 30D determines whether or not the car CR is being driven in the autonomous drive mode (S81) based on information from the ECU (not shown). If it is determined in step S81 that the car CR is not being driven in the autonomous drive mode (No), the control unit 30D ends the present process.

If it is determined in step S81 that the car CR is being driven in the autonomous drive mode (Yes), the control unit 30D determines whether or not execution of the communication mode is allowed for a plurality of seats S (S82). The seats S for which execution of the communication mode is allowed are hereinafter also referred to as “target seats”. If it is determined in step S82 that there is not a plurality of target seats (No), the control unit 30D ends the present process. If it is determined in step S82 that there is a plurality of target seats (Yes), the control unit 30D determines whether or not a plurality of occupants, among the occupants seated on the plurality of target seats, are in a state in which they should communicate with each other (S83). The occupants in a state in which they should communicate with each other are hereinafter also referred to as “target occupants”.

If it is determined in step S83 that there is not a plurality of target occupants (No), the control unit 30D ends the present process. If it is determined in step S83 that there is a plurality of target occupants (Yes), the control unit 30D determines to execute the seat orientation change process for the seats S corresponding to the plurality of target occupants (S84). The seats S corresponding to the plurality of target occupants are hereinafter also referred to as “seats to be rotated”.

After step S84, the control unit 30D determines whether or not an obstacle is in the movement trajectory of the plurality of seats to be rotated (S85). If it is determined in step S85 that there is no obstacle (Yes), the control unit 30D transmits the execution information to the tablet terminals TB of the target occupants (S86). After step S86, the control unit 30D executes the seat orientation change process (S87) and ends the present process. If it is determined in step S85 that there is an obstacle (No), the control unit 30D transmits the non-execution information to the tablet terminals TB of the target occupants (S88), and ends the present process without executing the seat orientation change process.

Next, specific examples of the operation of the control unit 30D will be described.

As shown in FIG. 37, if the communication mode is allowed, during the autonomous mode, for the second seat SB, the third seat SC, and the fourth seat SD, the control unit 30D identifies the second seat SB, the third seat SC, and the fourth seat SD as the target seats. The outlines of the target seats are shown by thick lines in FIGS. 37 to 39.

Next, the control unit 30D acquires, for example, information regarding the images currently being displayed on the tablet terminals TB of the occupants seated on the target seats (SB to SD), and determines whether or not the occupants seated on the target seats should communicate with each other based on whether or not the contents displayed on the tablet terminals TB are approximately the same.

If the approximately same contents are displayed on the tablet terminal TB corresponding to the third seat SC and the tablet terminal TB corresponding to the fourth seat SD as shown in FIGS. 37 to 39, the control unit 30D identifies the third seat SC and the fourth seat SD as the plurality of seats to be rotated. The seats to be rotated are hatched by dots in FIGS. 37 to 39. Then, the control unit 30D determines to execute the seat orientation change process for the plurality of seats to be rotated.

If the control unit 30D determines to execute the seat orientation change process, the control unit 30D determines, before starting the seat orientation change process, whether or not an obstacle is in the movement trajectory of the seats to be rotated (SC, SD) based on information from the obstacle detection sensor SE4. Since no obstacle is in the movement trajectory of the seats to be rotated (SC, SD) in the example shown in FIG. 37, the control unit 30D executes the seat orientation change process as shown in FIG. 38 to change the orientation of the seats to be rotated (SC, SD) to the second orientation. At this time, the control unit 30D transmits the execution information to the tablet terminal TB of each target occupant. The tablet terminal TB informs the target occupant of the execution information by voice, sound, image, vibration, etc.

Herein, the execution information transmitted from the control unit 30D to the tablet terminal TB may be, for example, a flag indicating that the seat orientation change process will be executed. In this case, when the tablet terminal TB receives the information transmitted from the control unit 30D, the tablet terminal TB provides the execution information, for example, audio information such as a voice message “the seat has been changed to the communication mode” to each target occupant.

Although an obstacle such as a bag is in the movement trajectory of the second seat SB in this example, the second seat SB is not a seat to be rotated. Thus, the presence or absence of an obstacle in the moving trajectory of the second seat SB is not determined. Further, although the contents displayed on the tablet terminal TB corresponding to the first seat SA is approximately the same as the contents displayed on the tablet terminals TB corresponding to the third seat SC and the fourth seat SD, the first seat SA is not a target seat. Thus, it is not determined whether or not the occupant seated on the first seat is the target occupant.

As shown in FIG. 39, if an obstacle such as a bag is in the movement trajectory of the fourth seat SD, which is one of the seats to be rotated, the control unit 30D does not execute the seat orientation change process even though it has determined to do so. At this time, the control unit 30D transmits the non-execution information to the tablet terminal TB of each target occupant. The tablet terminal TB informs the target occupant of the non-execution information by voice, sound, image, vibration, etc.

Herein, the non-execution information transmitted from the control unit 30D to the tablet terminal TB may be, for example, a flag indicating that the seat orientation change process will not be executed. In this case, when the tablet terminal TB receives the information transmitted from the control unit 30D, the tablet terminal TB provides the non-execution information, for example, audio information such as a voice message “the seat could not be changed to the communication mode” to each target occupant.

According to the above, the following advantageous effects can be obtained in this example.

Since it is determined whether or not an obstacle is in the movement trajectory of the seats to be rotated based on information from the obstacle detection sensor SE4 before starting the seat orientation change process, and the seat orientation change process is not started if it is determined that there is an obstacle, the movement of the seats to be rotated, caused by execution of the seat orientation change process, can be restrained from being restricted by the obstacle. Thus, the load exerted on a drive source such as a motor for operating each of the seats to be rotated can be reduced.

Since the seat orientation change process is determined to be executed in response to a request (selection of the communication mode) from the occupant made during the autonomous drive mode, the orientation of the seat can be restrained from being changed during the non-autonomous drive mode or when there is no request from the occupant.

Since the target occupants are informed of the non-execution information when there is an obstacle in the movement trajectory of the seats to be rotated, the target occupants can be aware that the seat orientation change process will not be executed.

Since the target occupants are informed of the execution information when there is no obstacle in the movement trajectory of the seats to be rotated, the target occupants can be aware that the seat orientation change process will be executed.

Since the non-execution information or the execution information is informed via the tablet terminals TB carried by the target occupants, it is not necessary to execute control such as to temporarily stop music being played by an internal speaker of the car CR, as would be necessary if, for example, the non-execution information or the execution information is informed via the internal speaker of the car CR.

The eighth example described herein can be used in various forms as illustrated below.

Although the first orientation is an orientation in which the seat surface of the seat back faces frontward, and the second orientation is an orientation in which the seat surface of the seat back faces laterally inward than in the first orientation in the above example, the first orientation may be an orientation in which the seat surface of the seat back faces in a laterally outward direction of the car CR, and the second orientation may be an orientation in which the seat surface of the seat back faces in a laterally inward direction of the car CR. In this case, the control unit may position the seat in the first orientation if it is determined that it is not a state in which the occupants should communicate with each other, and position the seat in the second orientation if it is determined that it is a state in which the occupants should communicate with each other. According to this configuration, if it is not a state in which the occupants should to communicate with each other, specifically, when different contents are, for example, displayed on the tablets carried by the occupants, the seats of the occupants may be oriented laterally outward away from each other to secure privacy of each occupant.

The seats may not include all seats. For, example, only the seats in the first row may be the targets, or only the seats in the second row may be the targets. If the car has three rows of seats, the seats in the third row may be the targets. Further, only one seat may be provided as the seat. In this case, the control unit for executing the seat orientation change process may be provided for each of a plurality of seats.

The obstacle detection sensor may be a pressure sensor, a radio wave sensor, a capacitance sensor, etc. If a pressure sensor or a capacitance sensor is used, a plurality of sensors may be provided in the moving range of the seat. The obstacle detection sensor may also be configured by combining a plurality of sensors such as a pressure sensor and a camera. This allows more accurate detection of obstacles.

In the eighth example, the power generation device described in the first example may be provided in at least one of the seat bottom S1, the seat back S2, and the headrest S3 of the seats S (SA to SD). By connecting the power generation device to, for example, the obstacle detection sensor, the power generation device can be configured to supply power to the obstacle detection sensor.

The non-execution information and the execution information may be informed by an internal speaker, a room lamp, etc. of the car

If the seat is caught on an obstacle during the movement of the seat caused by execution of the seat orientation change process, the control unit may stop the movement of the seat and return the seat to its original state.

The portable terminal may be a terminal other than the tablet terminal TB, such as a smartphone.

If an abnormality occurs in the drive source that operates the seat, the control unit, or the obstacle detection sensor, the control unit may prohibit execution of the seat orientation change process.

Although it is determined to execute the seat orientation change process when the first and second conditions are satisfied in the above example, the control unit may, for example, determine to execute the seat orientation change process on the sole condition that information indicating that the car has been switched from the non-autonomous drive mode to the autonomous drive mode is received from the ECU of the car. Further, the control unit may determine to execute the seat orientation change process in response to a request from the occupant, regardless of whether the car is in the autonomous drive mode, in the non-autonomous drive mode, or parked.

The seat may, for example, be a seat installed in a room.

The elements described in the eighth example and modified examples thereof may be implemented selectively and in combination.

A detailed description will be given of the ninth, tenth, eleventh, and twelfth examples pertaining to a seat with a seat bottom, on which a person is to be seated, and a seat back.

Sofas and armchairs for home use, seats for vehicles, and the like are known as seats with a seat bottom and a seat back (see, for example, JP 2020-192843A).

It would be desirable to provide a seat capable of improving the comfort of a person seated on the seat (occupant). In addition, it would be desirable to provide a seat that can be easily operated to preform necessary operations.

Thus, a seat is proposed that can improve the comfort of an occupant and that can be easily operated.

### NINTH EXAMPLE

Next, specific aspects of the ninth example will be described, mainly referring to FIGS. 40 to 47. As shown in FIG. 40, the seat of the ninth example is configured as a two-seater sofa SS for home use. The sofa SS comprises a seat body S0, armrests AR as an example of side portions, and a headrest SH. The seat body S0 comprises a seat bottom S1, on which a person is to be seated, and a seat back S2.

As shown in FIG. 41, the seat bottom S1 comprises two seat bottom cushions 100 and a lower support portion 310 as an example of a seat frame that supports the seat bottom cushions 100 from below. The two seat bottom cushions 100 are arranged side-by-side. The seat bottom cushions 100 are placed and used on the lower support portion 310 and can be attached to and detached from the lower support portion 310.

The seat back S2 comprises two seat back cushions 200 and a rear support portion 320 as an example of a seat frame that supports the seat back cushions 200 from behind. The two seat back cushions 200 are arranged side-by-side. The seat back cushions 200 are placed and used in front of the rear support portion 320 and can be attached to and detached from the rear support portion 320.

The armrests AR are respectively located on the left and right sides of the seat bottom S1, and extend to positions above the seat bottom S1. Specifically, the left armrest AR is located at the left of the left seat bottom cushion 100 and the right armrest AR is located at the right of the right seat bottom cushion 100. Each armrest AR extends to a position above the top surfaces of the seat bottom cushions 100 placed on the lower support portion 310 (see FIG. 40).

Each armrest AR can be attached to and detached from the seat bottom S1 and the seat back S2 (seat body S0). Specifically, each armrest AR can be attached to and detached from the lower support portion 310 and the rear support portion 320. After being attached to the seat body S0, each armrest AR is fixed to at least one of the lower support portion 310 and the rear support portion 320 by screws (not shown).

The headrest SH is a portion that supports the occupant from the neck up. The headrest SH supports at least one of the neck and the head of the occupant. The headrest SH includes two headrests SH provided side-by-side, one corresponding to the left seat back cushion 200 and the other corresponding to the right seat back cushion 200. The two headrests SH each comprise a frame (seat frame) constituting a framework, a pad body that covers the frame, and an outer covering that covers the pad body. The headrest SH can be attached to and detached from the seat back S2. In more detail, the headrest SH can be attached to and detached from the rear support portion 320.

In this example, the left and right armrests AR, the headrest SH, the lower support portion 310 and the rear support portion 320 constitute a base section BS. In other words, the base section BS comprises the left and right armrests AR, the headrest SH, the lower support portion 310 and the rear support portion 320. In more detail, the sofa SS comprises two seat bottom cushions 100, two seat back cushions 200, and the base section BS.

As shown in FIG. 42, the sofa SS further comprises a blower 10 and user-operable control 20 (see FIG. 40). Since the sofa SS has an almost symmetrical structure, the structure of the left side portion of the sofa SS, including the left seat bottom cushion 100 and left seat back cushion 200 will be mainly described below.

The blower 10 is a device that blows out air by rotation of an impeller and is located inside the base section BS. Specifically, the blower 10 is located inside the rear support portion 320. In this example, the blower 10 includes a first blower 11, a second blower 12, and a third blower 13 (see FIG. 43).

The first blower 11 is located inside the rear support portion 320 and behind the seat bottom cushion 100. The second blower 12 is located inside the rear support portion 320 and behind the seat back cushion 200. The second blower 12 is positioned above the first blower 11. The third blower 13, shown in FIG. 43, is located inside the rear support portion 320, near a laterally central portion of the rear support portion 320.

Referring back to FIG. 42, the seat bottom cushion 100 comprises a first cushion material 110 as an example of a pad body and a first outer covering 120 as an example of an outer covering member that covers the first cushion material 110. The first cushion material 110 has a seat-bottom-cushion airflow passage 130 as a cushion airflow passage. The seat-bottom-cushion airflow passage 130 is an airflow passage through which an airflow formed by the blower 10, specifically the blower 11, flows.

The seat-bottom-cushion airflow passage 130 has a plurality of seat bottom vent openings 131, as vent openings, and a seat bottom connection opening 132. The seat bottom vent openings 131 are formed on the upper surface of the first cushion material 110 and open upward toward the occupant. The seat bottom connection opening 132 is formed on the rear surface of the first cushion material 110 and opens rearward toward the rear support portion 320. The plurality of seat bottom vent openings 131 and the seat bottom connection opening 132 communicate with each other.

As shown in FIG. 44A, the seat bottom vent openings 131 are provided at positions other than the lateral central portion of the seat bottom cushion 100. Specifically, the seat bottom vent openings 131 are provided at positions spaced left or right from a center LC1 of the seat bottom cushion 100, in a lateral direction, by a length equal to or greater than a predetermined length L1.

The first outer covering 120 is formed to be breathable by including a plurality of fine through holes at positions corresponding to the seat bottom vent openings 131 or is formed from a breathable material.

As shown in FIG. 42, the seat back cushion 200 comprises a second cushion material 210 as an example of a pad body and a second outer covering 220 as an example of an outer covering member that covers the second cushion material 210. The second cushion material 210 has a seat-back-cushion airflow passage 230 as a cushion airflow passage. The seat-back-cushion airflow passage 230 is an airflow passage through which an airflow formed by the blower 10, specifically the second blower 12, flows.

The seat-back-cushion airflow passage 230 has a plurality of seat back vent openings 231, as vent openings, and a seat back connection opening 232. The seat back vent openings 231 are formed on the front surface of the second cushion material 210 and open frontward toward the occupant. The seat back connection opening 232 is formed on the rear surface of the second cushion material 210 and opens rearward toward the rear support portion 320. The plurality of seat back vent openings 231 and the seat back connection opening 232 communicate with each other.

As shown in FIG. 44B, the seat back vent openings 231 are provided at positions other than the laterally central portion of the seat back cushion 200. Specifically, the seat back vent openings 231 are provided at positions spaced left or right from a center LC2 of the seat back cushion 200, in the lateral direction, by a length equal to or greater than a predetermined length L2.

The second outer covering 220 is formed to be breathable by including a plurality of fine through holes at positions corresponding to the seat back vent openings 231 or is formed from a breathable material.

As shown in FIG. 43, the armrests AR each have a pad material 510 and a third outer covering 520 that covers the pad material 510. The pad material 510 has a side airflow passage 530. The side airflow passage 530 is an airflow passage through which an airflow formed by the blower 10, specifically the third blower 13, flows.

The side airflow passage 530 has a plurality of side vent openings 531 and a side connection opening 532. The side vent openings 531 and the side connection opening 532 are formed on a laterally inner surface of the pad material 510 and open laterally inward. The side vent openings 531 open toward the occupant. The side connection opening 532 is located rearward of the side vent openings 531 and opens toward the rear support portion 320. The plurality of side vent openings 531 and the side connection opening 532 communicate with each other.

The third outer covering 520 is formed to be breathable by including a plurality of fine through holes at positions corresponding to the side vent openings 531 or is formed from a breathable material.

As shown in FIGS. 42 and 43, the base section BS has a blower housing chamber 330, a first-base-section airflow passage 340, a second-base-section airflow passage 350, and a third-base-section airflow passage 360.

The blower housing chamber 330 is a portion in which the blower 10 is located and is provided inside the rear support portion 320. The blower housing chamber 330 includes a first blower housing chamber 331 in which the first blower 11 is located, a second blower housing chamber 332 in which the second blower 12 is located, and a third blower housing chamber 333 in which the third blower 13 is located.

As shown in FIG. 42, the first-base-section airflow passage 340 is an airflow passage that communicates the blower 10 with the cushion airflow passages 130, 230. Specifically, the first-base-section airflow passage 340 comprises a first duct 341 and a second duct 342.

The first duct 341 communicates the first blower 11 with the seat-bottom-cushion airflow passage 130. Specifically, the first duct 341 communicates the first blower housing chamber 331 in which the first blower 11 is located with the seat-bottom-cushion airflow passage 130. As shown in FIG. 45, the first duct 341 has a first tubular portion 341A at its front end as a tubular portion protruding from the front surface of the rear support portion 320. The seat-bottom-cushion airflow passage 130 and the first duct 341 of the first-base-section airflow passage 340 are connected when the seat bottom cushion 100 is attached to the base section BS by the first tubular portion 341A entering the seat bottom connection opening 132 of the seat-bottom-cushion airflow passage 130.

The second duct 342 communicates the second blower 12 with the seat-back-cushion airflow passage 230. Specifically, the second duct 342 communicates the second blower housing chamber 332 in which the second blower 12 is located with the seat-back-cushion airflow passage 230. The second duct 342 has a second tubular portion 342A at its upper end as a tubular portion that bends frontward and protrudes from the front surface of the rear support portion 320. The seat-back-cushion airflow passage 230 and the second duct 342 of the first-base-section airflow passage 340 are connected when the seat back cushion 200 is attached to the base section BS by the second tubular portion 342A entering the seat back connection opening 232 of the seat-back-cushion airflow passage 230.

Referring back to FIG. 42, the second-base-section airflow passage 350 is an airflow passage that communicates the outside of the base section BS with the blower 10. Specifically, the second-base-section airflow passage 350 communicates the outside of the base section BS with the blower housing chamber 330. The second-base-section airflow passage 350 has a base section opening 351 that opens rearward at a lower portion of the base section BS. The base section opening 351 may be formed on a surface of the base section BS (sofa SS) and may be uncovered or covered by an air permeable cover or filter.

The second-base-section airflow passage 350 includes a first communication passage 352 communicating the base section opening 351 and the first blower housing chamber 331 and a second communication passage 353 communicating the first blower housing chamber 331 and the second blower housing chamber 332. Further, as shown in FIG. 43, the second-base-section airflow passage 350 includes a third communication passage 354 that communicates the second communication passage 353 with the third blower housing chamber 333.

The third-base-section airflow passage 360 is an airflow passage that communicates the third blower housing chamber 333 in which the third blower 13 is located with the side airflow passage 530. The third-base-section airflow passage 360 is comprised of a duct and includes a left communication passage 361 that communicates the third blower housing chamber 333 with the left side airflow passage 530 and a right communication passage 362 that communicates the third blower housing chamber 333 with the right side airflow passage 530.

The left communication passage 361 and the right communication passage 362 each has a third tubular portion 363 at its laterally outer end protruding from the left or right side of the rear support portion 320. The side airflow passages 530 and the third-base-section airflow passage 360 are connected when the armrests AR are attached to the seat body S0 by the third tubular portions 363 entering the side connection openings 532 of the armrests AR.

As shown in FIGS. 42 and 43, the blower 10 is provided to blow air from the vent openings 131, 231, 431 toward the occupant. Specifically, the first blower 11 and the second blower 12 are provided so that air is blown out from the second-base-section airflow passage 350 toward the first-base-section airflow passage 340 by rotation of the impellers. The third blower 13 is provided so that air is blown out from the second-base-section airflow passage 350 toward the third-base-section airflow passage 360 by rotation of the impeller.

As shown in FIG. 40, the user-operable control 20 is a portion operated by the occupant to operate the blower 10.

As shown in FIG. 46, the user-operable control 20 comprises, in one example, a power switch 21, a selector switch 22, and an adjustment dial 23.

The blower 10 can be driven by turning on the power switch 21.

The selector switch 22 is a switch for driving or stopping the blower 10 when the power switch 21 is turned on, and includes a first selector switch 22A, a second selector switch 22B, and a third selector switch 22C. In the sofa SS, when the first selector switch 22A is turned on, the blower 11 is driven to blow air out from the seat bottom cushion 100 toward the occupant. When the first selector switch 22A is turned off, the blower 11 is stopped and air is no longer blown out from the seat bottom cushion 100.

When the second selector switch 22B is turned on, the second blower 12 is driven and blows air out from the seat back cushion 200 toward the occupant. When the second selector switch 22B is turned off, the second blower 12 is stopped and air is no longer blown out from the front surface of the seat back cushion 200. When the third selector switch 22C is turned on, the third blower 13 is driven and air is blown out from the armrests AR toward the occupant. When the third selector switch 22C is turned off, the third blower 13 stops and air is no longer blown out from the armrest AR.

The adjustment dial 23 is a dial for adjusting the flow rate of the blown air by changing, for example, the rotation speed of the impeller of blower 10.

As shown in FIGS. 47A and 47B, the sofa SS further comprises an electric wire 70 for supplying electric power to the blowers 11 to 13. The electric wire 70 is connected to the first blower 11, the second blower 12 and the third blower 13 via the user-operable control 20. The electric wire 70 may, for example, be configured to be drawn rearward from the rear surface of the armrest AR, as shown in FIG. 47A, or from the rear surface of the laterally central portion of the base section BS, as shown in FIG. 47B.

In this example, since the armrest AR is attachable to and detachable from the seat body S0, the connection of the electric wire 70 where the left armrest AR and the seat body S0 are detachable is provided by a connector 80.

According to the ninth example described above, since air can be blown from the seat bottom cushion 100 and the seat back cushion 200, the comfort of the occupant can be improved. In addition, since the user-operable control 20 is provided at the armrest AR, the user-operable control can be operated more easily than, for example, when the user-operable control is provided at the seat back S2.

### TENTH EXAMPLE

Next, the tenth example will be described with reference to FIGS. 48A and 48B. Hereinafter, points that differ from the previously described ninth example will be described in detail, and points that are the same as those of the ninth example will be omitted by, for example, affixing the same reference characters to similar components.

The tenth example differs from the ninth example in the connection structure of the cushion airflow passages 130, 230 and the first-base-section airflow passage 340.

As shown in FIGS. 48A and 48B, the seat-bottom-cushion airflow passage 130 has a plurality of seat bottom vent openings 131 and the seat bottom connection opening 132 as a second opening. The seat bottom connection opening 132 is formed on the rear surface of the first cushion material 110 and opens toward a first connection opening 343A, which will be described below, of the first-base-section airflow passage 340.

The seat-back-cushion airflow passage 230 has a plurality of seat back vent openings 231 and the seat back connection opening 232 as a second opening. The seat back connection opening 232 is formed on the rear surface of the second cushion material 210 and opens toward a second connection opening 344A, which will be described below, of the first-base-section airflow passage 340.

The first-base-section airflow passage 340 includes a seat bottom communication passage 343 communicating the first blower housing chamber 331 in which the first blower 11 is disposed with the seat-bottom-cushion airflow passage 130, and a seat back communication passage 344 communicating the second blower housing chamber 332 in which the second blower 12 is disposed with the seat-back-cushion airflow passage 230.

The seat bottom communication passage 343 has, at an end opposite to the end connected to the first blower housing chamber 331, a first connection opening 343A as a first opening. The first connection opening 343A opens toward the seat connection opening 132 of the seat-bottom-cushion airflow passage 130. The seat-bottom-cushion airflow passage 130 and the first-base-section airflow passage 340 are communicated when the seat bottom cushion 100 is attached to the base section BS by the seat bottom connection opening 132 and the first connection opening 343A facing each other.

The seat back communication passage 344 has, at an end opposite to the end connected to the second blower housing chamber 332, a second connection opening 344A as a first opening. The second connection opening 344A opens toward the seat back connection opening 232 of the seat-back-cushion airflow passage 230. The seat-back-cushion airflow passage 230 and the first-base-section airflow passage 340 are communicated when the seat back cushion 200 is attached to the base section BS by the seat back connection opening 232 and the second connection opening 344A facing each other.

### ELEVENTH EXAMPLE

Next, the eleventh example will be described mainly referring to FIGS. 49 to 51.

As shown in FIG. 49, the sofa SS of the eleventh example further comprises an adjustment mechanism MC. The adjustment mechanism MC can adjust the position at which air is blown out toward the occupant.

The seat bottom cushion 100 comprises a seat bottom duct 140 and a first connection tube 150 that form the seat-bottom-cushion airflow passage 130. The seat bottom duct 140 has a plurality of seat bottom vent openings 131 that open toward the occupant, and is configured to slide frontward, rearward, leftward and rightward by the adjustment mechanism MC. The first connection tube 150 is a member that connects the seat bottom duct 140 and the seat bottom communication passage 343 of the first-base-section airflow passage 340, and includes an extendable portion 151 that can be extended and contracted in the front-rear direction.

The seat back cushion 200 comprises a seat back duct 240 and a second connection tube 250 that form the seat-back-cushion airflow passage 230. The seat back duct 240 has a plurality of seat back vent openings 231 that open toward the occupant, and is configured to slide up, down, leftward and rightward by the adjustment mechanism MC. The second connection tube 250 is a member that connects the seat back duct 240 and the seat back communication passage 344 of the first-base-section airflow passage 340, and includes an extendable portion 251 that can be extended and contracted in the up-down direction.

The adjustment mechanism MC comprises a first slide mechanism MS1 that causes the seat bottom duct 140 to slide frontward and rearward, a second slide mechanism MS2 that causes the seat bottom duct 140 to slide left and right, a third slide mechanism MS3 that causes the seat back duct 240 to slide up and down, a fourth slide mechanism MS4 that causes the seat back duct 240 to slide left and right.

The sofa SS comprises the user-operable control 20 as shown in FIG. 50. The user-operable control 20 is provided on the upper surface of the armrest AR as in the ninth example. The user-operable control 20 of the eleventh example can actuate the adjustment mechanism MC. The user-operable control 20 comprises the power switch 21, the selector switch 22, and the adjustment dial 23, as well as an actuation switch 24.

The actuation switch 24 is a switch for actuating the adjustment mechanism MC and is comprised of four switches 24A to 24D arranged forward, rearward, leftward and rightward in a cross pattern, and an approximately cross-shaped switch cover 24E. The switch cover 24E has a pivot point at a center thereof with portions arranged forward, rearward, leftward and rightward of the center configured to pivot up and down.

The sofa SS can, for example, cause the seat bottom duct 140 to slide forward by the first slide mechanism MS1, as shown in FIG. 51A, when the frontward switch 24A is pressed via the switch cover 24E after the first selector switch 22A is turned on. This allows the position at which air is blown out from the seat bottom cushion 100 to be adjusted frontward. When the rearward switch 24B is pressed via the switch cover 24E, the seat bottom duct 140 is slid rearward by the first sliding mechanism MS1, as shown in FIG. 51B. This allows the position at which air is blown out from the seat bottom cushion 100 to be adjusted rearward.

When the leftward switch 24C is pressed via the switch cover 24E, the seat bottom duct 140 is slid leftward by the second slide mechanism MS2. This allows the position at which air is blown out from the seat bottom cushion 100 to be adjusted to the left. When the right switch 24D is pressed via the switch cover 24E, the seat bottom duct 140 is slid rightward by the second slide mechanism MS2. This allows the position at which air is blown out from the seat bottom cushion 100 to be adjusted rightward.

The sofa SS can cause the seat back duct 240 to slide downward by the third slide mechanism MS3, as shown in FIG. 51A, when the switch 24A is pressed via the switch cover 24E after turning on the second selector switch 22B. This allows the position at which air is blown out from the seat back cushion 200 to be adjusted downward. When the switch 24B is pressed via the switch cover 24E, the seat back duct 240 is slid upward by the third slide mechanism MS3, as shown in FIG. 51B. This allows the position at which air is blown out from the seat back cushion 200 to be adjusted upward.

When the switch 24C is pressed via the switch cover 24E, the seat back duct 240 is slid to the leftward by the fourth slide mechanism MS4. This allows the position at which air is blown out from the seat back cushion 200 to be adjusted leftward. When the switch 24D is pressed via the switch cover 24E, the seat back duct 240 is slid rightward by the fourth slide mechanism MS4. This allows the position at which air is blown out from the seat back cushion 200 to be adjusted rightward.

According to the eleventh example described above, since the position at which air is blown out can be adjusted by the adjustment mechanism MC, the comfort of the occupant can be further improved.

In addition, since the position at which air is blown out can be adjusted according to the preference of the occupant by the occupant operating the user-operable control 20, the comfort of the occupant can be further improved.

### TWELFTH EXAMPLE

Next, the twelfth example will be described mainly referring to FIGS. 52 and 53.

The twelfth example differs from the eleventh example in the adjustment mechanism MC. Specifically, the adjustment mechanism MC of the twelfth example can adjust the direction in which air is blown out toward the occupant, instead of adjusting the position at which air is blown toward the occupant.

As shown in FIG. 52, the seat bottom cushion 100 comprises a seat bottom duct 160 and a first connection tube 170 that form the seat-bottom-cushion airflow passage 130. The seat duct 160 has a plurality of seat bottom vent openings 131 and front and rear ends that are swung up and down by the adjustment mechanism MC. The first connection tube 170 is a member connecting the seat bottom duct 160 and the seat bottom communication passage 343, and has an extendable portion 171 that can be extended and contracted in the up-down direction.

The seat back cushion 200 comprises a seat back duct 260 and a second connection tube 270 that form the seat-back-cushion airflow passage 230. The seat back duct 260 has a plurality of seat back vent openings 231, and upper and lower ends that are swung frontward and rearward by the adjustment mechanism MC. The second connection tube 270 is a member connecting the seat back duct 260 and the seat back communication passage 344, and has an extendable portion 271 that can be extended and contracted in the front-rear direction.

The adjustment mechanism MC includes a seat bottom swing mechanism MD1 for swinging the seat bottom duct 160 and a seat back swing mechanism MD2 for swinging the seat back duct 260.

As shown in FIG. 53A, the sofa SS can cause the seat bottom duct 160 to swing by the seat bottom swing mechanism MD1 from a position facing upward to a position facing obliquely forward. As a result, the direction in which air is blown out from the seat bottom cushion 100 can be adjusted from an upward direction to an obliquely forward direction. The sofa SS can also cause the seat back duct 260 to swing by the seat back swing mechanism MD2 from a position facing obliquely upward to a position facing frontward. This allows the direction in which air is blown out from the seat back cushion 200 to be adjusted from an obliquely upward direction to a forward direction.

As shown in FIG. 53B, the sofa SS can cause the seat bottom duct 160 to swing by the seat bottom swing mechanism MD1 from a position facing upward to a position facing obliquely rearward. This allows the direction in which air is blown out from the seat bottom cushion 100 to be adjusted from an upward direction to an obliquely rearward direction. The sofa SS can also cause the seat back duct 260 to swing by the seat back swing mechanism MD2 to a position facing further obliquely upward. This allows the direction in which air is blown out from the seat back cushion 200 to be adjusted to an even more obliquely upward direction.

According to the twelfth example described above, since the direction in which air is blown out can be adjusted by the adjustment mechanism MC, the comfort of the occupant can be further improved.

The adjustment mechanism MC of the twelfth example is preferably, but not necessarily, operable by user-operable control as in the eleventh example. According to this configuration, the direction in which air is blown out can be adjusted according to the preference of the occupant by operating the user-operable control. Thereby, the comfort of the occupant can be further improved.

The above described ninth, tenth, eleventh, and twelfth examples can be modified where appropriate as described below.

For example, as shown in FIG. 54, when the sofa SS does not comprise side sections, the user-operable control 20 may be provided on the left side surface of the base section BS. In more detail, the user-operable control may be provided on the left side surface 311 of the lower support portion 310. Although not shown in the figure, the user-operable control 20 may be alternatively provided on the right side surface of the base section BS (lower support portion 310).

As shown in FIG. 55, the sofa SS may further comprise a heater 50.

The heater 50 is a sheet-shaped heater, i.e., a so-called planar heater. In the modified example shown in FIG. 55, the heater 50 includes a seat bottom heater 51A, a seat back heater 52A, a headrest heater 54A, and a leg heater 55.

The seat bottom heater 51A is a heater that heats the surface of the seat bottom S1 facing the occupant, specifically, the upper surface of the seat bottom S1. The seat bottom heater 51A is mainly positioned to face the buttocks and thighs of the occupant and heats the buttocks and thighs of the occupant from below. One seat bottom heater 51A is provided in each of the left and right seat bottom cushions 100. The seat bottom heater 51A is disposed between the top surface of the first cushion material 110 and the first outer covering 120. The seat bottom heater 51A is disposed in the laterally central portion of each seat bottom cushion 100. The seat bottom heater 51A is disposed between a plurality of seat bottom vent openings 131 provided on the left side portion of the seat bottom cushion 100 and a plurality of seat bottom vent openings 131 provided on the right side portion of the seat bottom cushion 100.

The seat back heater 52A is a heater that heats the surface of the seat back S2 facing the occupant, specifically, the front surface of the seat back S2. The seat back heater 52A is mainly positioned to face the lumbar region and the back of the occupant, and heats the lumbar region and the back of the occupant from behind. One seat back heater 52A is provided in each of the left and right seat back cushions 200. The seat back heater 52A is positioned between the front surface of the second cushion material 210 and the second outer covering 220. The seat back heater 52A is disposed between a plurality of seat back vent openings 231 provided on the left side portion of the seat back cushion 200 and a plurality of seat back vent openings 231 provided on the right side portion of the seat back cushion 200.

The headrest heater 54A is a heater that heats the surface of the headrest SH facing the occupant, specifically, the front surface of the headrest SH. The headrest heater 54A is positioned to face at least one of the head and neck of the occupant and heats at least one of the head and neck of the occupant from behind. One headrest heater 54A is provided in each of the left and right headrests SH. The headrest heater 54A is positioned between the pad material of the headrest SH and the outer covering of the headrest SH. In the modified example shown in FIG. 55, the headrest heater 54A is located in a position in the left-right direction between the plurality of seat back vent openings 231 provided on the left side portion of the seat back cushion 200 and the plurality of seat back vent openings 231 provided on the right side portion of the seat back cushion 200.

The leg heater 55 is a heater that heats a surface of the sofa SS that faces the legs of the occupant. The leg heater 55 mainly heats the portion of the leg of the occupant from the knee down. In the modified example shown in FIG. 55, the leg heater 55 is provided to heat the front surface of the seat bottom S1. Specifically, the leg heater 55 is provided to heat the front surface of the seat bottom cushion 100.

### THIRTEENTH EXAMPLE

A detailed description will be given, referring to FIGS. 56 to 64, of a thirteenth example pertaining to a seat with a seat bottom, on which a person is to be seated, and a seat back.

It would be desirable for a seat with a seat bottom and a seat back (for example, refer to JP 2020-192843 A) to improve the comfort of a person seated on the seat (occupant).

Thus, a seat is proposed that can improve the comfort of an occupant and that does not make the occupant feel uncomfortable.

As shown in FIG. 56, the seat of the thirteenth example is configured as a two-seater sofa SS for home use. The sofa SS comprises a seat body S0, armrests AR as an example of side portions, and a headrest SH. The seat body S0 comprises a seat bottom S1, on which a person is to be seated, and a seat back S2.

As shown in FIG. 57, the seat bottom S1 comprises two seat bottom cushions 100 and a lower support portion 310 as an example of a seat frame that supports the seat bottom cushions 100 from below. The two seat bottom cushions 100 are arranged side-by-side. The seat bottom cushions 100 are placed and used on the lower support portion 310 and can be attached to and detached from the lower support portion 310.

The seat back S2 comprises two seat back cushions 200 and a rear support portion 320 as an example of a seat frame that supports the seat back cushions 200 from behind. The two seat back cushions 200 are arranged side-by-side. The seat back cushions 200 are placed and used in front of the rear support portion 320 and can be attached to and detached from the rear support portion 320.

The armrests AR are respectively located on the left and right sides of the seat bottom S1, and extend to positions above the seat bottom S1. Specifically, the left armrest AR is located at the left of the left seat bottom cushion 100 and the right armrest AR is located at the right of the right seat bottom cushion 100. Each armrest AR extends to a position above the top surfaces of the seat bottom cushions 100 placed on the lower support portion 310 (see FIG. 56).

Each armrest AR can be attached to and detached from the seat bottom S1 and the seat back S2 (seat body S0). Specifically, each armrest AR can be attached to and detached from the lower support portion 310 and the rear support portion 320. After being attached to the seat body S0, each armrest AR is fixed to at least one of the lower support portion 310 and the rear support portion 320 by screws (not shown).

The headrest SH is a portion that supports the occupant from the neck up. The headrest SH supports at least one of the neck and the head of the occupant. The headrest SH includes two headrests SH provided side-by-side, one corresponding to the left seat back cushion 200 and the other corresponding to the right seat back cushion 200. The two headrests SH each comprise a frame (seat frame) constituting a framework, a pad body that covers the frame, and an outer covering that covers the pad body. The headrest SH can be attached to and detached from the seat back S2. In more detail, the headrest SH can be attached to and detached from the rear support portion 320.

In this example, the left and right armrests AR, the headrest SH, the lower support portion 310 and the rear support portion 320 constitute a base section BS. In other words, the base section BS comprises the left and right armrests AR, the headrest SH, the lower support portion 310 and the rear support portion 320. In more detail, the sofa SS comprises two seat bottom cushions 100, two seat back cushions 200, and the base section BS.

Referring back to FIG. 56, the sofa SS further comprises a heater 50 and a user-operable control 90.

The heater 50 is a sheet-shaped heater, i.e., a so-called planar heater. In this example, the heater 50 includes a seat bottom heater 51, a seat back heater 52, a side heater 53, and a headrest heater 54.

The seat bottom heater 51 is a heater that heats the surface of the seat bottom S1 facing the occupant, specifically, the upper surface of the seat bottom S1. The seat bottom heater 51 is mainly positioned to face the buttocks and thighs of the occupant and heats the buttocks and thighs of the occupant from below. One seat bottom heater 51 is provided in each of the left and right seat bottom cushions 100. As shown in FIG. 58, the seat bottom cushion 100 has a first cushion material 110 as an example of a pad body and a first outer covering 120 as an example of an outer covering member that covers the first cushion material 110. The seat bottom heater 51 is disposed between the upper surface of the first cushion material 110 and the first outer covering 120.

As shown in FIG. 59A, the seat bottom heater 51 comprises a heater wire 511 that generates heat when energized and a sheet-shaped base material 512 that supports the heater wire 511. The base material 512 is made of a nonwoven fabric or the like and has a plurality of slits 513. The slits 513 respectively extend in the front-rear direction. Specifically, the slits 513 each extend from the front end of the base material 512 toward the rear. The plurality of slits 513 are arranged side-by-side. The heater wires 511 are arranged to follow the contour of the base material 512 including the slits 513 and are fixed to the top surface of the base material 512 by an adhesive or the like.

Referring back to FIG. 58, the seat back heater 52 is a heater that heats the surface of the seat back S2 facing the occupant, specifically, the front surface of the seat back S2. The seat back heater 52 is mainly positioned to face the lumbar region and the back of the occupant, and heats the lumbar region and the back of the occupant from behind. One seat back heater 52 is provided in each of the left and right seat back cushions 200 (see FIG. 56). The seat back cushion 200 has a second cushion material 210 as an example of a pad body and a second outer covering 220 as an example of an outer covering member that covers the second cushion material 210. The seat back heater 52 is disposed between the front surface of the second cushion material 210 and the second outer covering 220.

As shown in FIG. 59B, the seat back heater 52 comprises a heater wire 521 that generates heat when energized and a sheet-shaped base material 522 that supports the heater wire 521. The base material 522 is made of a nonwoven fabric or the like and has a plurality of slits 523. The slits 523 respectively extend in the front-rear direction. Specifically, the slits 523 each extend from the upper end of the base material 522 downward. The plurality of slits 523 are arranged side-by-side. The heater wires 521 are arranged to follow the contour of the base material 522 including the slits 523 and are fixed to the front surface of the base material 522 by an adhesive or the like.

As shown in FIG. 60, the side heater 53 is a heater that heats a surface of the armrest AR facing the occupant. Specifically, the side heater 53 includes an armrest heater 53A that heats the upper surface of the armrest AR and an inner surface heater 53B that heats the laterally inner surface of the armrest AR.

One armrest heater 53A and one inner surface heater 53B are provided in each of the left and right armrest ARs. The armrest AR has a first pad material 510 and a third outer covering 520 that covers the first pad material 510. The armrest heater 53A is disposed between the top surface of the first pad material 510 and the third outer covering 520. The inner surface heater 53B is disposed between the laterally inner surface of the first pad material 510 and the third outer covering 520. Specifically, the inner surface heater 53B is disposed between a portion of the laterally inner surface of the first pad material 510, located adjacent to and above the upper portion of the seat bottom cushion 100, and the third outer covering 520. The inner surface heater 53B is disposed in a position that faces the lumbar region of the occupant. The inner surface heater 53B is disposed in a position that faces the iliac bone of the occupant.

As shown in FIG. 58, the headrest heater 54 is a heater that heats the surface of the headrest SH facing the occupant, specifically, the front surface of the headrest SH. The headrest heater 54 is positioned to face at least one of the head and neck of the occupant and heats at least one of the head and neck of the occupant from behind. One headrest heater 54 is provided in each of the left and right headrests SH (see FIG. 56). The headrest SH has a second pad material 610 and a fourth outer covering 620 that covers the second pad material 610. The headrest heater 54 is disposed between the front surface of the second pad material 610 and the fourth outer covering 620.

As shown in FIG. 56, the user-operable control 90 is a portion operated by the occupant to operate the heater 50. The user-operable control 90 is located on the armrest AR of the base section BS. Specifically, the user-operable control 90 is located in the vicinity of the front end of the upper surface of the left armrest AR. In this example, the right armrest heater 53A is provided so as to heat the approximately entire upper surface of the right armrest AR, while the left armrest heater 53A is provided only at a position behind the user-operable control 90 to avoid the user-operable control 90.

As shown in FIG. 61, the user-operable control 90 comprises, in one example, a power switch 95, a plurality of selector switches 96, and an adjustment dial 97.

The heater 50 can heat the surface facing the occupant when the power switch 95 is turned on.

The selector switch 96 is a switch for switching the heater 50 on or off when the power switch 95 is turned on. Ten selector switches 96 are provided each corresponding to one of the left and right seat bottom heaters 51, the left and right seat back heaters 52, the left and right armrest heaters 53A, the left and right inner surface heaters 53B, and the left and right headrest heaters 54.

For example, when the selector switch 96 corresponding to the left seat bottom heater 51 is turned on, the top surface of the left seat cushion 100 can be heated by the left seat bottom heater 51, and when the above-described selector switch 96 is turned off, heating by the left seat bottom heater 51 can be stopped. When the selector switch 96 corresponding to the right seat bottom heater 51 is turned on, the top surface of the right seat cushion 100 can be heated by the right seat bottom heater 51, and when the above-described selector switch 96 is turned off, heating by the right seat bottom heater 51 can be stopped. The same applies to heaters 52, 53A, 53B, 54.

Adjustment dial 97 is a dial for adjusting the output of the heater 50. The output of the heater 50 can be increased by turning the adjustment dial 97 clockwise in the figure. The output of the heater 50 can be decreased by turning the adjustment dial 97 counterclockwise in the figure. The output of heater 50 is preferably, but not necessarily, adjustable for each heater 51, 52, 53A, 53B, 54 and for each heater at the left and the right.

As shown in FIG. 62, the sofa SS further comprises an electric wire 70 for supplying electric power to the heater 50. The electric wire 70 is connected to the heater 50 via the user-operable control 90. Here, the support portion 300 is a portion of the seat body S0 that supports the seat bottom cushions 100 and the seat back cushions 200 and includes the lower support portion 310 and the rear support portion 320. The electric wire 70 comprises electric wires 700 to 710.

The electric wire 701 connects the left seat bottom heater 51 and the user-operable control 90, and the electric wire 702 connects the right seat bottom heater 51 and the user-operable control 90. Since the seat bottom cushions 100 are attachable to and detachable from the support portion 300 (lower support portion 310), the connection of the electric wire 701 where the left seat bottom cushion 100 and the support portion 300 are detachable is provided by a connector 81 (see also FIG. 57 as appropriate). The connection of the electric wire 702 where the right seat bottom cushion 100 and the support portion 300 are detachable is provided by a connector 82. Since the armrests AR are attachable to and detachable from the support section 300 (seat body S0), the connection of the electric wires 701 and 702 where the support section 300 and the left armrest AR are detachable is provided by a connector 86.

The electric wire 703 connects the left seat back heater 52 and the user-operable control 90, and the electric wire 704 connects the right seat back heater 52 and the user-operable control 90. Since the seat back cushions 200 are attachable to and detachable from the support portion 300 (rear support portion 320), the connection of the electric wire 703 where the left seat back cushion 200 and the support portion 300 are detachable is provided by a connector 83. The connection of the electric wire 704 where the right seat back cushion 200 and the support section 300 are detachable is provided by a connector 84. The connection of the electric wires 703 and 704 where the support section 300 and left armrest AR are detachable is provided by the connector 86.

The electric wire 705 connects the left armrest heater 53A and the user-operable control 90, and the electric wire 706 connects the left inner surface heater 53B and the user-operable control 90.

The electric wire 707 connects the right armrest heater 53A and the user-operable control 90, and the electric wire 708 connects the right inner surface heater 53B and the user-operable control 90. The connection of the electric wires 707 and 708 where the right armrest AR and the support section 300 are detachable is provided by a connector 85. The connection of the electric wires 707, 708 where the support section 300 and the left armrest AR are detachable is provided by the connector 86.

The electric wire 709 connects the left headrest heater 54 and the user-operable control 90, and the electric wire 710 connects the right headrest heater 54 to the user-operable control 90. Since the headrest SH can be attached to and detached from the support portion 300 (rear support portion 320), the connection of the electric wire 709 where the left headrest SH and the support portion 300 are detachable is provided by a connector not shown in the figure. The connection of the electric wire 710 where the right headrest SH and support section 300 are detachable is provided by a connector not shown in the figure. The connection of the electric wires 709 and 710 where the support section 300 and the left armrest AR are detachable is made by the connector 86.

The electric wire 700 connects the power plug shown with the reference character omitted and the user-operable control 90. The electric wire 700 is drawn out from the support section 300. The connection of the electric wire 700 where the left armrest AR and the support section 300 are detachable is provided by the connector 86. As shown in FIG. 63, the electric wire 700 is drawn rearward from the rear surface of the laterally central portion of the support section 300 (seat body S0). Further, as shown in FIG. 58, the electric wire 700 is drawn rearward from the rear surface of the seat body S0 at a position lower than the lower end of the seat cushion 100 attached to the lower support portion 310 (see the alternate long and short dashed line).

According to the example described above, the upper surface of the seat bottom S1 facing the occupant can be heated by the seat bottom heater 51, and the front surface of the seat back S2 facing the occupant can be heated by the seat back heater 52.

The surface of the armrest AR facing the occupant can be heated by the side heaters. In more detail, the upper surface of the armrest AR can be heated by the armrest heater 53A. The laterally inner surface of the armrest AR can be heated by the inner surface heater 53B, thus the occupant can be heated from a lateral side.

The front surface of the headrest SH facing the occupant can be heated by the headrest heater 54.

In this way, the heater 50 can heat the surfaces facing the occupant, and the comfort of the occupant can thereby be improved.

Since the base materials 512, 522 of the seat bottom heater 51 and the seat back heater 52 include a plurality of slits 513, 523, the seat bottom heater 51 and the seat back heater 52 are allowed to moderately deform when a person sits on the seat bottom S1 or leans on the seat back S2, the occupant does not feel uncomfortable.

The above described thirteenth example can be modified where appropriate as described below.

For example, as shown in FIG. 64, the heater 50 may be configured to include a leg heater 55. The leg heater 55 is a heater that heats a surface of the sofa SS that faces the legs of the occupant. The leg heater 55 mainly heats portions of the legs of the occupant from the knee down. In the modified example shown in FIG. 64, the leg heater 55 is provided to heat the front surface of the seat bottom S1. Specifically, the leg heater 55 is provided to heat the front surface of the seat bottom cushion 100. The leg heaters may be provided to heat not only the front surface of the seat bottom S1, but also the surface of the lower support portion 310 facing the occupant, specifically, the front surface of the lower support portion 310. The leg heater may also be provided to heat the surface, facing the occupant, of a retractable ottoman provided in the sofa SS.

As shown in FIG. 64, the heater 50 may comprise an outer surface heater 56. The outer surface heater 56 is a heater that heats the laterally outer surfaces of the sofa SS. In the modified example shown in FIG. 64, the outer surface heater 56 is provided to heat the laterally outer surfaces of the armrest AR. By providing such an outer surface heater 56, people and/or pets on the left and right sides of the sofa SS, for example, can be heated and the room temperature of the room can be raised by the sofa SS.

In the ninth to thirteenth examples, the seat may be a one-seater sofa or a three-seater sofa. The seat may, for example, be an armchair. The seat may, for example, be a seat used in an amusement or relaxation facility. The seat may also, for example, be a car seat or a vehicle seat installed in an automobile, railroad car, ship, aircraft, or the like.

The elements described in the above-described example embodiments and their modified examples may be implemented selectively and in combination.

What is claimed is:

1. A seat comprising:
a seat body comprising:
a seat bottom;
a seat back; and
a headrest; and
a cartridge installable into and removable from the seat body,
wherein the headrest comprises:
an air outlet configured to blow air out of the headrest;
an air inlet configured to draw air into the headrest;
a cartridge installation section in which the cartridge is removably installed; and
a fan that forms an airflow in the headrest, the airflow flowing from the air inlet, through the cartridge installation section, and toward the air outlet,
wherein the cartridge installed in the cartridge installation section allows the airflow to pass therethrough, and
wherein the cartridge installation section is located in a portion of the headrest behind the head of an occupant.

2. The seat according to claim 1, wherein the cartridge is installable into the cartridge installation section from behind or from above.

3. The seat according to claim 1, wherein the headrest comprises a plurality of the cartridge installation sections.

4. The seat according to claim 1,
wherein the cartridge installation section has an opening for installing the cartridge therein, and
wherein the headrest comprises a cover movable between an open position in which the opening is uncovered and a closed position in which the opening is covered.

5. The seat according to claim 4, wherein the headrest comprises a biasing member that biases the cover toward the closed position.

6. The seat according to claim 1, wherein the cartridge installation section comprises a claw that holds the cartridge in a state where the cartridge is installed in the cartridge installation section.

7. The seat according to claim 1, wherein the cartridge comprises a ventilation portion that connects an interior and an exterior of the cartridge and allows the airflow to pass therethrough in a state where the cartridge is installed in the cartridge installation section.

8. The seat according to claim 7, wherein the cartridge installation section further comprises a shutter that covers and uncovers the ventilation portion.

9. The seat according to claim 1, wherein the headrest further comprises:
a first duct connecting the air inlet and the cartridge installation section, and
a second duct connecting the cartridge installation section and the air outlet.

10. The seat according to claim 1, wherein the cartridge comprises at least one of a fragrance emitter, a temperature regulator, an ion generator, or an air purifier.
